(19) United States
(12) Patent Application Publication
(10) Pub. No.: US 2024/0117995 A1
(43) Pub. Date: Apr. 11, 2024

(54) HEATING DEVICE OF IONIZED WATER ARRANGEMENT STRUCTURE SURROUNDING FLUID AND HEAT EXCHANGE REGION

(71) Applicant: No Eul KIM, Busan (KR)

(72) Inventors: No Eul KIM, Busan (KR); Young Tae KIM, Busan (KR)

(21) Appl. No.: 18/393,777

(22) Filed: Dec. 22, 2023

Related U.S. Application Data
(63) Continuation of application No. PCT/KR2022/009035, filed on Jun. 24, 2022.

(30) Foreign Application Priority Data
Jun. 24, 2021 (KR) 10-2021-0082555
Jun. 24, 2021 (KR) 10-2021-0082590

(51) Int. Cl. F24H 1/10; F24H 1/12

(52) U.S. Cl. CPC F24H 1/106; F24H 1/121

(57) ABSTRACT

The present disclosure relates to a heating device of an ionized water arrangement structure surrounding a fluid and a heat exchange region. To this end, one aspect of the present disclosure may include a pipe part formed to allow a fluid to be disposed therein, a body part formed to allow an electrolyzed water to be disposed therein to overlap the fluid, and formed to surround at least one region of the pipe part, and at least one electrode for heating the electrolyzed water inside the body part.

### TECHNICAL FIELD

The present disclosure relates to a heating device of an ionized water arrangement structure surrounding a fluid and a heat exchange region.

### BACKGROUND ART

As technology advances, products to which various technologies are applied in the field of machinery and electronics are being developed and produced, and accordingly, various heating devices, for example, boiler devices, are being developed.

Boilers may be largely classified into industrial boilers, agricultural boilers, and household boilers. In addition, the types of boilers may be classified as a direct heating method or an indirect heating method in which a medium such as water is heated and circulated.

In addition, according to the types of energy sources of the boilers, as specific examples, boilers using petroleum, boilers using briquettes, boilers using wood, boilers using gas, boilers using electricity, and the like are being used or studied.

Among them, boilers using electricity to provide the heat source may have advantages in terms of soot and environmental problems compared to boilers using fossil fuels such as petroleum or coal.

However, there is a limitation in implementing a heating device while easily securing thermal efficiency and electrical stability of a heating device using electricity.

### DESCRIPTION OF EMBODIMENTS

### Technical Problem

The present disclosure may provide a heating device that may increase the use convenience of a user by improving electrical stability and thermal efficiency.

### Technical Solution to Problem

In order to achieve the above-described purpose, one aspect of the present disclosure may include a pipe part formed to allow a fluid to be disposed therein, a body part formed to allow an electrolyzed water to be disposed therein to overlap the fluid, and formed to surround at least one region of the pipe part, and at least one electrode for heating the electrolyzed water inside the body part.

### Advantageous Effects of Disclosure

An electrode-based heating device according to the present disclosure can increase the use convenience of a user by improving electrical stability and thermal efficiency.

### BRIEF DESCRIPTION OF DRAWINGS

FIG. 1 is a view schematically illustrating a heating device according to an embodiment of the present disclosure.

FIG. 2 is a cross-sectional view taken along line AI-AI′ of FIG. 1.

FIG. 3 is an exemplary enlarged view of portion A of FIG. 2.

FIG. 4 is a cross-sectional view taken along line AII-AII′ of FIG. 2.

FIG. 5 is a view schematically illustrating an embodiment of the heating device including a temperature sensor.

FIG. 6 is a view schematically illustrating an embodiment of the heating device including an overheating sensor.

FIG. 7 is a view schematically illustrating an embodiment of the heating device including a buffer part.

FIG. 8 is a view schematically illustrating an embodiment of the heating device including a control unit.

FIG. 9 is a view schematically illustrating a modified example of FIG. 8.

FIG. 10 is a view schematically illustrating a heating device according to another embodiment of the present disclosure.

FIG. 11 is a view for describing an embodiment in which a pipe part and a body part are coupled to each other.

FIG. 12 is a view schematically illustrating an embodiment of a pipe part of FIG. 1.

FIG. 13 is a view schematically illustrating a modified example of FIG. 12.

FIG. 14 is a view schematically illustrating another modified example of the pipe part.

FIG. 15 is a view schematically illustrating another modified example of the pipe part.

FIG. 16 is a view schematically illustrating another modified example of the pipe part.

FIG. 17 is a view illustrating a portion of a perspective view of FIG. 16.

FIG. 18 is a view schematically illustrating a modified example of FIG. 4.

FIG. 19 is a view schematically illustrating a heating device according to another embodiment of the present disclosure.

FIG. 20 is a cross-sectional view taken along line AIII-AIII′ of FIG. 19.

FIG. 21 is a view schematically illustrating a modified example of FIG. 20.

FIG. 22 is a view schematically illustrating a heating device according to another embodiment of the present disclosure.

FIG. 23 is a cross-sectional view taken along line AIV-AIV of FIG. 22.

FIG. 24 is a view schematically illustrating a heating device according to another embodiment of the present disclosure.

FIG. 25 is a cross-sectional view taken along line AV-AV′ of FIG. 24.

FIG. 26 is a view schematically illustrating a heating device according to another embodiment of the present disclosure.

FIG. 27 is a cross-sectional view taken along line AVI-AVI′ of FIG. 26.

FIG. 28 is a view schematically illustrating a heating device according to another embodiment of the present disclosure.

FIG. 29 is a cross-sectional view taken along line AVII-AVII′ of FIG. 28.

FIG. 30 is a view schematically illustrating a heating device according to an embodiment of the present disclosure.

FIG. 31 is a cross-sectional view taken along line BI-BI′ of FIG. 30.

FIG. 32 is an exemplary enlarged view of portion A of FIG. 31.

FIG. 33 is a cross-sectional view taken along line BII-BII′ of FIG. 31.

FIG. 34 schematically illustrates an embodiment of a pipe part of FIG. 30.

FIG. 35 is a view schematically illustrating another modified example of the pipe part.

FIG. 36 is a view schematically illustrating another modified example of the pipe part.

FIG. 37 is a view schematically illustrating another modified example of the pipe part.

FIG. 38 is a view illustrating a portion of a perspective view of FIG. 37.

FIG. 39 is a view for describing an embodiment in which a pipe part and a body part are coupled to each other.

FIG. 40 is a view schematically illustrating a heating device according to another embodiment of the present disclosure.

FIG. 41 is a cross-sectional view taken along line BIII-BIII′ of FIG. 40.

FIG. 42 is a cross-sectional view taken along line BIV-BIV′ of FIG. 41.

FIG. 43 is a view schematically illustrating a heating device according to another embodiment of the present disclosure.

FIG. 44 is a cross-sectional view taken along line BV-BV′ of FIG. 43.

FIG. 45 is a cross-sectional view taken along line BVI-BVI′ of FIG. 44.

FIG. 46 is a view schematically illustrating an embodiment of a pipe part of FIG. 44.

FIG. 47 is a view schematically illustrating a heating device according to another embodiment of the present disclosure.

FIG. 48 is a cross-sectional view taken along line BVII-BVII′ of FIG. 47.

FIG. 49 is a cross-sectional view taken along line BVIII-BVIII′ of FIG. 44.

FIG. 50 is a view schematically illustrating a modified example of FIGS. 47 to 49.

FIG. 51 is a view schematically illustrating a heating device according to another embodiment of the present disclosure.

FIG. 52 is a cross-sectional view taken along line BIX-BIX′ of FIG. 51.

FIG. 53 is a cross-sectional view taken along line BX-BX′ of FIG. 52.

FIG. 54 is a view schematically illustrating a modified example of FIGS. 51 to 53.

FIG. 55 is a view schematically illustrating an embodiment of the heating device including a sensor.

FIG. 56 is a view schematically illustrating an embodiment of the heating device including a buffer part.

FIG. 57 is a view schematically illustrating an embodiment of the heating device including a heat sink.

### BEST MODE

In order to achieve the above-described purpose, one aspect of the present disclosure may include a pipe part formed to allow a fluid to be disposed therein, a body part formed to allow an electrolyzed water to be disposed therein to overlap the fluid, and formed to surround at least one region of the pipe part, and at least one electrode for heating the electrolyzed water inside the body part.

Further, the pipe part may be disposed to cross an inside of the body part.

Further, the pipe part may include an inlet via which a fluid is introduced in an inward direction of the body part and an outlet via which the fluid is discharged in an outward direction of the body part.

Further, the electrolyzed water may be disposed to surround a side surface of the pipe part.

In addition, another aspect of the present disclosure may include a pipe part formed to allow a fluid to be disposed therein, a body part formed to allow an electrolyzed water to be disposed therein to surround at least one region of the fluid, and disposed to surround at least one region of the pipe part, and at least one electrode disposed inside the body part to heat the electrolyzed water.

Further, the pipe part may include an inlet via which a fluid is introduced in an inward direction of the body part and an outlet via which the fluid is discharged in an outward direction of the body part.

Further, the pipe part may be formed such that at least one region thereof is curved inside the body part.

In addition, the electrode may be disposed in parallel to at least one region of the pipe part.

### MODE OF DISCLOSURE

Hereinafter, configurations and operations of the present disclosure will be described in detail with reference to embodiments of present disclosure illustrated in the accompanying drawings.

While the present disclosure is susceptible to various modifications and alternative forms, specific embodiments thereof are shown by way of example in the drawings and will herein be described in detail. Advantages and features of the present disclosure and a method of achieving the same should become clear with embodiments described below in detail with reference to the drawings. However, the present disclosure is not limited to the embodiments disclosed below, but may be implemented in various forms.

Hereinafter, the embodiments of the present disclosure will be described below in detail with reference to the accompanying drawings, and when the embodiments of the present disclosure are described with reference to the drawings, the same or corresponding components are given the same reference numerals, and repetitive descriptions thereof will be omitted.

In the following embodiments, the terms “first,” “second,” and the like have been used to distinguish one component from another, rather than limitative in all aspects.

In the following embodiments, singular expressions are intended to include plural expressions as well, unless the context clearly indicates otherwise.

In the following embodiments, the terms such as “including,” “having,” and “comprising” are intended to indicate the existence of features or components disclosed in the specification, and are not intended to preclude the possibility that one or more other features or components may be added.

For convenience of description, sizes of components shown in the drawings may be exaggerated or reduced. For example, since the size and thickness of each component illustrated in the drawing are arbitrarily shown for convenience of description, the present disclosure is not necessarily limited to those illustrated in the drawing.

In the following embodiments, the x-axis, y-axis, and z-axis are not limited to three axes on a Cartesian coordinate system, and may be interpreted in a broad sense including them. For example, the x-axis, the y-axis, and the z-axis may be orthogonal to each other, but may refer to different directions that are not orthogonal to each other.

In a case in which a particular embodiment is realized otherwise, a particular process may be performed out of the order described. For example, two processes described in succession may be performed substantially simultaneously, or may be performed in an order opposite to the described order.

Hereinafter, based on the principles described above, an embodiment of a heating device of an ionized water arrangement structure (hereinafter referred to as a heating device) surrounding a fluid and heat exchange region according to the present disclosure will be described in detail.

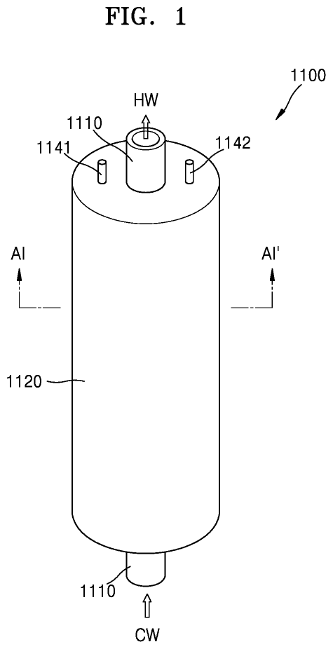

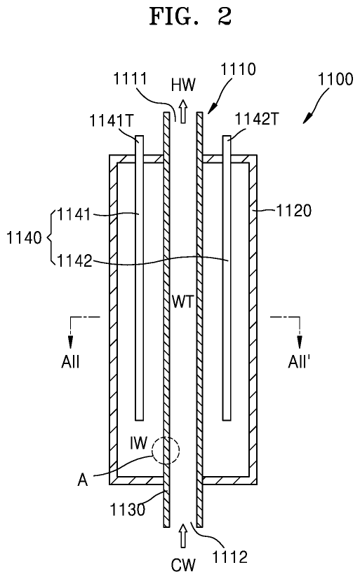

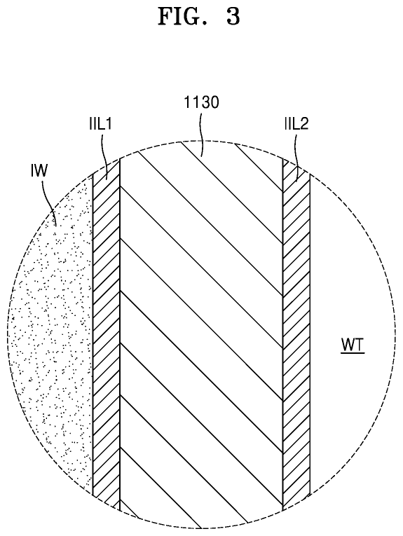

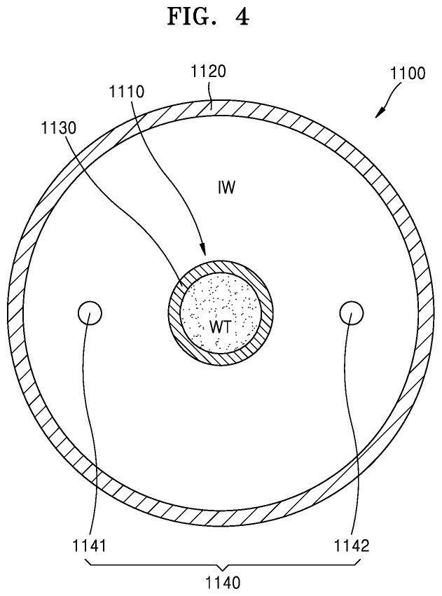

FIG. 1 is a view schematically illustrating a heating device 1100 according to an embodiment of the present disclosure, and FIG. 2 is a cross-sectional view taken along line AI-AI′ of FIG. 1. FIG. 3 is an exemplary enlarged view of portion A of FIG. 2, and FIG. 4 is a cross-sectional view taken along line AII-AII′ of FIG. 2.

Referring to FIGS. 1 to 4, the heating device 1100 according to the present embodiment may include a pipe part 1110 and a body part 1120.

A fluid WT may be disposed inside the pipe part 1110. The fluid WT may include various types, for example, a liquid or a gas.

In an optional embodiment, the fluid WT may include water. For example, the heating device 1100 may be driven in a manner that uses hot water.

The pipe part 1110 may be formed in the shape of a pipe including an outer wall and an inner wall and having a space therein in which the fluid WT may be disposed. For example, the pipe part 1110 may be formed in the shape of a pipe having a circular cross-section. In another example, the pipe part 1110 may be formed in the shape of a pipe having a polygonal cross-section. For example, the pipe part 1110 may be formed in the shape of a pipe having a rectangular cross-section. In another example, the pipe part 1110 may be formed in the shape of a pipe having a curved cross-section similar to an ellipse.

The body part 1120 may be a device disposed to surround at least one region of the pipe part 1110 and configured to heat the fluid WT disposed inside the pipe part 1110. The body part 1120 may have various shapes, and for example, may be formed in the shape of a hollow box having a space provided therein.

In an optional embodiment, the body part 1120 may be formed in a columnar shape, for example, may be formed in the shape of a cylinder having a space provided therein. In another example, the body part 1120 may be formed in a prismatic columnar shape, for example, may be formed in the shape of a square column. In another example, the body part 1120 may be formed in the shape of a column including a curved surface whose bottom surface is similar to an ellipse.

The body part 1120 may be formed of various materials. For example, the body part 1120 may be formed of a durable and lightweight insulating material. In an optional embodiment, the body part 1120 may be formed of a synthetic resin material including various types of resins. In another optional embodiment, the body part 1120 may also include an inorganic material such as ceramic.

In another optional embodiment, the body part 1120 may be formed of a metal material. In another example, the body part 1120 may also include a Teflon resin that is a fluorine resin.

In an optional embodiment, among surfaces of the body part 1120, an inner side surface adjacent to an electrolyzed water IW may include an insulating layer. For example, the inner side surface of the body part 1120 may include an inorganic layer, and may include an inorganic material including ceramic.

Further, as another example, an insulating layer including an organic material may be formed on the inner side surface adjacent to the electrolyzed water IW among the surfaces of the body part 1120.

The pipe part 1110 may be formed to be longer than the body part 1120.

In an embodiment, the pipe part 1110 may be disposed to cross the inside of the body part 1120. For example, the pipe part 1110 may be disposed to pass through the body part 1120. Accordingly, when the fluid WT is disposed inside the pipe part 1110, at least a portion of the fluid WT may be disposed inside the body part 1120.

In an optional embodiment, the pipe part 1110 may include an inlet 1112 via which the fluid WT flows in an inward direction of the body part 1120, and an outlet 1111 via which the fluid WT is discharged in an outward direction of the body part 1120. For example, the pipe part 1110 may include the inlet 1112 at one side and the outlet 1111 at another side, and may include a flow path, in which the fluid WT is disposed, between the inlet 1112 and the outlet 1111.

Accordingly, the fluid WT may flow into the pipe part 1110, and for example, the fluid WT may be introduced via the inlet 1112 of the pipe part 1110 and may be discharged to the outside via the outlet 1111 through the flow path.

Specifically, an unheated fluid CW before being heated may be introduced via the inlet 1112 of the pipe part 1110. For example, the unheated fluid CW may include room-temperature water or low-temperature water.

A heated fluid HW may be discharged via the outlet 1111 and, for example, a fluid WT including water having a temperature higher than that of the unheated fluid CW introduced via the inlet 1112 may be discharged.

In a specific example, the unheated fluid CW including room-temperature water, which is introduced via the inlet 1112, may be introduced into the pipe part 1110 and then heated through the body part 1120, and the heated fluid HW including heated water may be discharged to the outside of the pipe part 1110 via the outlet 1111.

Since the body part 1120 is disposed to surround at least a portion of the pipe part 1110, the fluid WT can be in contact with the body part 1120 over a large area while passing through the pipe part 1110 and thus can be efficiently heated.

The electrolyzed water IW may be disposed inside the body part 1120, and the electrode part 1140 for heating the electrolyzed water IW may be included in the body part 1120. The electrode part 1140 may include at least one electrode.

In an embodiment, the fluid WT and the electrolyzed water IW may be disposed to overlap each other, and for example, the electrolyzed water IW may be disposed to surround the side surface of the pipe part 1110. That is, since the electrolyzed water IW is disposed inside the body, and the fluid WT is disposed inside the pipe part 1110, the electrolyzed water IW and the fluid WT may be disposed to overlap each other.

The electrolyzed water IW may be of various types. For example, the electrolyzed water IW may include electrolyte solution, specifically distilled water, filtered water, bottled water, tap water, or the like in which at least one of various types of electrolyte solutions is appropriately diluted.

As a material included in the electrolyzed water IW, there are various types including rust inhibitors or the like that contain edible soda, chlorite, silicate, an inorganic material of polyphosphate, amines, oxyacids, or the like as main components.

Thus, as will be described later, the electrolyzed water IW can be easily heated by the electrode part 1140, and the heated electrolyzed water IW can easily heat the fluid WT overlapping therewith.

The pipe part 1110 may include an inner surface in contact with the fluid WT and an outer surface in contact with the electrolyzed water IW. For example, the inner surface of the pipe part 1110 may define a space in which the fluid WT is disposed, and the outer surface of the pipe part 1110 may define an external shape of the pipe part 1110.

The pipe part 1110 may include the heat dissipation part 1130. For example, the heat dissipation part 1130 may be a region which is disposed between the fluid WT and the electrolyzed water IW and in which heat is exchanged between the fluid WT and the electrolyzed water IW.

As described above, an inner space may be provided in the pipe part 1110, and the inner space of the pipe part 1110 may be determined by the heat dissipation part 1130.

The fluid WT may be disposed inside the pipe part 1110. The fluid WT may be disposed to be distinguished from the electrolyzed water IW disposed outside the pipe part 1110.

For example, the fluid WT may be disposed inside the heat dissipation part 1130 of the pipe part 1110, and the fluid WT and the electrolyzed water IW may be disposed to be distinguished from each other through the heat dissipation part 1130. A detailed description of the heat dissipation part 1130 will be provided later.

The body part 1120 may be formed in such a shape that the entry and exit of the electrolyzed water IW are controlled, and may be formed in such a manner that the electrolyzed water IW does not unexpectedly leak to the outside after filling the inside of the body part 1120. In an embodiment, an inlet (not shown) and an outlet (not shown) for replenishing or discharging the electrolyzed water IW may be formed in the body part 1120.

The body part 1120 may include the electrode part 1140 having one or more electrodes.

At least one region of the electrode part 1140 may be disposed on an inner side of the body part 1120, for example, may be disposed on an outer side of the pipe part 1110.

In addition, the electrode part 1140 may be disposed to overlap the electrolyzed water IW to heat the electrolyzed water IW at an outer region of the heat dissipation part 1130.

In addition, the electrode part 1140 may overlap the fluid WT, which is disposed inside the pipe part 1110, with respect to one direction.

In an embodiment, the electrode part 1140 may include a plurality of electrodes.

For example, the electrode part 1140 may include a first electrode 1141 and a second electrode 1142.

Specifically, each of the first electrode 1141 and the second electrode 1142 may be disposed inside the body part 1120 so as to be in contact with the electrolyzed water IW. Although not shown in the drawing, current may be applied to the first electrode 1141 and the second electrode 1142 under control of an electrode control part (not shown), and a control part (not shown) may control the current applied to the electrode part 1140.

In an optional embodiment, the first electrode 1141 and the second electrode 1142 may include a first terminal 1141T and a second terminal 1142T, respectively, and a power source may be connected thereto respectively through the first terminal 1141T and the second terminal 1142T.

The electrolyzed water IW may be heated by the current applied to the first electrode 1141 and the second electrode 1142 of the electrode part 1140. Heat generated by heating of the electrolyzed water IW is transferred to the fluid WT in the pipe part 1110, and the fluid WT may be heated. That is, the body part 1120 may convert electrical energy into thermal energy to heat the electrolyzed water IW disposed inside the body part 1120, and the thermal energy transferred to the electrolyzed water IW may be transferred to the fluid WT in the pipe part 1110.

The first electrode 1141 and the second electrode 1142 may be disposed to be spaced apart from each other with an interval in an inner space of the body part 1120.

For example, the first electrode 1141 and the second electrode 1142 may be spaced apart from each other with an interval in an outer space of the heat dissipation part 1130 of the body part 1120, and may each have an elongated shape, specifically a linear shape.

One end portions of the first electrode 1141 and the second electrode 1142, which are formed by extending from the first electrode 1141 and the second electrode 1142, respectively, may be spaced apart from a region of the body part 1120, specifically, a bottom surface of the body part 1120. In a specific example, each of the end portions, which are oriented in an opposite direction from the first terminal 1141T and the second terminal 1142T, may be formed to be spaced apart from the bottom surface of the body part 1120.

Accordingly, the risk of occurrence of electrical leakage or short circuits, which may occur due to the direct contact between the body part 1120 and the electrode part 1140, may be reduced, and a heating process for the electrolyzed water IW may be stably performed.

Further, a conductive part (not shown) connected to one regions of the first electrode 1141 and the second electrode 1142, for example, the first terminal 1141T and the second terminal 1142T, may be included so that current is applied to the first electrode 1141 and the second electrode 1142, and the conductive part (not shown) is a conductor in the form of a wire and may be connected to the electrode control part (not shown).

In this case, the electrode part 1140 may be provided in a two-phase form, and may include the first electrode 1141 and the second electrode 1142.

In an optional embodiment, the first electrode 1141 and the second electrode 1142 may be respectively disposed on both sides with respect to the pipe part 1110. For example, the first electrode 1141 and the second electrode 1142 may be disposed in different directions with respect to the pipe part 1110, and in a specific embodiment, the first electrode 1141 and the second electrode 1142 may be disposed in opposite directions. Thus, the electrolyzed water IW can be uniformly heated by the first electrode 1141 and the second electrode 1142.

The heat dissipation part 1130 may be a device disposed to distinguish between the electrolyzed water IW and the fluid WT. For example, the heat dissipation part 1130 may be disposed between the electrolyzed water IW and the fluid WT, and specifically, may be formed to define an internal space of the pipe part 1110. In addition, the heat dissipation part 1130 may be formed to be spaced apart from the electrode part 1140.

For example, the heat dissipation part 1130 may have an elongated shape having a length in the same direction with a longitudinal direction of the pipe part 1110, and specifically, may form the flow path of the pipe part 1110. Thus, the heat dissipation part 1130 may be connected to at least one surface of the body part 1120, and in an optional embodiment, the heat dissipation part 1130 may be connected to an upper surface and a lower surface of the body part 1120. That is, the heat dissipation part 1130 may be disposed between the inlet 1112 and the outlet 1111 of the pipe part 1110.

Accordingly, the unheated fluid CW introduced via the inlet 1112 may remain in contact with the heat dissipation part 1130 for a relatively long period of time while remaining inside the heat dissipation part 1130 or moving along the internal space. That is, the unheated fluid CW can receive heat from the heated electrolyzed water IW for a long period of time, thereby improving heating efficiency.

As described above, the heat dissipation part 1130 may be in contact with the electrolyzed water IW and the fluid WT, and for example, an outer surface of the heat dissipation part 1130 may be in contact with the electrolyzed water IW, and an inner surface of the heat dissipation part 1130 may be in contact with the fluid WT.

The heat dissipation part 1130 may be formed of a material having high thermal conductivity, and may be formed to include, for example, a metal material. Heat of the electrolyzed water IW may be easily transferred to the fluid WT through the heat dissipation part 1130.

The heat dissipation part 1130 may be formed to surround one region, in which the fluid WT is disposed, and thus surround an outer side of the region in which the fluid WT is disposed.

Further, the electrolyzed water IW may be disposed to surround the heat dissipation part 1130 on an outer side of the heat dissipation part 1130.

In an embodiment, the heat dissipation part 1130 may include an insulating layer.

Referring to FIG. 3, in an optional embodiment, the heat dissipation part 1130 may include a first insulating layer IIL1 on a side surface facing the electrolyzed water IW and a second insulating layer IIL2 on a side surface facing the fluid WT.

In addition, in another optional embodiment, the heat dissipation part 1130 may include only the first insulating layer IIL1 on the side surface facing the electrolyzed water IW, or may include only the second insulating layer IIL2 on the side surface facing the fluid WT.

In an embodiment, the first insulating layer IIL1 or the second insulating layer IIL2 may include an inorganic layer, such as a ceramic material or the like.

In another example, the first insulating layer ELI or the second insulating layer IIL2 may include an organic layer such as a resin layer, and may also include an insulating Teflon resin layer as a specific example.

The first insulating layer IIL1 may reduce the current flowing to the heat dissipation part 1130 through the electrolyzed water IW, and may reduce or prevent the flow of the leaked current from remaining in the pipe part 1110 or the fluid WT. Furthermore, when leakage current components remain in the heat dissipation part 1130, the first insulating layer IIL1 may reduce or prevent the leakage current components from flowing to the fluid WT, thereby reducing the occurrence of an electrical accident that may occur during the flow of the fluid WT.

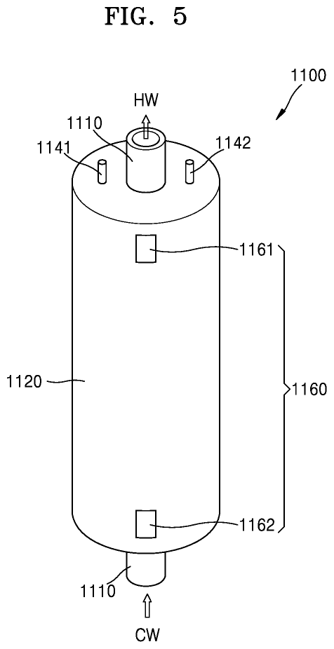

FIG. 5 is a view schematically illustrating an embodiment of the heating device 1100 including a temperature sensor 1160.

Referring to FIG. 5, the heating device 1100 according to the present embodiment may further include the temperature sensor 1160.

The temperature sensor 1160 may be a device for measuring a temperature of the electrolyzed water IW inside the body part 1120 or a temperature of the fluid WT disposed inside the pipe part 1110. For example, the temperature sensor 1160 may measure the temperature of the electrolyzed water IW or the fluid WT to determine whether the temperature is maintained within a predetermined temperature range.

In an optional embodiment, a plurality of temperature sensors 1160 may be provided. For example, the temperature sensors 1160 may include a first temperature sensor 1161 and a second temperature sensor 1162.

The first temperature sensor 1161 and the second temperature sensor 1162 may be disposed at positions spaced apart from each other. For example, the first temperature sensor 1161 may be disposed on the body part 1120 to be adjacent to the outlet 1111 of the pipe part 1110. In addition, the second temperature sensor 1162 may be disposed on the body part 1120 to be adjacent to the inlet 1112 of the pipe part 1110. However, the temperature sensors 1160 are not necessarily disposed at both the position adjacent to the outlet 1111 of the pipe part 1110 and the position adjacent to the inlet 1112 of the pipe part 1110, but may be disposed at either position.

In an optional embodiment, the temperature sensor 1160 may be further disposed at a position adjacent to a path through which the fluid WT flows. Thus, the temperature sensors 1160 may be disposed at a plurality of positions and paths, via which the fluid WT is introduced, flows, and is discharged, to measure the temperature of the electrolyzed water IW or the fluid WT at various positions.

Accordingly, it can be more easily determined whether the electrolyzed water IW or the fluid WT is maintained at a predetermined temperature, and the heating device 1100 can be controlled to heat the fluid WT to a required temperature.

In addition, specific descriptions of the pipe part 1110, the body part 1120, the fluid WT, the electrolyzed water IW, the electrode part 1140, and the like will be omitted as the contents described in the above-described embodiments may be selectively applied or may be modified and applied as necessary.

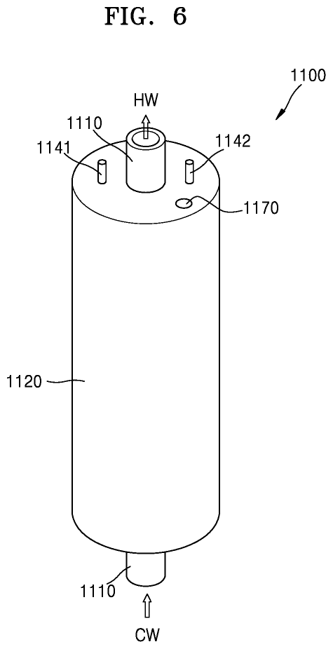

FIG. 6 is a view schematically illustrating an embodiment of the heating device 1100 including an overheating sensor 1170.

In the embodiment of FIG. 6, the description of the above-described embodiments may be selectively applied or modified and applied as necessary, and thus, differences from the above-described embodiments will be mainly described.

Referring to FIG. 6, the heating device 1100 may further include the overheating sensor 1170. For example, the overheating sensor 1170 may be disposed in at least one region of the body part 1120.

The overheating sensor 1170 may be a device for measuring whether the electrolyzed water IW disposed inside the body part 1120 or the fluid WT disposed inside the pipe part 1110 is heated to a predetermined temperature or higher. Thus, accidents due to overheating may be prevented in advance, or it is possible to measure whether the fluid WT is heated to a desired temperature and discharged.

In an optional embodiment, the overheating sensor 1170 may be disposed at a position adjacent to the outlet 1111 of the pipe part 1110. Accordingly, the temperature of the fluid WT finally discharged from the heating device 1100 can be measured to determine whether the fluid WT at a desired temperature is discharged, or to determine whether the electrolyzed water IW is heated to a temperature within a safe range.

In an additional embodiment, the heating device 1100 may further include a cooling part to control the overheating of the electrolyzed water IW when the temperature sensor 1160 measures that the electrolyzed water IW reaches an overheated temperature.

The control part may be provided to control a current applied to the electrode part 1140. A current applied to each of the first electrode 1141 and the second electrode 1142 of the electrode part 1140 may be controlled through the control part, and in an optional embodiment, real-time control may be performed.

At this time, the control part may check the amount of current applied to the electrode part 1140 and control the current by increasing or decreasing the amount of current according to a set value, thereby preventing a sudden change in the temperature of the electrolyzed water IW.

The control part may have various shapes to facilitate changes in current. For example, the control part may include various types of switches, and may include a non-contact relay such as a solid state relay (SSR) for sensitive and rapid control.

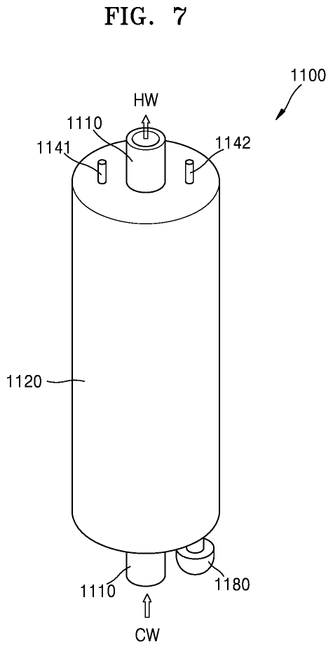

FIG. 7 is a view schematically illustrating an embodiment of the heating device 1100 including a buffer part 1180.

In the embodiment of FIG. 7, the description of the above-described embodiments may be selectively applied or modified and applied as necessary, and thus, differences from the above-described embodiments will be mainly described.

Referring to FIG. 7, the heating device 1100 may further include the buffer part 1180.

The buffer part 1180 may be a device for buffering thermal expansion caused by heating.

That is, the fluid WT expands in volume when heated, and thus, when the electrolyzed water IW disposed in the body part 1120 is excessively overheated, the volume of the electrolyzed water IW may become larger than the volume inside the body part 1120, or when a gas is present in the body part 1120, the pressure inside the body part 1120 may be excessively increased as the gas is heated. In this case, the body part 1120 may be damaged or the electrolyzed water IW may leak. Alternatively, the pipe part 1110 may be damaged, causing the mixing of the electrolyzed water IW and the fluid WT.

The buffer part 1180 may be connected to the body part 1120 to buffer an increase in volume due to thermal expansion occurring in the body part 1120.

In an embodiment, the body part 1120 and the buffer part 1180 may be in communication with each other so that the electrolyzed water IW or air can be distributed therebetween. In addition, the buffer part 1180 may be formed of an elastic material, and thus may increase in volume to buffer an increase in pressure inside the buffer part 1180 and, conversely, decrease in volume when the pressure inside the buffer part 1180 decreases.

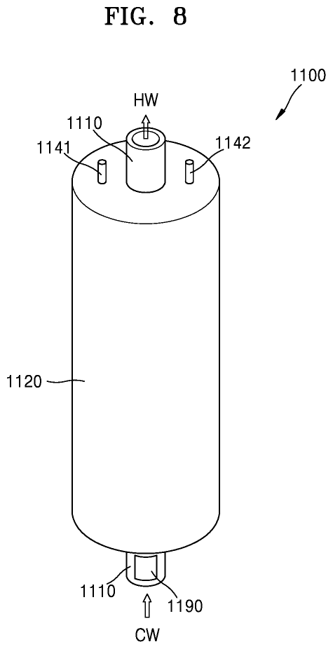

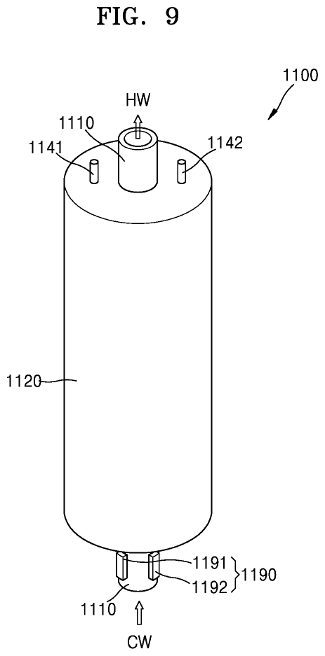

FIG. 8 is a view schematically illustrating an embodiment of the heating device 1100 including a control unit 1190, and FIG. 9 is a view schematically illustrating a modified example of FIG. 8.

In the embodiments of FIGS. 8 and 9, the description of the above-described embodiments may be selectively applied or modified and applied as necessary, and thus, differences from the above-described embodiments will be mainly described.

Referring to FIG. 8, the heating device 1100 may further include the control unit 1190. For example, the control unit 1190 may be one component included in the above-described control part (not shown), and in another example, the control unit 1190 may be an additional component provided separately.

The control unit 1190 may be a device for performing control over at least one component of the heating device 1100. For example, the control unit 1190 may control circuits for providing power. In a specific example, the control unit 1190 may control the flow of current supplied to the electrode part 1140. Accordingly, the heating of the electrolyzed water IW may be precisely performed, and thus, the temperature control of the fluid WT may be stably performed.

In an embodiment, the control unit 1190 may include a thyristor, for example, a power thyristor. Thus, the control unit 1190 may easily and stably control the temperature of the fluid WT or the electrolyzed water IW.

Meanwhile, the control unit 1190 may generate heat during operation, and when the control unit 1190 includes a thyristor, the control unit 1190 may generate more heat due to the nature of the thyristor.

In an embodiment, the heat generated in the control unit 1190 may be exchanged with the fluid WT. For example, the control unit 1190 may be disposed so as to overlap the fluid WT, and specifically, the control unit 1190 may be disposed in at least one position of the pipe part 1110 so as to overlap the fluid WT. Accordingly, the control unit 1190 may be cooled by the fluid WT, and conversely, the fluid WT may be heated by the control unit 1190, which has the advantage of efficiently utilizing heat.

In a specific embodiment, the control unit 1190 may be disposed at a position via which the fluid WT is introduced. For example, the control unit 1190 may be disposed at a position adjacent to the inlet 1112 of the pipe part 1110. Thus, the control unit 1190 may heat the fluid WT flowing into the heating device 1100 in advance so that the fluid WT can be rapidly heated to a desired temperature.

In another embodiment, the heat generated in the control unit 1190 may be exchanged with the electrolyzed water IW. For example, the control unit 1190 may be disposed to overlap the electrolyzed water IW, and specifically, the control unit 1190 may be disposed in at least one position of the body part 1120 so as to overlap the electrolyzed water IW. Thus, the control unit 1190 may be cooled by the electrolyzed water IW, and conversely, the electrolyzed water IW may be heated by the control unit 1190, which has the advantage of efficiently utilizing heat.

In a specific embodiment, the control unit 1190 may be disposed on the body part at a position adjacent to the inlet 1112. For example, the control unit 1190 may be disposed on one lower side surface of the body part 1120 based on FIG. 8. Thus, the control unit 1190 can heat the electrolyzed water IW disposed at a position adjacent to the fluid WT flowing into the heating device 1100 in advance so that the fluid WT can be rapidly heated to a desired temperature.

In an optional embodiment, the control unit 1190 may be formed in the form of a plate. For example, the control unit 1190 may be formed to correspond to the outer surface of the pipe part 1110 or the body part 1120 so as to be disposed along one surface of the pipe part 1110 or the body part 1120. Specifically, the control unit 1190 may be formed in the form of a plate of which at least a portion is formed to be curved. Accordingly, even when the control unit 1190 is disposed on one surface of the pipe part 1110 or the body part 1120, a portion of the pipe part 1110 or the body part 1120 may not protrude. In addition, an area in which the control unit 1190 overlaps the fluid WT or the electrolyzed water IW increases so that heat exchange can be more efficiently performed.

Referring to FIG. 9, a plurality of control units 1190 may be disposed. For example, the control unit 1190 may include a first control unit 1191 and a second control unit 1192.

The first control unit 1191 and the second control unit 1192 may perform control of at least one component of the heating device 1100.

In an embodiment, the first control unit 1191 and the second control unit 1192 may be identically configured. Thus, by including the plurality of control units 1190, it is possible to more rapidly and efficiently perform heat exchange with the fluid WT or the electrolyzed water IW.

In an optional embodiment, the first control unit 1191 and the second control unit 1192 may be disposed at the inlet 1112 of the pipe part 1110, and specifically, the first control unit 1191 and the second control unit 1192 may be disposed on one surface of the inlet 1112 along a circumference of the inlet 1112 so as to be spaced apart from each other by a predetermined distance. Thus, a large amount of heat exchange with the fluid WT introduced into the heating device 1100 via the inlet 1112 can be performed, thereby enabling the fluid WT to be rapidly and efficiently heated to a desired temperature.

However, the present disclosure is not limited thereto, and of course, more than the above number of control units 1190 may be provided. In this case, in an optional embodiment, at least one control unit 1190 is disposed in the body part 1120 at a position adjacent to the inlet 1112.

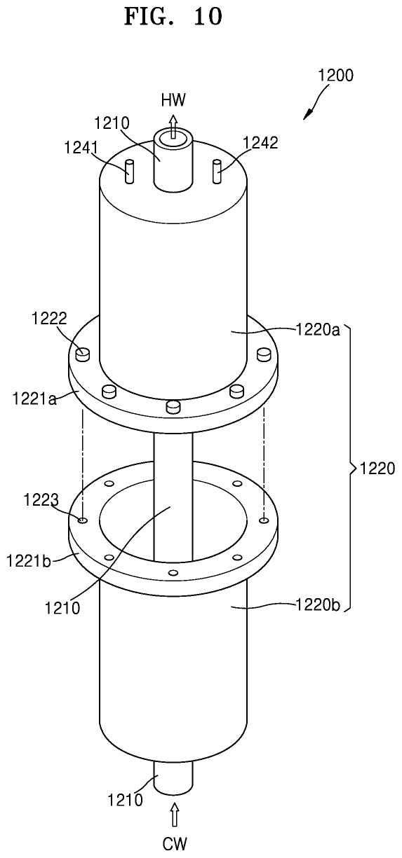

FIG. 10 is a view schematically illustrating a heating device 1200 according to another embodiment of the present disclosure.

Referring to FIG. 10, the heating device 1200 according to the present embodiment may include a pipe part 1210 and a body part 1220.

A fluid may be disposed inside the pipe part 1210. The fluid may include various types, for example, a liquid or a gas.

The pipe part 1210 may be formed in the shape of a pipe including an outer wall and an inner wall and having a space therein in which the fluid WT may be disposed. For example, the pipe part 1210 may be formed in the shape of a pipe having a circular cross-section. In another example, the pipe part 1210 may be formed in the shape of a pipe having a polygonal cross-section. For example, the pipe part 1210 may be formed in the shape of a pipe having a rectangular cross-section. In another example, the pipe part 1210 may be formed in the shape of a pipe having a curved cross-section similar to an ellipse.

The body part 1220 may be a device disposed to surround at least one region of the pipe part 1210 and configured to heat the fluid WT disposed inside the pipe part 1210.

The body part 1220 may have various shapes, and for example, may be formed in the shape of a hollow box having a space provided therein.

In an optional embodiment, the body part 1220 may be formed in a columnar shape, for example, may be formed in the shape of a cylinder having a space provided therein. In another example, the body part 1220 may be formed in a prismatic columnar shape, for example, may be formed in the shape of a square column. In another example, the body part 1220 may be formed in the shape of a column including a curved surface whose bottom surface is similar to an ellipse.

The pipe part 1210 may be formed to be longer than the body part 1220.

In an embodiment, the pipe part 1210 may be disposed to cross the inside of the body part 1220. For example, the pipe part 1210 may be disposed to pass through the body part 1220. Accordingly, when the fluid WT is disposed inside the pipe part 1210, at least a portion of the fluid WT may be disposed inside the body part 1220.

In an optional embodiment, the pipe part 1210 may include an inlet 1212 via which the fluid WT flows in an inward direction of the body part 1220, and an outlet 1211 via which the fluid WT is discharged in an outward direction of the body part 1220. For example, the pipe part 1210 may include the inlet 1212 at one side and the outlet 1211 at another side, and may include a flow path, in which the fluid WT is disposed, between the inlet 1212 and the outlet 1211.

Accordingly, the fluid WT may flow into the pipe part 1210, and for example, the fluid WT may be introduced via the inlet 1212 of the pipe part 1210 and may be discharged to the outside via the outlet 1211 through the flow path.

Specifically, an unheated fluid CW before being heated may be introduced via the inlet 1212 of the pipe part 1210. For example, the unheated fluid CW may include room-temperature water or low-temperature water.

A heated fluid HW may be discharged via the outlet 1211 and, for example, a fluid WT including water having a temperature higher than that of the unheated fluid CW introduced via the inlet 1212 may be discharged.

The electrolyzed water IW may be disposed inside the body part 1220, and an electrode part 1240 for heating the electrolyzed water IW may be included in the body part 1220. The electrode part 1240 may include at least one electrode.

In an embodiment, the fluid WT and the electrolyzed water IW may be disposed to overlap each other, and for example, the electrolyzed water IW may be disposed to surround the side surface of the pipe part 1210. That is, since the electrolyzed water IW is disposed inside the body, and the fluid WT is disposed inside the pipe part 1210, the electrolyzed water IW and the fluid WT may be disposed to overlap each other.

The pipe part 1210 may include a heat dissipation part 1230. For example, the heat dissipation part 1230 may be a region which is disposed between the fluid WT and the electrolyzed water IW and in which heat is exchanged between the fluid WT and the electrolyzed water IW.

As described above, an inner space may be provided in the pipe part 1210, and the inner space of the pipe part 1210 may be determined by the heat dissipation part 1230.

The fluid WT may be disposed inside the pipe part 1210. The fluid WT may be disposed to be distinguished from the electrolyzed water IW disposed outside the pipe part 1210.

For example, the fluid WT may be disposed inside the heat dissipation part 1230 of the pipe part 1210, and the fluid WT and the electrolyzed water IW may be disposed to be distinguished from each other through the heat dissipation part 1230.

The body part 1220 may include the electrode part 1240 having one or more electrodes.

At least one region of the electrode part 1240 may be disposed on an inner side of the body part 1220, for example, may be disposed on an outer side of the pipe part 1210.

In addition, the electrode part 1240 may be disposed to overlap the electrolyzed water IW to heat the electrolyzed water IW at an outer region of the heat dissipation part 1230.

In addition, the electrode part 1240 may overlap the fluid WT, which is disposed inside the pipe part 1210, with respect to one direction.

In an embodiment, the electrode part 1240 may include a plurality of electrodes.

For example, the electrode part 1240 may include a first electrode 1241 and a second electrode 1242.

Specifically, each of the first electrode 1241 and the second electrode 1242 may be disposed inside the body part 1220 so as to be in contact with the electrolyzed water IW. Although not shown in the drawing, current may be applied to the first electrode 1241 and the second electrode 1242 under control of an electrode control part (not shown), and a control part (not shown) may control the current applied to the electrode part 1240.

The electrolyzed water IW may be heated by the current applied to the first electrode 1241 and the second electrode 1242 of the electrode part 1240. Heat generated by heating of the electrolyzed water IW is transferred to the fluid WT in the pipe part 1210, and the fluid WT may be heated. That is, the body part 1220 may convert electrical energy into thermal energy to heat the electrolyzed water IW disposed inside the body part 1220, and the thermal energy transferred to the electrolyzed water IW may be transferred to the fluid WT in the pipe part 1210.

In an embodiment, the body part 1220 may include a first body part 1220a and a second body part 1220b. For example, the body part 1220 may be formed by coupling the first body part 1220a and the second body part 1220b to each other.

Each of the first body part 1220a and the second body part 1220b may be formed in a shape having a space therein. In this case, when the first body part 1220a and the second body part 1220b are coupled to each other, the spaces provided in the first body part 1220a and the second body part 1220b communicate with each other to form a single internal space.

In an optional embodiment, the first body part 1220a may include a first coupling part 1221a, and the second body part 1220b may include a second coupling part 1221b. The first coupling part 1221a and the second coupling part 1221b are coupled to each other such that the first body part 1220a and the second body part 1220b are coupled to each other. For example, the first coupling part 1221a may include a first coupling member 1222, and the second coupling part 1221b may include a first coupling hole 1223 to which the first coupling member 1222 is coupled. That is, the first coupling member 1222 may be a member for coupling a screw, a bolt, a nail, or the like, and the first coupling hole 1223 may be a component that allows the first coupling member 1222 to be inserted therein so that the first coupling part 1221a is firmly coupled to the second coupling part 1221b.

In another optional embodiment, the first body part 1220a and the second body part 1220b may be coupled to each other using means such as welding or bonding without using a member.

In another optional embodiment, the first body part 1220a and the second body part 1220b may be coupled to each other through a member for coupling, and then further coupled to each other through means such as welding or bonding.

By including such a configuration, the heating device 1200 can be easily fabricated. That is, after preparing each of the first body part 1220a and the second body part 1220b, the pipe part 1210 is disposed to pass through the first body part 1220a and the second body part 1220b, and the first body part 1220a is coupled to the second body part 1220b to form the body part 1220.

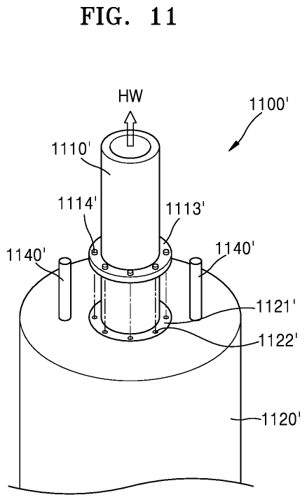

FIG. 11 is a view for describing an embodiment (1100′) in which a pipe part 1110′ and a body part 1120′ are coupled to each other.

Referring to FIG. 11, the pipe part 1110′ may be disposed to pass through the body part 1120′, and the pipe part 1110′ may be fixedly coupled to the body part 1120′.

In an embodiment, the pipe part 1110′ may include a third coupling part 1113′ for coupling to the body part 1120′. The third coupling part may be formed along an outer circumferential surface of the pipe part 1110′. The third coupling part 1113′ is coupled to at least a portion of the body part 1120′, and thus, the pipe part 1110′ and the body part 1120′ may eventually be firmly fixed to each other.

In an optional embodiment, the third coupling part 1113′ may include a third coupling member 1114′, and the body part 1120′ may include a pipe coupling part 1121′ for coupling to the third coupling part 1113′. In this case, the pipe coupling part 1121′ may include a second coupling hole 1122′ to which the third coupling member 1114′ is coupled. That is, the third coupling member 1114′ may be a member for coupling a screw, a bolt, a nail, or the like, and the second coupling hole 1122′ may be a component that allows the third coupling member 1114′ to be inserted therein so that the pipe part 1110′ is firmly coupled to the body part 1120′.

In another optional embodiment, the pipe part 1110′ and the body part 1120′ may be coupled to each other through welding, bonding, or the like without using a separate member for coupling.

In another optional embodiment, the pipe part 1110′ and the body part 1120′ may be coupled to each other through a separate member for coupling, and then further coupled to each other through means such as welding or bonding.

Accordingly, the pipe part 1110′ may be easily and firmly coupled to the body part 1120′. That is, it is possible to prevent the pipe part 1110′ from being separated or decoupled from the body part 1120′.

In addition, specific descriptions of the pipe part 1110′, the body part 1120′, an electrode part 1140′, a fluid WT, an electrolyzed water IW, and the like will be omitted as the contents described in the above-described embodiments may be selectively applied or may be modified and applied as necessary.

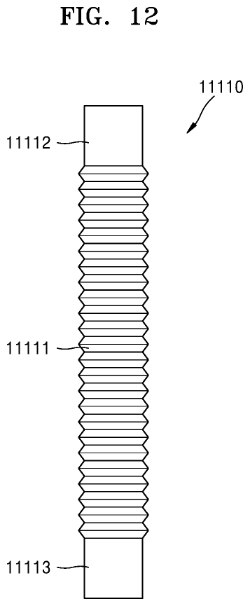

FIG. 12 is a view schematically illustrating an embodiment of the pipe part 1110 of FIG. 1.

Referring to FIG. 12, a pipe part 11110 may include an inflow region 11113 on one side, a discharge region 11112 on another side, and a flow path region 11111 positioned between the inflow region and the discharge region 11112.

The inflow region 11113 may be a region via which the unheated fluid CW is introduced, and the discharge region 11112 may be a region via which the heated fluid HW is discharged. For example, the fluid WT may be introduced via the inflow region 11113, heated by the body part 1120 while passing through the flow path region 11111, and then discharged to the outside via the discharge region 11112.

In an embodiment, the body part 1120 may include two grooves through which the pipe part 11110 passes. For example, the inflow region 11113 of the pipe part 11110 may be inserted into one groove included in the body part 1120, and the discharge region 11112 of the pipe part 11110 may be inserted into the other groove.

In an optional embodiment, an outer circumferential surface of the flow path region 11111 may include a plurality of ridges and valleys. For example, the outer circumferential surface of the flow path region 11111 may be formed in a shape similar to an outer shape of a bellows. In another example, the outer circumferential surface of the flow path region 11111 may include a plurality of protrusions formed to protrude outward.

Thus, in a state in which the flow path region 11111 is disposed inside the body part 1120, an area in contact with the electrolyzed water IW may increase. Accordingly, the fluid WT passing through the flow path region 11111 can receive heat from the electrolyzed water IW more efficiently.

In an optional embodiment, an outer circumferential surface of the inflow region 11113 may be formed in the shape of a gently curved surface. For example, the outer circumferential surface of the inflow region 11113 may not include a protruding or recessed region. Thus, coupling characteristics when the inflow region 11113 is coupled to the groove included in the body part 1120 may be improved. For example, the inflow region 11113 may not include an empty gap caused by a portion of the inflow region 11113 protruding or recessing when coupled to the groove included in the body part 1120. Thus, the electrolyzed water IW disposed inside the body part 1120 may be prevented from leaking to the outside, or foreign substances or gas from the outside may be prevented from flowing into the body part 1120.

In an optional embodiment, an outer circumferential surface of the discharge region 11112 may be formed in the shape of a gently curved surface. For example, the outer circumferential surface of the discharge region 11112 may not include a protruding or recessed region. Thus, coupling characteristics when the discharge region 11112 is coupled to the groove included in the body part 1120 may be improved. For example, the discharge region 11112 may not include an empty gap caused by a portion of the discharge region 11112 protruding or recessing when coupled to the groove included in the body part 1120. Thus, the electrolyzed water IW disposed inside the body part 1120 may be prevented from leaking to the outside, or foreign substances or gas from the outside may be prevented from flowing into the body part 1120.

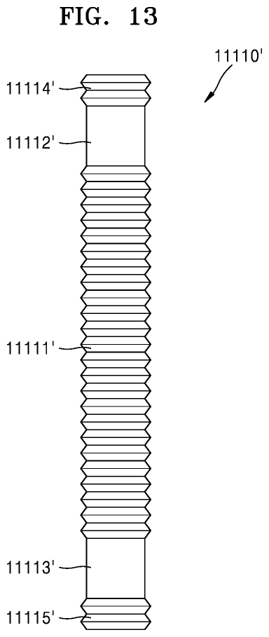

FIG. 13 is a view schematically illustrating a modified example (11110′) of FIG. 12.

For convenience of description, differences from the embodiment (11110) described above with reference to FIG. 12 will be mainly described.

Referring to FIG. 13, a pipe part 11110′ may include an inflow region 11113′ on one side, a discharge region 11112′ on another side, and a flow path region 11111′ positioned between the inflow region and the discharge region 11112′.

The inflow region 11113′ may be a region via which the unheated fluid CW is introduced, the discharge region 11112′ may be a region via which the heated fluid HW is discharged, and the flow path region 11111′ may be a path via which the fluid WT introduced via the inflow region 11113′ moves toward the discharge region 11112′. In an embodiment, the body part 1120 may include two grooves through which the pipe part 11110′ passes. For example, the inflow region 11113′ of the pipe part 11110′ may be inserted into one groove included in the body part 1120, and the discharge region 11112′ of the pipe part 11110′ may be inserted into the other groove.

In an optional embodiment, an outer circumferential surface of the flow path region 11111′ may include a plurality of ridges and valleys. Thus, in a state in which the flow path region 11111′ is disposed inside the body part 1120, an area in contact with the electrolyzed water may increase. Accordingly, the fluid WT passing through the flow path region 11111′ may receive heat from the electrolyzed water more efficiently.

In an embodiment, an outer circumferential surface of the inflow region 11113′ may be formed in the shape of a gently curved surface. In an optional embodiment, one end of the inflow region 11113′ may be connected to the flow path region 11111′, and another end thereof may include an inflow outer region 11115′ including a plurality of ridges and valleys. For example, the outer circumferential surface of the inflow region 11113′ may not include a protruding or recessed region, and the inflow outer region 11115′ may include a protruding or recessed region.

Thus, coupling characteristics when the inflow region 11113′ is coupled to the groove included in the body part 1120 may be improved. For example, the inflow region 11113′ may be coupled to the body part 1120 without a gap to prevent the electrolyzed water from leaking out or the foreign substances and gases from flowing in.

In addition, when the inflow outer region 11115′ is connected to another device, an area in contact with the other device may increase, and thus heat exchange efficiency may be improved. For example, when the inflow outer region 11115′ is connected to a separate heating device, heat may be efficiently transferred from the separate heating device. Alternatively, when the inflow outer region 11115′ is connected to another device, heat exchange with the other device may be efficiently performed.

In another embodiment, an outer circumferential surface of the discharge region 11112′ may be formed in the shape of a gently curved surface. In an optional embodiment, one end of the discharge region 11112′ may be connected to the flow path region 11111′, and another end thereof may include a discharge outer region 11114′ including a plurality of ridges and valleys. For example, the outer circumferential surface of the discharge region 11112′ may not include a protruding or recessed region, and the discharge outer region 11114′ may include a protruding or recessed region.

Thus, coupling characteristics when the discharge region 11112′ is coupled to the groove included in the body part 1120 may be improved. For example, the discharge region 11112′ may be coupled to the body part 1120 without a gap to prevent the electrolyzed water from leaking out or the foreign substances and gases from flowing in.

In addition, when the discharge outer region 11114′ is connected to another device, an area in contact with the other device may increase, and thus heat exchange efficiency may be improved. For example, when the discharge outer region 11114′ is connected to a separate heating device, heat may be efficiently transferred from the separate heating device. Alternatively, when the discharge outer region 11114′ is connected to another device, heat exchange with the other device may be efficiently performed.

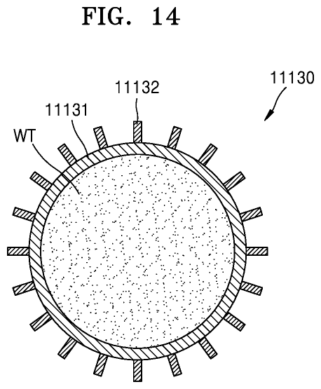

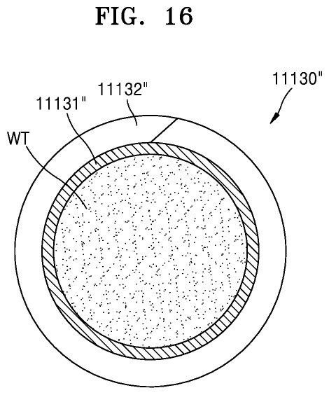

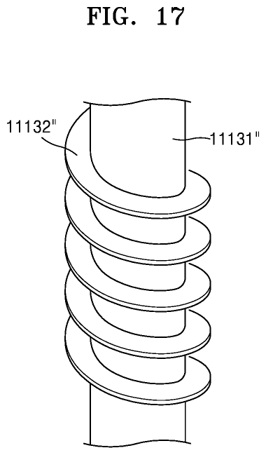

FIGS. 14 to 16 are views schematically illustrating various modified examples of the pipe part, and FIG. 17 is a view illustrating a portion of a perspective view of FIG. 16.

Specific descriptions of the body part 1120, the fluid WT, the electrolyzed water IW, the electrode part 1140, and the like will be omitted as the contents described in the above-described embodiments may be selectively applied or may be modified and applied as necessary.

Referring to FIG. 14, in a modified example, a heat dissipation part 11130 of a pipe part 11130 may include a base 11131 and a protrusion 11132.

The base 11131 may be a component that forms the entire outer shape of the heat dissipation part 11130.

The base 11131 may be formed in a shape surrounding the fluid WT, and may be formed in a shape similar to, for example, a cylinder.

A space may be provided on an inner side of the base 11131, and the electrode part 1140 may be disposed on an outer side of the base 11131.

The protrusion 11132 may be a component for easily transferring heat from the electrolyzed water IW to the heat dissipation part 11130. For example, the protrusion 11132 may be a component of increasing a contact area with the electrolyzed water IW to allow heat to be easily transferred from the electrolyzed water IW to the heat dissipation part 11130, thereby improving heat transfer efficiency.

The protrusion 11132 may be connected to the base 11131 and formed to protrude outward from the base 11131.

In an embodiment, a plurality of protrusions 11132 may be provided, for example, a plurality of protrusions 11132 may be provided along an outer circumference of the base 11131.

In an optional embodiment, each of the plurality of protrusions 11132 may have a shape extending in one direction, and for example, each of the protrusions 11132 may extend in a normal direction from an outer surface of the base 11131. In addition, the protrusions 11132 may be disposed to be spaced apart from each other, and accordingly, a spaced region may be formed between the protrusions 11132 and the electrolyzed water IW may be filled therein.

In an optional embodiment, each of the plurality of protrusions 11132 may have an elongated shape in a longitudinal direction of the heat dissipation part 11130, and may have a length in a direction parallel to the longitudinal direction of the heat dissipation part 11130, for example, to a longitudinal direction of the base 11131.

Further, in another example, each of the plurality of protrusions 11132 may have a length in a direction having an acute angle or an obtuse angle without being parallel to the longitudinal direction of the base 11131.

Further, in another example, each of the plurality of protrusions 11132 may be formed to be curved with respect to the longitudinal direction of the base 11131.

With such a configuration, a contact area between the protrusions 11132 and the electrolyzed water IW may be increased, and heat transfer efficiency may be improved.

The heat dissipation part 11130 may be formed of a material having high thermal conductivity, and may be formed to include, for example, a metal material. Heat of the electrolyzed water 1HT may be easily transferred to the fluid WT through the heat dissipation part 11130.

Further, in an optional embodiment, the heat dissipation part 11130 may include an insulating layer (not shown) on one side facing the fluid WT, and in another example, the heat dissipation part 11130 may include an insulating layer (not shown) on one side facing the electrolyzed water IW. This may reduce or prevent current from flowing through the heat dissipation part 11130 from the electrolyzed water IW.

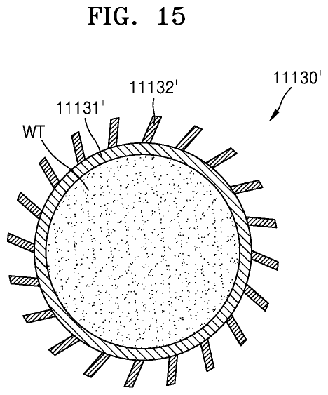

Referring to FIG. 15, in a modified example, a heat dissipation part 11130′ of a pipe part 11130′ may include a base 11131′ and a protrusion 11132′.

The base 11131′ may be a component that forms the entire outer shape of the heat dissipation part 11130′.

The base 11131′ may be formed in a shape surrounding the fluid WT, and may be formed in a shape similar to, for example, a cylinder.

A space may be provided on an inner side of the base 11131′, and the electrode part 1140 may be disposed on an outer side of the base 11131′.

The protrusion 11132′ may be a component for easily transferring heat from the electrolyzed water IW to the heat dissipation part 11130′. For example, the protrusion 11132′ may be a component of increasing a contact area with the electrolyzed water IW to allow heat to be easily transferred from the electrolyzed water IW to the heat dissipation part 11130′, thereby improving heat transfer efficiency.

The protrusion 11132′ may be connected to the base 11131′ and formed to protrude outward from the base 11131′.

In an embodiment, a plurality of protrusions 11132′ may be provided, for example, a plurality of protrusions 11132′ may be provided along an outer circumference of the base 11131′.

In an optional embodiment, each of the plurality of protrusions 11132′ may be formed to protrude in an inclined direction with respect to an outer circumferential surface of the base 11131′. For example, each of the plurality of protrusions 11132′ may be formed to protrude to have an acute angle or an obtuse angle with respect to the outer circumferential surface of the base 11131′.

In addition, in a specific embodiment, each of the plurality of protrusions 11132′ may have a shape inclined in the same direction when each of the plurality of protrusions 11132′ has the shape inclined with respect to the outer circumferential surface of the base 11131′. In an example, as shown in FIG. 15, each of the plurality of protrusions 11132′ may have a shape inclined in a clockwise direction with respect to the outer circumferential surface of the base 11131′.

Accordingly, the electrolyzed water IW can flow along an inclined direction of the protrusion 11132′, so that, in the inner space of the body part 1120, the electrolyzed water IW can be easily moved, thereby improving the uniformity of heating.

In an optional embodiment, each of the plurality of protrusions 11132′ may have an elongated shape in a longitudinal direction of the heat dissipation part 11130′, and may have a length in a direction parallel to the longitudinal direction of the heat dissipation part 11130′, for example, to a longitudinal direction of the base 11131′.

Further, in another example, each of the plurality of protrusions 11132′ may have a length in a direction having an acute angle or an obtuse angle without being parallel to the longitudinal direction of the base 11131′.

Further, in another example, each of the plurality of protrusions 11132′ may be formed to be curved with respect to the longitudinal direction of the base 11131′.

With such a configuration, a contact area between the protrusions 11132′ and the electrolyzed water IW may be increased, and heat transfer efficiency may be improved.

The heat dissipation part 11130′ may be formed of a material having high thermal conductivity, and may be formed to include, for example, a metal material. Heat of the fluid WT may be easily transferred to the electrolyzed water IW through the heat dissipation part 11130′.

Further, in an optional embodiment, the heat dissipation part 11130′ may include an insulating layer (not shown) on one side facing the fluid WT, and in another example, the heat dissipation part 11130′ may include an insulating layer (not shown) on one side facing the electrolyzed water IW. This may reduce or prevent current from flowing through the heat dissipation part 11130′ from the electrolyzed water IW.

Referring to FIGS. 16 and 17, in a modified example, a heat dissipation part 11130″ of a pipe part 11130″ may include a base 11131″ and a protrusion 11132″.

The base 11131″ may be a component that forms the entire outer shape of the heat dissipation part 11130″.

The base 11131″ may be formed in a shape surrounding the fluid WT, and may be formed in a shape similar to, for example, a cylinder.

A space may be provided on an inner side of the base 11131″, and the electrode part 1140 may be disposed on an outer side of the base 11131″.

The protrusion 11132″ may be a component for easily transferring heat from the electrolyzed water IW to the heat dissipation part 11130″. For example, the protrusion 11132″ may be a component of increasing a contact area with the electrolyzed water IW to allow heat to be easily transferred from the electrolyzed water IW to the heat dissipation part 11130″, thereby improving heat transfer efficiency.

The protrusion 11132″ may be formed to protrude outward along an outer surface of the base 11131″, and in a specific embodiment, the protrusion 11132″ may be formed in the shape of a screw thread. For example, the protrusion 11132″ may be formed to be inclined while forming a wing shape along an outer circumference of the base 11131″.

In an optional embodiment, the protrusion 11132″ may include at least one connected portion extending from an upper portion to a lower portion of an outer surface of the base 11131″. However, not all regions necessarily have to be connected, and at least one discontinuous portion may also be included.

Accordingly, the electrolyzed water IW can flow along the screw thread of the protrusion 11132″, so that, in the inner space of the body part 1120, the electrolyzed water IW can be easily moved, thereby improving the uniformity of heating. That is, at least a portion of the electrolyzed water IW can continuously come into contact with the heat dissipation part 11130″ while moving along the screw thread-shaped protrusion 11132″, thereby improving heating efficiency and improving the uniformity of heating.

Further, with such a configuration, a contact area between the protrusions 11132″ and the electrolyzed water IW may be increased, and heat transfer efficiency may be improved.

The heat dissipation part 11130″ may be formed of a material having high thermal conductivity, and may be formed to include, for example, a metal material. Heat of the fluid WT may be easily transferred to the electrolyzed water IW through the heat dissipation part 11130″.

Further, in an optional embodiment, the heat dissipation part 11130″ may include an insulating layer (not shown) on one side facing the fluid WT, and in another example, the heat dissipation part 11130″ may include an insulating layer (not shown) on one side facing the electrolyzed water IW. This may reduce or prevent current from flowing through the heat dissipation part 11130″ from the fluid WT.

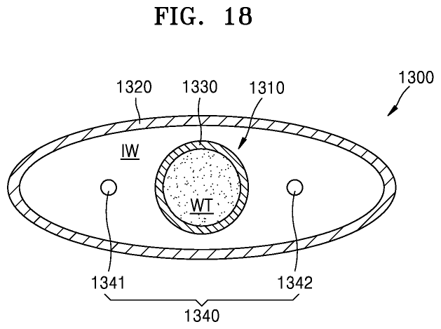

FIG. 18 is a view schematically illustrating a modified example (1300) of FIG. 4.

Referring to FIG. 18, a heating device according to the present modified example (1300) may include a pipe part 1310 and a body part 1320.

A fluid WT may be disposed inside the pipe part 1310. The fluid WT may include various types, for example, a liquid or a gas.

The pipe part 1310 may be formed in the shape of a pipe including an outer wall and an inner wall and having a space therein in which the fluid WT may be disposed. For example, the pipe part 1310 may be formed in the shape of a pipe having a circular cross-section. In another example, the pipe part 1310 may be formed in the shape of a pipe having a polygonal cross-section. For example, the pipe part 1310 may be formed in the shape of a pipe having a rectangular cross-section. In another example, the pipe part 1310 may be formed in the shape of a pipe having a curved cross-section similar to an ellipse.

The body part 1320 may be a device disposed to surround at least one region of the pipe part 1310 and configured to heat the fluid WT disposed inside the pipe part 1310.

An electrolyzed water IW may be disposed inside the body part 1320, and an electrode part 1340 for heating the electrolyzed water IW may be included in the body part 1320. The electrode part 1340 may include at least one electrode.

The pipe part 1310 may include a heat dissipation part 1330. For example, the heat dissipation part 1330 may be a region which is disposed between the fluid WT and the electrolyzed water IW and in which heat is exchanged between the fluid WT and the electrolyzed water IW.

An inner space may be provided in the pipe part 1310, and the inner space of the pipe part 1310 may be determined by the heat dissipation part 1330.

The fluid WT may be disposed inside the pipe part 1310. The fluid WT may be disposed to be distinguished from the electrolyzed water IW disposed outside the pipe part 1310. That is, the fluid WT and the electrolyzed water IW may be disposed to be distinguished from each other by the heat dissipation part 1330, for example, the fluid WT may be disposed on an inner side of the heat dissipation part 1330, and an electrolyzed water IW may be disposed on an outer side of the heat dissipation part 1330.

The body part 1320 may include the electrode part 1340 having one or more electrodes.

At least one region of the electrode part 1340 may be disposed on an inner side of the body part 1320, for example, may be disposed on an outer side of the pipe part 1310.

In addition, the electrode part 1340 may be disposed to overlap the electrolyzed water IW to heat the electrolyzed water IW at an outer region of the heat dissipation part 1330.

In an embodiment, the electrode part 1340 may include a plurality of electrodes.

For example, the electrode part 1340 may be provided in a two-phase form, and may include a first electrode 1341 and a second electrode 1342.

Specifically, each of the first electrode 1341 and the second electrode 1342 may be disposed inside the body part 1320 so as to be in contact with the electrolyzed water IW.

The electrolyzed water IW may be heated by a current applied to the first electrode 1341 and the second electrode 1342 of the electrode part 1340. Heat generated by heating of the electrolyzed water IW is transferred to the fluid WT in the pipe part 1310, and the fluid WT may be heated.

In a specific embodiment, the body part 1320 may be formed in a shape in which a space is provided therein. For example, the body part 1320 may be formed in a columnar shape, and may be formed in the shape of a column having an elliptical cross-section.

Here, the first electrode 1341 and the second electrode 1342 may be respectively disposed on both sides with respect to the pipe part 1310. For example, the first electrode 1341 and the second electrode 1342 may be disposed in different directions with respect to the pipe part 1310, and in a specific embodiment, the first electrode 1341 and the second electrode 1342 may be disposed in opposite directions. Specifically, the first electrode 1341, the pipe part 1310, and the second electrode 1342 may be disposed along a long axis of the ellipse, and may be disposed to be spaced apart from each other. Accordingly, heat generated from the first electrode 1341 and the second electrode 1342 may be uniformly transferred to the entire region of the electrolyzed water IW rather than being transferred only to a local region of the electrolyzed water IW.

In addition, specific descriptions of the pipe part 1310, the body part 1320, the fluid WT, the electrolyzed water IW, the electrode part 1340, and the like will be omitted as the contents described in the above-described embodiments may be selectively applied or may be modified and applied as necessary.

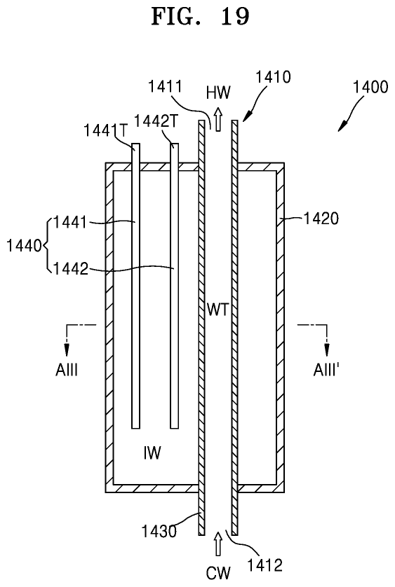

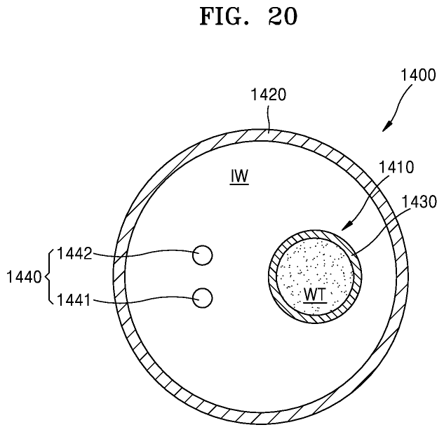

FIG. 19 is a view schematically illustrating a heating device according to another embodiment of the present disclosure, and FIG. 20 is a cross-sectional view taken along line AIII-AIII′ of FIG. 19.

Referring to FIGS. 19 and 20, a heating device 1400 according to the present embodiment may include a pipe part 1410 and a body part 1420.

A fluid WT may be disposed inside the pipe part 1410. The fluid WT may include various types, for example, a liquid or a gas.

The pipe part 1410 may be formed in the shape of a pipe including an outer wall and an inner wall and having a space therein in which the fluid WT may be disposed. For example, the pipe part 1410 may be formed in the shape of a pipe having a circular cross-section. In another example, the pipe part 1410 may be formed in the shape of a pipe having a polygonal cross-section. For example, the pipe part 1410 may be formed in the shape of a pipe having a rectangular cross-section. In another example, the pipe part 1410 may be formed in the shape of a pipe having a curved cross-section similar to an ellipse.

The body part 1420 may be a device disposed to surround at least one region of the pipe part 1410 and configured to heat the fluid WT disposed inside the pipe part 1410.

The body part 1420 may have various shapes, and for example, may be formed in the shape of a hollow box having a space provided therein.

In an optional embodiment, the body part 1420 may be formed in a columnar shape, for example, may be formed in the shape of a cylinder having a space provided therein. In another example, the body part 1420 may be formed in a prismatic columnar shape, for example, may be formed in the shape of a square column. In another example, the body part 1420 may be formed in the shape of a column including a curved surface whose bottom surface is similar to an ellipse.

The pipe part 1410 may be formed to be longer than the body part 1420.

In an embodiment, the pipe part 1410 may be disposed to cross the inside of the body part 1420. For example, the pipe part 1410 may be disposed to pass through the body part 1420. Accordingly, when the fluid WT is disposed inside the pipe part 1410, at least a portion of the fluid WT may be disposed inside the body part 1420.

In an optional embodiment, the pipe part 1410 may include an inlet 1412 via which the fluid WT flows in an inward direction of the body part 1420, and an outlet 1411 via which the fluid WT is discharged in an outward direction of the body part 1420. For example, the pipe part 1410 may include the inlet 1412 at one side and the outlet 1411 at another side, and may include a flow path, in which the fluid WT is disposed, between the inlet 1412 and the outlet 1411.

Accordingly, the fluid WT may flow into the pipe part 1410, and for example, the fluid WT may be introduced via the inlet 1412 of the pipe part 1410 and may be discharged to the outside via the outlet 1411 through the flow path.

Specifically, an unheated fluid CW before being heated may be introduced via the inlet 1412 of the pipe part 1410. For example, the unheated fluid CW may include room-temperature water or low-temperature water.

A heated fluid HW may be discharged via the outlet 1411 and, for example, a fluid WT including water having a temperature higher than that of the unheated fluid CW introduced via the inlet 1412 may be discharged.

In a specific example, the unheated fluid CW including room-temperature water, which is introduced via the inlet 1412, may be introduced into the pipe part 1410 and then heated through the body part 1420, and the heated fluid HW including heated water may be discharged to the outside of the pipe part 1410 via the outlet 1411.

Since the body part 1420 is disposed to surround at least a portion of the pipe part 1410, the fluid WT can be in contact with the body part 1420 over a large area while passing through the pipe part 1410 and thus can be efficiently heated.

The electrolyzed water IW may be disposed inside the body part 1420, and an electrode part 1440 for heating the electrolyzed water IW may be included in the body part 1420. The electrode part 1440 may include at least one electrode.

In an embodiment, the fluid WT and the electrolyzed water IW may be disposed to overlap each other, and for example, the electrolyzed water IW may be disposed to surround the side surface of the pipe part 1410. That is, since the electrolyzed water IW is disposed inside the body, and the fluid WT is disposed inside the pipe part 1410, the electrolyzed water IW and the fluid WT may be disposed to overlap each other.

The pipe part 1410 may include a heat dissipation part 1430. For example, the heat dissipation part 1430 may be a region which is disposed between the fluid WT and the electrolyzed water IW and in which heat is exchanged between the fluid WT and the electrolyzed water IW.

The heat dissipation part 1430 may be a device disposed to distinguish between the electrolyzed water IW and the fluid WT. For example, the heat dissipation part 1430 may be disposed between the electrolyzed water IW and the fluid WT, and specifically, may be formed to define an internal space of the pipe part 1410. In addition, the heat dissipation part 1430 may be formed to be spaced apart from the electrode part 1440.

For example, the heat dissipation part 1430 may have an elongated shape having a length in the same direction with a longitudinal direction of the pipe part 1410, and specifically, may form the flow path of the pipe part 1410. Thus, the heat dissipation part 1430 may be connected to at least one surface of the body part 1420, and in an optional embodiment, the heat dissipation part 1430 may be connected to an upper surface and a lower surface of the body part 1420. That is, the heat dissipation part 1430 may be disposed between the inlet 1412 and the outlet 1411 of the pipe part 1410.

The fluid WT may be disposed inside the pipe part 1410. The fluid WT may be disposed to be distinguished from the electrolyzed water IW disposed outside the pipe part 1410.

For example, the fluid WT may be disposed inside the heat dissipation part 1430 of the pipe part 1410, and the fluid WT and the electrolyzed water IW may be disposed to be distinguished from each other through the heat dissipation part 1430.

The body part 1420 may include the electrode part 1440 having one or more electrodes.

At least one region of the electrode part 1440 may be disposed on an inner side of the body part 1420, for example, may be disposed on an outer side of the pipe part 1410.

In addition, the electrode part 1440 may be disposed to overlap the electrolyzed water IW to heat the electrolyzed water IW at an outer region of the heat dissipation part 1430.

In addition, the electrode part 1440 may overlap the fluid WT, which is disposed inside the pipe part 1410, with respect to one direction.

In an embodiment, the electrode part 1440 may include a plurality of electrodes.

For example, the electrode part 1440 may be provided in a two-phase form, and may include a first electrode 1441 and a second electrode 1442.

Specifically, each of the first electrode 1441 and the second electrode 1442 may be disposed inside the body part 1420 so as to be in contact with the electrolyzed water IW. Although not shown in the drawing, current may be applied to the first electrode 1441 and the second electrode 1442 under control of an electrode control part (not shown), and a control part (not shown) may control the current applied to the electrode part 1440.

In a specific embodiment, the body part 1420 may be formed in a shape in which a space is provided therein. For example, the body part 1420 may be formed in a columnar shape, and may be formed in the shape of a column having a circular cross-section.

Here, the first electrode 1441 and the second electrode 1442 may be disposed on a side surface in the same direction with respect to the pipe part. For example, based on FIG. 20, the pipe part 1410 may be disposed to be biased in one direction away from the center of the body part 1420, and the first electrode 1441 and the second electrode 1442 may be disposed to be biased in the opposite direction of the pipe part 1410 from the center of the body part 1420. The first electrode 1441 and the second electrode 1442 are disposed in the opposite direction of the pipe part 1410, but are disposed to be spaced apart from each other, thereby preventing a problem such as an electrical short circuit.

Accordingly, heat may be more efficiently generated by the first electrode 1441 and the second electrode 1442, and the electrolyzed water IW may be rapidly heated by the first electrode 1441 and the second electrode 1442.

In an optional embodiment, the first electrode 1441 and the second electrode 1442 may include a first terminal 1441T and a second terminal 1442T, respectively, and a power source may be connected thereto respectively through the first terminal 1441T and the second terminal 1442T.

The electrolyzed water IW may be heated by the current applied to the first electrode 1441 and the second electrode 1442 of the electrode part 1440. Heat generated by heating of the electrolyzed water IW is transferred to the fluid WT in the pipe part 1410, and the fluid WT may be heated. That is, the body part 1420 may convert electrical energy into thermal energy to heat the electrolyzed water IW disposed inside the body part 1420, and the thermal energy transferred to the electrolyzed water IW may be transferred to the fluid WT in the pipe part 1410.

The first electrode 1441 and the second electrode 1442 may be disposed to be spaced apart from each other with an interval in an inner space of the body part 1420.

For example, the first electrode 1441 and the second electrode 1442 may be spaced apart from each other with an interval in an outer space of the heat dissipation part 1430 of the body part 1420, and may each have an elongated shape, specifically a linear shape.

One end portions of the first electrode 1441 and the second electrode 1442, which are formed by extending from the first electrode 1441 and the second electrode 1442, respectively, may be spaced apart from a region of the heat dissipation part 1430, specifically, a bottom surface of the body part 1420. In a specific example, each of the end portions, which are oriented in an opposite direction from the first terminal 1441T and the second terminal 1442T, may be formed to be spaced apart from the bottom surface of the body part 1420.

Accordingly, the risk of occurrence of electrical leakage or short circuits, which may occur due to the direct contact between the body part 1420 and the electrode part 1440, may be reduced, and a heating process for the electrolyzed water IW may be stably performed.

Further, a conductive part (not shown) connected to one regions of the first electrode 1441 and the second electrode 1442, for example, the first terminal 1441T and the second terminal 1442T, may be included so that current is applied to the first electrode 1441 and the second electrode 1442, and the conductive part (not shown) is a conductor in the form of a wire and may be connected to the electrode control part (not shown).

In addition, specific descriptions of the pipe part 1410, the body part 1420, the fluid WT, the electrolyzed water IW, the electrode part 1440, and the like will be omitted as the contents described in the above-described embodiments may be selectively applied or may be modified and applied as necessary.

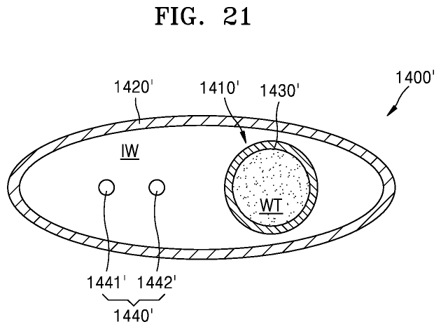

FIG. 21 is a view schematically illustrating a modified example (1400′) of FIG. 20.

Referring to FIG. 21, a heating device according to the present modified example (1400′) may include a pipe part 1410′ and a body part 1420′.

A fluid WT may be disposed inside the pipe part 1410′. The fluid WT may include various types, for example, a liquid or a gas.

The pipe part 1410′ may be formed in the shape of a pipe including an outer wall and an inner wall and having a space therein in which the fluid WT may be disposed. For example, the pipe part 1410′ may be formed in the shape of a pipe having a circular cross-section. In another example, the pipe part 1410′ may be formed in the shape of a pipe having a polygonal cross-section. For example, the pipe part 1410′ may be formed in the shape of a pipe having a rectangular cross-section. In another example, the pipe part 1410′ may be formed in the shape of a pipe having a curved cross-section similar to an ellipse.

The body part 1420′ may be a device disposed to surround at least one region of the pipe part 1410′ and configured to heat the fluid WT disposed inside the pipe part 1410′.

The electrolyzed water IW may be disposed inside the body part 1420′, and an electrode part 1440′ for heating the electrolyzed water IW may be included in the body part 1420′. The electrode part 1440′ may include at least one electrode.

The pipe part 1410′ may include a heat dissipation part 1430′. For example, the heat dissipation part 1430′ may be disposed between the body part 1420′ and the pipe part 1410′.

An inner space may be provided in the pipe part 1410′, and the inner space of the pipe part 1410′ may be determined by the heat dissipation part 1430′.

The fluid WT may be disposed inside the pipe part 1410′. The fluid WT may be disposed to be distinguished from the electrolyzed water IW disposed outside the pipe part 1410′. That is, the fluid WT and the electrolyzed water IW may be disposed to be distinguished from each other by the heat dissipation part 1430′, for example, the fluid WT may be disposed on an inner side of the heat dissipation part 1430′, and an electrolyzed water IW may be disposed on an outer side of the heat dissipation part 1430′.

The body part 1420′ may include the electrode part 1440′ having one or more electrodes.

At least one region of the electrode part 1440′ may be disposed on an inner side of the body part 1420′, for example, may be disposed on an outer side of the pipe part 1410′.

In addition, the electrode part 1440′ may be disposed to overlap the electrolyzed water IW to heat the electrolyzed water IW at an outer region of the heat dissipation part 1430′.

In an embodiment, the electrode part 1440′ may include a plurality of electrodes.

For example, the electrode part 1440′ may be provided in a two-phase form, and may include a first electrode 1441′ and a second electrode 1442′.

Specifically, each of the first electrode 1441′ and the second electrode 1442′ may be disposed inside the body part 1420′ so as to be in contact with the electrolyzed water IW.

The electrolyzed water IW may be heated by the current applied to the first electrode 1441′ and the second electrode 1442′ of the electrode part 1440′. Heat generated by heating of the electrolyzed water IW is transferred to the fluid WT in the pipe part 1410′, and the fluid WT may be heated.

In a specific embodiment, the body part 1420′ may be formed in a shape in which a space is provided therein. For example, the body part 1420′ may be formed in a columnar shape, and may be formed in the shape of a column having an elliptical cross-section.

Here, the first electrode 1441′ and the second electrode 1442′ may be disposed on a side surface in the same direction with respect to the pipe part. For example, based on FIG. 21, the pipe part 1410′ may be disposed to be biased in one direction away from the center of the body part 1420′, and the first electrode 1441′ and the second electrode 1442′ may be disposed to be biased in the opposite direction of the pipe part 1410′ from the center of the body part 1420′. The first electrode 1441′ and the second electrode 1442′ are disposed in the opposite direction of the pipe part 1410′, but are disposed to be spaced apart from each other, thereby preventing a problem such as an electrical short circuit.

Accordingly, heat may be more efficiently generated by the first electrode 1441′ and the second electrode 1442′, and the electrolyzed water IW disposed in a specific portion may be rapidly heated by the first electrode 1441′ and the second electrode 1442′. That is, different positions inside the body part 1420′ will generate heat unevenly, and the heating device 1400′ according to the present embodiment may be used when such heating characteristics are required.

In addition, specific descriptions of the pipe part 1410′, the body part 1420′, the fluid WT, the electrolyzed water IW, the electrode part 1440′, and the like will be omitted as the contents described in the above-described embodiments may be selectively applied or may be modified and applied as necessary.

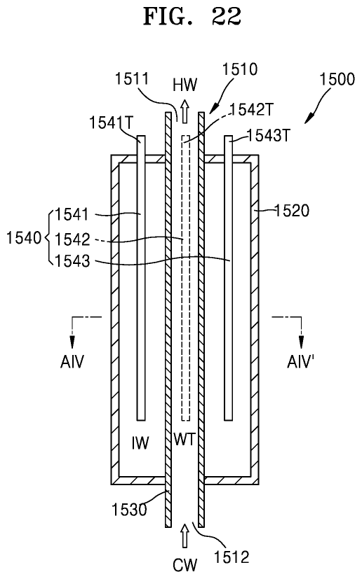

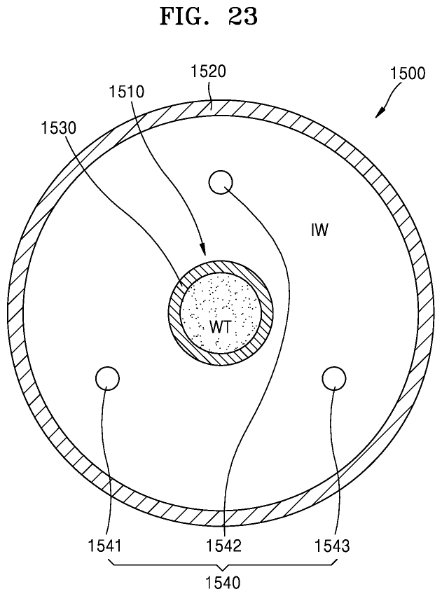

FIG. 22 is a view schematically illustrating a heating device 1500 according to another embodiment of the present disclosure, and FIG. 23 is a cross-sectional view taken along line AIV-AIV′ of FIG. 22.

Referring to FIGS. 22 and 23, the heating device 1500 according to the present embodiment may include a pipe part 1510 and a body part 1520.

A fluid WT may be disposed inside the pipe part 1510. The fluid WT may include various types, for example, a liquid or a gas.

The pipe part 1510 may be formed in the shape of a pipe including an outer wall and an inner wall and having a space therein in which the fluid WT may be disposed. For example, the pipe part 1510 may be formed in the shape of a pipe having a circular cross-section. In another example, the pipe part 1510 may be formed in the shape of a pipe having a polygonal cross-section. For example, the pipe part 1510 may be formed in the shape of a pipe having a rectangular cross-section. In another example, the pipe part 1510 may be formed in the shape of a pipe having a curved cross-section similar to an ellipse.

The body part 1520 may be a device disposed to surround at least one region of the pipe part 1510 and configured to heat the fluid WT disposed inside the pipe part 1510.

The body part 1520 may have various shapes, and for example, may be formed in the shape of a hollow box having a space provided therein.

In an optional embodiment, the body part 1520 may be formed in a columnar shape, for example, may be formed in the shape of a cylinder having a space provided therein. In another example, the body part 1520 may be formed in a prismatic columnar shape, for example, may be formed in the shape of a square column. In another example, the body part 1520 may be formed in the shape of a column including a curved surface whose bottom surface is similar to an ellipse.

The pipe part 1510 may be formed to be longer than the body part 1520.

In an embodiment, the pipe part 1510 may be disposed to cross the inside of the body part 1520. For example, the pipe part 1510 may be disposed to pass through the body part 1520. Accordingly, when the fluid WT is disposed inside the pipe part 1510, at least a portion of the fluid WT may be disposed inside the body part 1520.

In an optional embodiment, the pipe part 1510 may include an inlet 1512 via which the fluid WT flows in an inward direction of the body part 1520, and an outlet 1511 via which the fluid WT is discharged in an outward direction of the body part 1520. For example, the pipe part 1510 may include the inlet 1512 at one side and the outlet 1511 at another side, and may include a flow path, in which the fluid WT is disposed, between the inlet 1512 and the outlet 1511.

Accordingly, the fluid WT may flow into the pipe part 1510, and for example, the fluid WT may be introduced via the inlet 1512 of the pipe part 1510 and may be discharged to the outside via the outlet 1511 through the flow path.

Specifically, an unheated fluid CW before being heated may be introduced via the inlet 1512 of the pipe part 1510. For example, the unheated fluid CW may include room-temperature water or low-temperature water.

A heated fluid HW may be discharged via the outlet 1511 and, for example, a fluid WT including water having a temperature higher than that of the unheated fluid CW introduced via the inlet 1512 may be discharged.

In a specific example, the unheated fluid CW including room-temperature water, which is introduced via the inlet 1512, may be introduced into the pipe part 1510 and then heated through the body part 1520, and the heated fluid HW including heated water may be discharged to the outside of the pipe part 1510 via the outlet 1511.

Since the body part 1520 is disposed to surround at least a portion of the pipe part 1510, the fluid WT can be in contact with the body part 1520 over a large area while passing through the pipe part 1510 and thus can be efficiently heated.

The electrolyzed water IW may be disposed inside the body part 1520, and an electrode part 1540 for heating the electrolyzed water IW may be included in the body part 1520. The electrode part 1540 may include at least one electrode.

In an embodiment, the fluid WT and the electrolyzed water IW may be disposed to overlap each other, and for example, the electrolyzed water IW may be disposed to surround the side surface of the pipe part 1510. That is, since the electrolyzed water IW is disposed inside the body, and the fluid WT is disposed inside the pipe part 1510, the electrolyzed water IW and the fluid WT may be disposed to overlap each other.

The pipe part 1510 may include a heat dissipation part 1530. For example, the heat dissipation part 1530 may be a region which is disposed between the fluid WT and the electrolyzed water IW and in which heat is exchanged between the fluid WT and the electrolyzed water IW.

The heat dissipation part 1530 may be a device disposed to distinguish between the electrolyzed water IW and the fluid WT. For example, the heat dissipation part 1530 may be disposed between the electrolyzed water IW and the fluid WT, and specifically, may be formed to define an internal space of the pipe part 1510. In addition, the heat dissipation part 1530 may be formed to be spaced apart from the electrode part 1540.

For example, the heat dissipation part 1530 may have an elongated shape having a length in the same direction with a longitudinal direction of the pipe part 1510, and specifically, may form the flow path of the pipe part 1510. Thus, the heat dissipation part 1530 may be connected to at least one surface of the body part 1520, and in an optional embodiment, the heat dissipation part 1530 may be connected to an upper surface and a lower surface of the body part 1520. That is, the heat dissipation part 1530 may be disposed between the inlet 1512 and the outlet 1511 of the pipe part 1510.

The fluid WT may be disposed inside the pipe part 1510. The fluid WT may be disposed to be distinguished from the electrolyzed water IW disposed outside the pipe part 1510.

For example, the fluid WT may be disposed inside the heat dissipation part 1530 of the pipe part 1510, and the fluid WT and the electrolyzed water IW may be disposed to be distinguished from each other through the heat dissipation part 1530.

The body part 1520 may include the electrode part 1540 having one or more electrodes.

At least one region of the electrode part 1540 may be disposed on an inner side of the body part 1520, for example, may be disposed on an outer side of the pipe part 1510.

In addition, the electrode part 1540 may be disposed to overlap the electrolyzed water IW to heat the electrolyzed water IW at an outer region of the heat dissipation part 1530.

In addition, the electrode part 1540 may overlap the fluid WT, which is disposed inside the pipe part 1510, with respect to one direction.

In an embodiment, the electrode part 1540 may include a plurality of electrodes.

For example, the electrode part 1540 may be provided in a three-phase form, and may include a first electrode 1541, a second electrode 1542, and a third electrode 1543.

Specifically, each of the first electrode 1541, the second electrode 1542, and the third electrode 1543 may be disposed inside the body part 1520 so as to be in contact with the electrolyzed water IW. Although not shown in the drawing, current may be applied to the first electrode 1541, the second electrode 1542, and the third electrode 1543 under control of an electrode control part (not shown), and a control part (not shown) may control the current applied to the electrode part 1540. For example, each of the first electrode 1541, the second electrode 1542, and the third electrode 1543 may receive a balanced three-phase current having a phase difference of 120°, and may receive an unbalanced three-phase current as necessary.

In a specific embodiment, the body part 1520 may be formed in a shape in which a space is provided therein. For example, the body part 1520 may be formed in a columnar shape, and may be formed in the shape of a column having a circular cross-section.

Here, the first electrode 1541, the second electrode 1542, and the third electrode 1543 may be arranged to form a triangle based on the pipe part. For example, based on FIG. 23, the pipe part may be disposed at the center of the body part, and the first electrode 1541, the second electrode 1542, and the third electrode 1543 may be arranged to form a triangle surrounding the pipe part. In an optional embodiment, the triangle formed by connecting the first electrode 1541, the second electrode 1542, and the third electrode 1543 may be an equilateral triangle. The first electrode 1541, the second electrode 1542, and the third electrode 1543 may be disposed to be spaced apart from each other, thereby preventing a problem such as an electrical short circuit.

By including the first electrode 1541, the second electrode 1542, and the third electrode 1543 and receiving a three-phase current, the heating device according to the present embodiment can easily transform a voltage as necessary. In addition, safety can be improved by ensuring that power can be shut off rapidly and easily when an electrical accident occurs.

In an optional embodiment, the first electrode 1541, the second electrode 1542, and the third electrode 1543 may include a first terminal 1541T, a second terminal 1542T, and a third terminal 1543T, respectively, and a power source may be connected thereto respectively through the first terminal 1541T, the second terminal 1542T, and the third terminal 1543T.

The electrolyzed water IW may be heated by the current applied to the first electrode 1541, the second electrode 1542, and the third electrode 1543 of the electrode part 1540. Heat generated by heating of the electrolyzed water IW is transferred to the fluid WT in the pipe part 1510, and the fluid WT may be heated. That is, the body part 1520 may convert electrical energy into thermal energy to heat the electrolyzed water IW disposed inside the body part 1520, and the thermal energy transferred to the electrolyzed water IW may be transferred to the fluid WT in the pipe part 1510.

The first electrode 1541, the second electrode 1542, and the third electrode 1543 may be disposed to be spaced apart from each other with an interval in an inner space of the body part 1520.

For example, the first electrode 1541, the second electrode 1542, and the third electrode 1543 may be spaced apart from each other with an interval in an outer space of the heat dissipation part 1530 of the body part 1520, and may each have an elongated shape, specifically a linear shape.

One end portions of the first electrode 1541, the second electrode 1542, and the third electrode 1543, which are formed by extending from the first electrode 1541, the second electrode 1542, and the third electrode 1543, respectively, may be spaced apart from a region of the body part 1520, specifically, a bottom of the body part 1520. In a specific example, each of the end portions, which are oriented in an opposite direction from the first terminal 1541T, the second terminal 1542Tm and the third terminal 1543T, may be formed to be spaced apart from a bottom surface of the body part 1520.

Accordingly, the risk of occurrence of electrical leakage or short circuits, which may occur due to the direct contact between the body part 1520 and the electrode part 1540, may be reduced, and a heating process for the electrolyzed water IW may be stably performed.

In addition, a conductive part (not shown), which is connected to one regions of the first electrode 1541, the second electrode 1542, and the third electrode 1543, for example, the first terminal 1541T, the second terminal 1542T, and the third terminal 1543T so that a current is applied to the first electrode 1541, the second electrode 1542, and the third electrode 1543, may be included, and the conductive part (not shown) is a conductor in the form of a wire and may be connected to the electrode control part (not shown).

In addition, specific descriptions of the pipe part 1510, the body part 1520, the fluid WT, the electrolyzed water IW, the electrode part 1540, and the like will be omitted as the contents described in the above-described embodiments may be selectively applied or may be modified and applied as necessary.

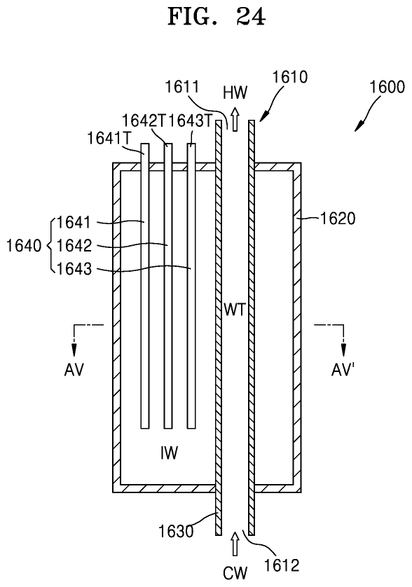

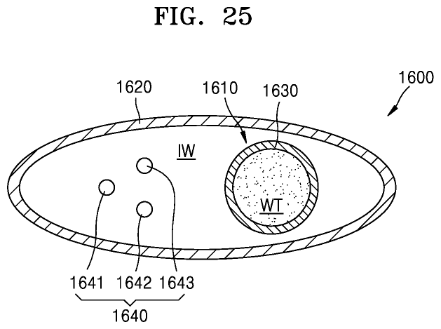

FIG. 24 is a view schematically illustrating a heating device 1600 according to another embodiment of the present disclosure, and FIG. 25 is a cross-sectional view taken along line AV-AV′ of FIG. 24.

Referring to FIGS. 24 and 25, the heating device 1600 according to the present embodiment may include a pipe part 1610 and a body part 1620.

A fluid WT may be disposed inside the pipe part 1610. The fluid WT may include various types, for example, a liquid or a gas.

The pipe part 1610 may be formed in the shape of a pipe including an outer wall and an inner wall and having a space therein in which the fluid WT may be disposed. For example, the pipe part 1610 may be formed in the shape of a pipe having a circular cross-section. In another example, the pipe part 1610 may be formed in the shape of a pipe having a polygonal cross-section. For example, the pipe part 1610 may be formed in the shape of a pipe having a rectangular cross-section. In another example, the pipe part 1610 may be formed in the shape of a pipe having a curved cross-section similar to an ellipse.

The body part 1620 may be a device disposed to surround at least one region of the pipe part 1610 and configured to heat the fluid WT disposed inside the pipe part 1610.

The body part 1620 may have various shapes, and for example, may be formed in the shape of a hollow box having a space provided therein.

In an optional embodiment, the body part 1620 may be formed in a columnar shape, for example, may be formed in the shape of a cylinder having a space provided therein. In another example, the body part 1620 may be formed in a prismatic columnar shape, for example, may be formed in the shape of a square column. In another example, the body part 1620 may be formed in the shape of a column including a curved surface whose bottom surface is similar to an ellipse.

The pipe part 1610 may be formed to be longer than the body part 1620.

In an embodiment, the pipe part 1610 may be disposed to cross the inside of the body part 1620. For example, the pipe part 1610 may be disposed to pass through the body part 1620.

Accordingly, when the fluid WT is disposed inside the pipe part 1610, at least a portion of the fluid WT may be disposed inside the body part 1620.

In an optional embodiment, the pipe part 1610 may include an inlet 1612 via which the fluid WT flows in an inward direction of the body part 1620, and an outlet 1611 via which the fluid WT is discharged in an outward direction of the body part 1620. For example, the pipe part 1610 may include the inlet 1612 at one side and the outlet 1611 at another side, and may include a flow path, in which the fluid WT is disposed, between the inlet 1612 and the outlet 1611.

Accordingly, the fluid WT may flow into the pipe part 1610, and for example, the fluid WT may be introduced via the inlet 1612 of the pipe part 1610 and may be discharged to the outside via the outlet 1611 through the flow path.

Specifically, an unheated fluid CW before being heated may be introduced via the inlet 1612 of the pipe part 1610. For example, the unheated fluid CW may include room-temperature water or low-temperature water.

A heated fluid HW may be discharged via the outlet 1611 and, for example, a fluid WT including water having a temperature higher than that of the unheated fluid CW introduced via the inlet 1612 may be discharged.

In a specific example, the unheated fluid CW including room-temperature water, which is introduced via the inlet 1612, may be introduced into the pipe part 1610 and then heated through the body part 1620, and the heated fluid HW including heated water may be discharged to the outside of the pipe part 1610 via the outlet 1611.

Since the body part 1620 is disposed to surround at least a portion of the pipe part 1610, the fluid WT can be in contact with the body part 1620 over a large area while passing through the pipe part 1610 and thus can be efficiently heated.

The electrolyzed water IW may be disposed inside the body part 1620, and an electrode part 1640 for heating the electrolyzed water IW may be included in the body part 1620. The electrode part 1640 may include at least one electrode.

In an embodiment, the fluid WT and the electrolyzed water IW may be disposed to overlap each other, and for example, the electrolyzed water IW may be disposed to surround the side surface of the pipe part 1610. That is, since the electrolyzed water IW is disposed inside the body, and the fluid WT is disposed inside the pipe part 1610, the electrolyzed water IW and the fluid WT may be disposed to overlap each other.

The pipe part 1610 may include a heat dissipation part 1630. For example, the heat dissipation part 1630 may be a region which is disposed between the fluid WT and the electrolyzed water IW and in which heat is exchanged between the fluid WT and the electrolyzed water IW.

The heat dissipation part 1630 may be a device disposed to distinguish between the electrolyzed water IW and the fluid WT. For example, the heat dissipation part 1630 may be disposed between the electrolyzed water IW and the fluid WT, and specifically, may be formed to define an internal space of the pipe part 1610. In addition, the heat dissipation part 1630 may be formed to be spaced apart from the electrode part 1640.

For example, the heat dissipation part 1630 may have an elongated shape having a length in the same direction with a longitudinal direction of the pipe part 1610, and specifically, may form the flow path of the pipe part 1610. Thus, the heat dissipation part 1630 may be connected to at least one surface of the body part 1620, and in an optional embodiment, the heat dissipation part 1630 may be connected to an upper surface and a lower surface of the body part 1620. That is, the heat dissipation part 1630 may be disposed between the inlet 1612 and the outlet 1611 of the pipe part 1610.

The fluid WT may be disposed inside the pipe part 1610. The fluid WT may be disposed to be distinguished from the electrolyzed water IW disposed outside the pipe part 1610.

For example, the fluid WT may be disposed inside the heat dissipation part 1630 of the pipe part 1610, and the fluid WT and the electrolyzed water IW may be disposed to be distinguished from each other through the heat dissipation part 1630.

The body part 1620 may include the electrode part 1640 having one or more electrodes.

At least one region of the electrode part 1640 may be disposed on an inner side of the body part 1620, for example, may be disposed on an outer side of the pipe part 1610.

In addition, the electrode part 1640 may be disposed to overlap the electrolyzed water IW to heat the electrolyzed water IW at an outer region of the heat dissipation part 1630.

In addition, the electrode part 1640 may overlap the fluid WT, which is disposed inside the pipe part 1610, with respect to one direction.

In an embodiment, the electrode part 1640 may include a plurality of electrodes.

For example, the electrode part 1640 may be provided in a three-phase form, and may include a first electrode 1641, a second electrode 1642, and a third electrode 1643.

Specifically, each of the first electrode 1641, the second electrode 1642, and the third electrode 1643 may be disposed inside the body part 1620 so as to be in contact with the electrolyzed water IW. Although not shown in the drawing, current may be applied to the first electrode 1641, the second electrode 1642, and the third electrode 1643 under control of an electrode control part (not shown), and a control part (not shown) may control the current applied to the electrode part 1640. For example, each of the first electrode 1641, the second electrode 1642, and the third electrode 1643 may receive a balanced three-phase current having a phase difference of 120°, and may receive an unbalanced three-phase current as necessary.

In a specific embodiment, the body part 1620 may be formed in a shape in which a space is provided therein. For example, the body part 1620 may be formed in a columnar shape, and may be formed in the shape of a column having an elliptical cross-section.

Here, the first electrode 1641, the second electrode 1642, and the third electrode 1643 may be disposed to form a triangle at a position spaced apart from the pipe part 1610. For example, based on FIG. 25, the pipe part 1610 may be disposed to be biased in one direction away from the center of the body part 1620, and the first electrode 1641, the second electrode 1642, and the third electrode 1643 may be disposed to form a triangle in the opposite direction of the pipe part 1610 from the center of the body part 1620. Specifically, the pipe part 1610 and the triangle formed by the first electrode 1641, the second electrode 1642, and the third electrode 1643 may be arranged in a longitudinal direction of a long axis of the ellipse formed by the body part 1620.

In an optional embodiment, the triangle formed by connecting the first electrode 1641, the second electrode 1642, and the third electrode 1643 may be an equilateral triangle. The first electrode 1641, the second electrode 1642, and the third electrode 1643 may be disposed to be spaced apart from each other, thereby preventing a problem such as an electrical short circuit.

By including the first electrode 1641, the second electrode 1642, and the third electrode 1643 and receiving a three-phase current, the heating device according to the present embodiment can easily transform a voltage as necessary. In addition, safety can be improved by ensuring that power can be shut off rapidly and easily when an electrical accident occurs.

In addition, in a position in which the first electrode 1641, the second electrode 1642, and the third electrode 1643 are disposed, heat can rapidly generated as compared to other positions, and thus, the electrolyzed water IW disposed in a specific position can be rapidly heated. That is, different positions inside the body part 1620 will generate heat unevenly, and the heating device 1600 according to the present embodiment may be used when such heating characteristics are required.

In an optional embodiment, the first electrode 1641, the second electrode 1642, and the third electrode 1643 may include a first terminal 1641T, a second terminal 1642T, and a third terminal 1643T, respectively, and a power source may be connected thereto respectively through the first terminal 1641T, the second terminal 1642T, and the third terminal 1643T.

The electrolyzed water IW may be heated by the current applied to the first electrode 1641, the second electrode 1642, and the third electrode 1643 of the electrode part 1640. Heat generated by heating of the electrolyzed water IW is transferred to the fluid WT in the pipe part 1610, and the fluid WT may be heated. That is, the body part 1620 may convert electrical energy into thermal energy to heat the electrolyzed water IW disposed inside the body part 1620, and the thermal energy transferred to the electrolyzed water IW may be transferred to the fluid WT in the pipe part 1610.

The first electrode 1641, the second electrode 1642, and the third electrode 1643 may be disposed to be spaced apart from each other with an interval in an inner space of the body part 1620.

For example, the first electrode 1641, the second electrode 1642, and the third electrode 1643 may be spaced apart from each other with an interval in an outer space of the heat dissipation part 1630 of the body part 1620, and may each have an elongated shape, specifically a linear shape.

One end portions of the first electrode 1641, the second electrode 1642, and the third electrode 1643, which are formed by extending from the first electrode 1641, the second electrode 1642, and the third electrode 1643, respectively, may be spaced apart from a region of the body part 1620, specifically, a bottom of the body part 1620. In a specific example, each of the end portions, which are oriented in an opposite direction from the first terminal 1641T, the second terminal 1642Tm and the third terminal 1643T, may be formed to be spaced apart from a bottom surface of the body part 1520.

Accordingly, the risk of occurrence of electrical leakage or short circuits, which may occur due to the direct contact between the body part 1620 and the electrode part 1640, may be reduced, and a heating process for the electrolyzed water IW may be stably performed.

In addition, a conductive part (not shown), which is connected to one regions of the first electrode 1641, the second electrode 1642, and the third electrode 1643, for example, the first terminal 1641T, the second terminal 1642T, and the third terminal 1643T so that a current is applied to the first electrode 1641, the second electrode 1642, and the third electrode 1643, may be included, and the conductive part (not shown) is a conductor in the form of a wire and may be connected to the electrode control part (not shown).

In addition, specific descriptions of the pipe part 1610, the body part 1620, the fluid WT, the electrolyzed water IW, the electrode part 1640, and the like will be omitted as the contents described in the above-described embodiments may be selectively applied or may be modified and applied as necessary.

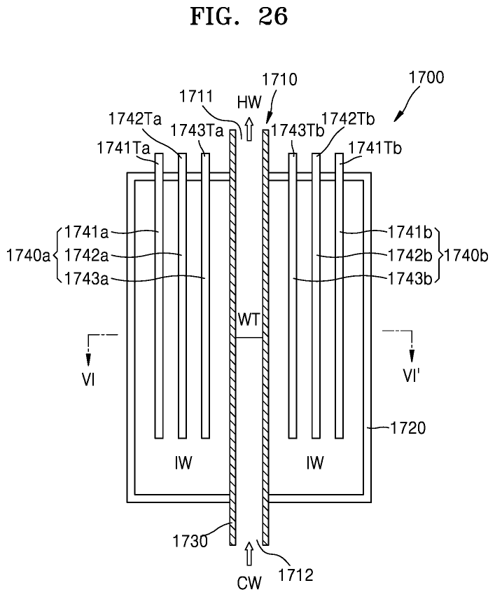

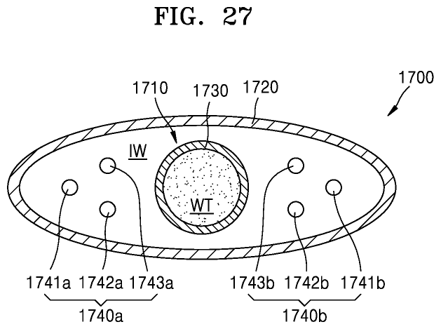

FIG. 26 is a view schematically illustrating a heating device 1700 according to another embodiment of the present disclosure, and FIG. 27 is a cross-sectional view taken along line AVI-AVI′ of FIG. 26.

A fluid WT may be disposed inside a pipe part 1710. The fluid WT may include various types, for example, a liquid or a gas.

The pipe part 1710 may be formed in the shape of a pipe including an outer wall and an inner wall and having a space therein in which the fluid WT may be disposed. For example, the pipe part 1710 may be formed in the shape of a pipe having a circular cross-section. In another example, the pipe part 1710 may be formed in the shape of a pipe having a polygonal cross-section. For example, the pipe part 1710 may be formed in the shape of a pipe having a rectangular cross-section. In another example, the pipe part 1710 may be formed in the shape of a pipe having a curved cross-section similar to an ellipse.

A body part 1720 may be a device disposed to surround at least one region of the pipe part 1710 and configured to heat the fluid WT disposed inside the pipe part 1710.

The body part 1720 may have various shapes, and for example, may be formed in the shape of a hollow box having a space provided therein.

In an optional embodiment, the body part 1720 may be formed in a columnar shape, for example, may be formed in the shape of a cylinder having a space provided therein. In another example, the body part 1720 may be formed in a prismatic columnar shape, for example, may be formed in the shape of a square column. In another example, the body part 1720 may be formed in the shape of a column including a curved surface whose bottom surface is similar to an ellipse.

The pipe part 1710 may be formed to be longer than the body part 1720.

In an embodiment, the pipe part 1710 may be disposed to cross the inside of the body part 1720. For example, the pipe part 1710 may be disposed to pass through the body part 1720. Accordingly, when the fluid WT is disposed inside the pipe part 1710, at least a portion of the fluid WT may be disposed inside the body part 1720.

In an optional embodiment, the pipe part 1710 may include an inlet 1712 via which the fluid WT flows in an inward direction of the body part 1720, and an outlet 1711 via which the fluid WT is discharged in an outward direction of the body part 1720. For example, the pipe part 1710 may include the inlet 1712 at one side and the outlet 1711 at another side, and may include a flow path, in which the fluid WT is disposed, between the inlet 1712 and the outlet 1711.

Accordingly, the fluid WT may flow into the pipe part 1710, and for example, the fluid WT may be introduced via the inlet 1712 of the pipe part 1710 and may be discharged to the outside via the outlet 1711 through the flow path.

Specifically, an unheated fluid CW before being heated may be introduced via the inlet 1712 of the pipe part 1710. For example, the unheated fluid CW may include room-temperature water or low-temperature water.

A heated fluid HW may be discharged via the outlet 1711 and, for example, a fluid WT including water having a temperature higher than that of the unheated fluid CW introduced via the inlet 1712 may be discharged.

In a specific example, the unheated fluid CW including room-temperature water, which is introduced via the inlet 1712, may be introduced into the pipe part 1710 and then heated through the body part 1720, and the heated fluid HW including heated water may be discharged to the outside of the pipe part 1710 via the outlet 1711.

Since the body part 1720 is disposed to surround at least a portion of the pipe part 1710, the fluid WT can be in contact with the body part 1720 over a large area while passing through the pipe part 1710 and thus can be efficiently heated.

The electrolyzed water IW may be disposed inside the body part 1720, and an electrode part 1740 for heating the electrolyzed water IW may be included in the body part 1720. The electrode part 1740 may include at least one electrode.

In an embodiment, the fluid WT and the electrolyzed water IW may be disposed to overlap each other, and for example, the electrolyzed water IW may be disposed to surround the side surface of the pipe part 1710. That is, since the electrolyzed water IW is disposed inside the body, and the fluid WT is disposed inside the pipe part 1710, the electrolyzed water IW and the fluid WT may be disposed to overlap each other.

The pipe part 1710 may include a heat dissipation part 1730. For example, the heat dissipation part 1730 may be a region which is disposed between the fluid WT and the electrolyzed water IW and in which heat is exchanged between the fluid WT and the electrolyzed water IW.

The heat dissipation part 1730 may be a device disposed to distinguish between the electrolyzed water IW and the fluid WT. For example, the heat dissipation part 1730 may be disposed between the electrolyzed water IW and the fluid WT, and specifically, may be formed to define an internal space of the pipe part 1710. In addition, the heat dissipation part 1730 may be formed to be spaced apart from the electrode part 1740.

For example, the heat dissipation part 1730 may have an elongated shape having a length in the same direction with a longitudinal direction of the pipe part 1710, and specifically, may form the flow path of the pipe part 1710. Thus, the heat dissipation part 1730 may be connected to at least one surface of the body part 1720, and in an optional embodiment, the heat dissipation part 1730 may be connected to an upper surface and a lower surface of the body part 1720. That is, the heat dissipation part 1730 may be disposed between the inlet 1712 and the outlet 1711 of the pipe part 1710.

The fluid WT may be disposed inside the pipe part 1710. The fluid WT may be disposed to be distinguished from the electrolyzed water IW disposed outside the pipe part 1710.

For example, the fluid WT may be disposed inside the heat dissipation part 1730 of the pipe part 1710, and the fluid WT and the electrolyzed water IW may be disposed to be distinguished from each other through the heat dissipation part 1730.

The body part 1720 may include the electrode part 1740 having one or more electrodes.

At least one region of the electrode part 1740 may be disposed on an inner side of the body part 1720, for example, may be disposed on an outer side of the pipe part 1710.

In addition, the electrode part 1740 may be disposed to overlap the electrolyzed water IW to heat the electrolyzed water IW at an outer region of the heat dissipation part 1730.

In addition, the electrode part 1740 may overlap the fluid WT, which is disposed inside the pipe part 1710, with respect to one direction.

In an embodiment, the electrode part 1740 may include a plurality of electrodes.

For example, the electrode part 1740 may include a plurality of three-phase electrode units in a three-phase form, and specifically, the electrode part 1740 may include a first electrode unit 1740a and a second electrode unit 1740b.

The first electrode unit 1740a may include a first-first electrode 1741a, a first-second electrode 1742a, and a first-third electrode 1743a. Although not shown in the drawing, current may be applied to the first-first electrode 1741a, the first-second electrode 1742a, and the first-third electrode 1743a under control of an electrode control part (not shown), and a control part (not shown) may control the current applied to the electrode part 1740. For example, each of the first-first electrode 1741a, the first-second electrode 1742a, and the first-third electrode 1743a may receive a balanced three-phase current having a phase difference of 120°, and may receive an unbalanced three-phase current as necessary.

The first-first electrode 1741a, the first-second electrode 1742a, and the first-third electrode 1743a may be disposed inside the body part so as to be in contact with the electrolyzed water IW, and may be disposed to form, for example, a triangle.

In an optional embodiment, the triangle formed by connecting the first-first electrode 1741a, the first-second electrode 1742a, and the first-third electrode 1743a may be an equilateral triangle. The first-first electrode 1741a, the first-second electrode 1742a, and the first-third electrode 1743a may be disposed to be spaced apart from each other, thereby preventing a problem such as an electrical short circuit.

The second electrode unit 1740b may include a second-first electrode, a second-second electrode, and a second-third electrode. Although not shown in the drawing, current may be applied to a second-first electrode 1741b, a second-second electrode 1742b, and a second-third electrode 1743b under control of an electrode control part (not shown), and a control part (not shown) may control the current applied to the electrode part 1740. For example, each of the second-first electrode 1741b, the second-second electrode 1742b, and the second-third electrode 1743b may receive a balanced three-phase current having a phase difference of 120°, and may receive an unbalanced three-phase current as necessary.

The second-first electrode 1741b, the second-second electrode 1742b, and the second-third electrode 1743b may be disposed inside the body part so as to be in contact with the electrolyzed water IW, and may be disposed to form, for example, a triangle.

In an optional embodiment, the triangle formed by connecting the second-first electrode 1741b, the second-second electrode 1742b, and the second-third electrode 1743b may be an equilateral triangle. The second-first electrode 1741b, the second-second electrode 1742b, and the second-third electrode 1743b may be disposed to be spaced apart from each other, thereby preventing a problem such as an electrical short circuit.

In a specific embodiment, the body part 1720 may be formed in a shape in which a space is provided therein. For example, the body part 1720 may be formed in a columnar shape, and may be formed in the shape of a column having an elliptical cross-section.

Here, the first electrode unit 1740a and the second electrode unit 1740b may be respectively disposed on both sides with respect to the pipe part 1710. For example, the first electrode unit 1740a and the second electrode unit 1740b may be disposed in different directions with respect to the pipe part 1710, and in a specific embodiment, the first electrode unit 1740a and the second electrode unit 1740b may be disposed in opposite directions. Specifically, the first electrode unit 1740a, the pipe part 1710, and the second electrode unit 1740b may be disposed along a long axis of the ellipse, and may be disposed to be spaced apart from each other. Accordingly, heat generated from the first electrode unit 1740a and second electrode unit 1740b may be uniformly transferred to the entire region of the electrolyzed water IW rather than being transferred only to a local region of the electrolyzed water IW.

Since the first electrode unit 1740a and the second electrode unit 1740b receive a three-phase current, the heating device 1700 according to the present embodiment can easily transform a voltage as necessary. In addition, safety can be improved by ensuring that power can be shut off rapidly and easily when an electrical accident occurs.

In an optional embodiment, the first-first electrode 1741a, the first-second electrode 1742a, and the first-third electrode 1743a may include a first-first terminal 1741Ta, a first-second terminal 1742Ta, and a first-third terminal 1743Ta, respectively, and a power source may be connected thereto respectively through the first-first terminal 1741Ta, the first-second terminal 1742Ta, and the first-third terminal 1743Ta. In addition, the second-first electrode 1741b, the second-second electrode 1742b, and the second-third electrode 1743b may include a second-first terminal 1741Tb, a second-second terminal 1742Tb, and a second-third terminal 1743Tb, respectively, and a power source may be connected thereto respectively through the second-first terminal 1741Tb, the second-second terminal 1742Tb, and the second-third terminal 1743Tb.

In addition, specific descriptions of the pipe part 1710, the body part 1720, the fluid WT, the electrolyzed water IW, the electrode part 1740, each terminal, and the like will be omitted as the contents described in the above-described embodiments may be selectively applied or may be modified and applied as necessary.

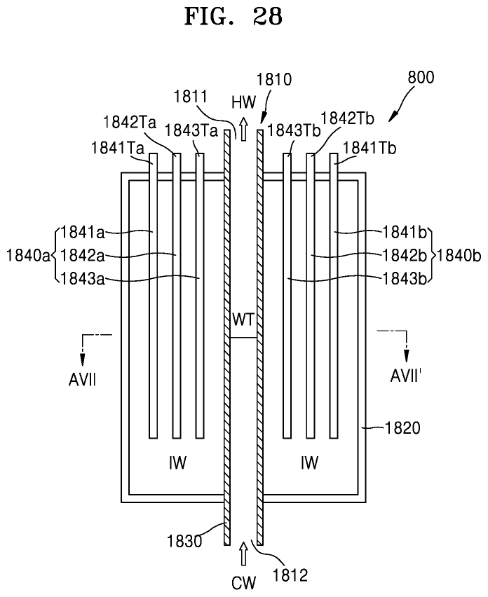

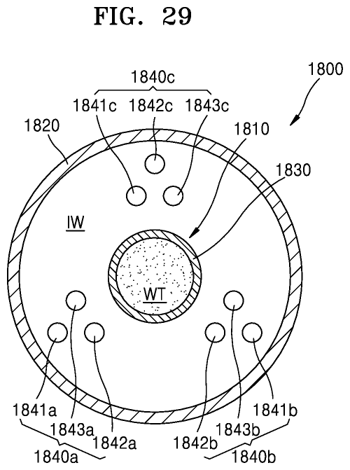

FIG. 28 is a view schematically illustrating a heating device according to another embodiment of the present disclosure, and FIG. 29 is a cross-sectional view taken along line AVII-AVII′ of FIG. 28.

A fluid WT may be disposed inside a pipe part 1810. The fluid WT may include various types, for example, a liquid or a gas.

The pipe part 1810 may be formed in the shape of a pipe including an outer wall and an inner wall and having a space therein in which the fluid WT may be disposed. For example, the pipe part 1810 may be formed in the shape of a pipe having a circular cross-section. In another example, the pipe part 1810 may be formed in the shape of a pipe having a polygonal cross-section. For example, the pipe part 1810 may be formed in the shape of a pipe having a rectangular cross-section. In another example, the pipe part 1810 may be formed in the shape of a pipe having a curved cross-section similar to an ellipse.

A body part 1820 may be a device disposed to surround at least one region of the pipe part 1810 and configured to heat the fluid WT disposed inside the pipe part 1810.

The body part 1820 may have various shapes, and for example, may be formed in the shape of a hollow box having a space provided therein.

In an optional embodiment, the body part 1820 may be formed in a columnar shape, for example, may be formed in the shape of a cylinder having a space provided therein. In another example, the body part 1820 may be formed in a prismatic columnar shape, for example, may be formed in the shape of a square column. In another example, the body part 1820 may be formed in the shape of a column including a curved surface whose bottom surface is similar to an ellipse.

The pipe part 1810 may be formed to be longer than the body part 1820.

In an embodiment, the pipe part 1810 may be disposed to cross the inside of the body part 1820. For example, the pipe part 1810 may be disposed to pass through the body part 1820. Accordingly, when the fluid WT is disposed inside the pipe part 1810, at least a portion of the fluid WT may be disposed inside the body part 1820.

In an optional embodiment, the pipe part 1810 may include an inlet 1812 via which the fluid WT flows in an inward direction of the body part 1820, and an outlet 1811 via which the fluid WT is discharged in an outward direction of the body part 1820. For example, the pipe part 1810 may include the inlet 1812 at one side and the outlet 1811 at another side, and may include a flow path, in which the fluid WT is disposed, between the inlet 1812 and the outlet 1811.

Accordingly, the fluid WT may flow into the pipe part 1810, and for example, the fluid WT may be introduced via the inlet 1812 of the pipe part 1810 and may be discharged to the outside via the outlet 1811 through the flow path.

Specifically, an unheated fluid CW before being heated may be introduced via the inlet 1812 of the pipe part 1810. For example, the unheated fluid CW may include room-temperature water or low-temperature water.

A heated fluid HW may be discharged via the outlet 1811 and, for example, a fluid WT including water having a temperature higher than that of the unheated fluid CW introduced via the inlet 1812 may be discharged.

In a specific example, the unheated fluid CW including room-temperature water, which is introduced via the inlet 1812, may be introduced into the pipe part 1810 and then heated through the body part 1820, and the heated fluid HW including heated water may be discharged to the outside of the pipe part 1810 via the outlet 1811.

Since the body part 1820 is disposed to surround at least a portion of the pipe part 1810, the fluid WT can be in contact with the body part 1820 over a large area while passing through the pipe part 1810 and thus can be efficiently heated.

The electrolyzed water IW may be disposed inside the body part 1820, and an electrode part 1840 for heating the electrolyzed water IW may be included in the body part 1820. The electrode part 1840 may include at least one electrode.

In an embodiment, the fluid WT and the electrolyzed water IW may be disposed to overlap each other, and for example, the electrolyzed water IW may be disposed to surround the side surface of the pipe part 1810. That is, since the electrolyzed water IW is disposed inside the body, and the fluid WT is disposed inside the pipe part 1810, the electrolyzed water IW and the fluid WT may be disposed to overlap each other.

The pipe part 1810 may include a heat dissipation part 1830. For example, the heat dissipation part 1830 may be a region which is disposed between the fluid WT and the electrolyzed water IW and in which heat is exchanged between the fluid WT and the electrolyzed water IW.

The heat dissipation part 1830 may be a device disposed to distinguish between the electrolyzed water IW and the fluid WT. For example, the heat dissipation part 1830 may be disposed between the electrolyzed water IW and the fluid WT, and specifically, may be formed to define an internal space of the pipe part 1810. In addition, the heat dissipation part 1830 may be formed to be spaced apart from the electrode part 1840.

For example, the heat dissipation part 1830 may have an elongated shape having a length in the same direction with a longitudinal direction of the pipe part 1810, and specifically, may form the flow path of the pipe part 1810. Thus, the heat dissipation part 1830 may be connected to at least one surface of the body part 1820, and in an optional embodiment, the heat dissipation part 1830 may be connected to an upper surface and a lower surface of the body part 1820. That is, the heat dissipation part 1830 may be disposed between the inlet 1812 and the outlet 1811 of the pipe part 1810.

The fluid WT may be disposed inside the pipe part 1810. The fluid WT may be disposed to be distinguished from the electrolyzed water IW disposed outside the pipe part 1810.

For example, the fluid WT may be disposed inside the heat dissipation part 1830 of the pipe part 1810, and the fluid WT and the electrolyzed water IW may be disposed to be distinguished from each other through the heat dissipation part 1830.

The body part 1820 may include the electrode part 1840 having one or more electrodes.

At least one region of the electrode part 1840 may be disposed on an inner side of the body part 1820, for example, may be disposed on an outer side of the pipe part 1810.

In addition, the electrode part 1840 may be disposed to overlap the electrolyzed water IW to heat the electrolyzed water IW at an outer region of the heat dissipation part 1830.

In addition, the electrode part 1840 may overlap the fluid WT, which is disposed inside the pipe part 1810, with respect to one direction.

In an embodiment, the electrode part 1840 may include a plurality of electrodes.

For example, the electrode part 1840 may include a plurality of three-phase electrode units in a three-phase form, and specifically, the electrode part 1840 may include a first electrode unit 1840a, a second electrode unit 1840b, and a third electrode unit 1840c.

The first electrode unit 1840a may include a first-first electrode 1841a, a first-second electrode 1842a, and a first-third electrode 1843a. Although not shown in the drawing, current may be applied to the first-first electrode 1841a, the first-second electrode 1842a, and the first-third electrode 1843a under control of an electrode control part (not shown), and a control part (not shown) may control the current applied to the electrode part 1840. For example, each of the first-first electrode 1841a, the first-second electrode 1842a, and the first-third electrode 1843a may receive a balanced three-phase current having a phase difference of 120°, and may receive an unbalanced three-phase current as necessary.

The first-first electrode 1841a, the first-second electrode 1842a, and the first-third electrode 1843a may be disposed inside the body part so as to be in contact with the electrolyzed water IW, and may be disposed to form, for example, a triangle.

In an optional embodiment, the triangle formed by connecting the first-first electrode 1841a, the first-second electrode 1842a, and the first-third electrode 1843a may be an equilateral triangle. The first-first electrode 1841a, the first-second electrode 1842a, and the first-third electrode 1843a may be disposed to be spaced apart from each other, thereby preventing a problem such as an electrical short circuit.

The second electrode unit 1840b may include a second-first electrode, a second-second electrode, and a second-third electrode. Although not shown in the drawing, current may be applied to a second-first electrode 1841b, a second-second electrode 1842b, and a second-third electrode 1843b under control of an electrode control part (not shown), and a control part (not shown) may control the current applied to the electrode part 1840. For example, each of the second-first electrode 1841b, the second-second electrode 1842b, and the second-third electrode 1843b may receive a balanced three-phase current having a phase difference of 120°, and may receive an unbalanced three-phase current as necessary.

The second-first electrode 1841b, the second-second electrode 1842b, and the second-third electrode 1843b may be disposed inside the body part so as to be in contact with the electrolyzed water IW, and may be disposed to form, for example, a triangle.

In an optional embodiment, the triangle formed by connecting the second-first electrode 1841b, the second-second electrode 1842b, and the second-third electrode 1843b may be an equilateral triangle. The second-first electrode 1841b, the second-second electrode 1842b, and the second-third electrode 1843b may be disposed to be spaced apart from each other, thereby preventing a problem such as an electrical short circuit.

The third electrode unit 1840c may include a third-first electrode 1841c, a third-second electrode 1842c, and a third-third electrode 1843c. Although not shown in the drawing, current may be applied to the third-first electrode 1841c, the third-second electrode 1842c, and the third-third electrode 1843c under control of an electrode control part (not shown), and a control part (not shown) may control the current applied to the electrode part 1840. For example, each of the third-first electrode 1841c, the third-second electrode 1842c, and the third-third electrode 1843c may receive a balanced three-phase current having a phase difference of 120°, and may receive an unbalanced three-phase current as necessary.

The third-first electrode 1841c, the third-second electrode 1842c, and the third-third electrode 1843c may be disposed inside the body part so as to be in contact with the electrolyzed water IW, and may be disposed to form, for example, a triangle.

In an optional embodiment, the triangle formed by connecting the third-first electrode 1841c, the third-second electrode 1842c, and the third-third electrode 1843c may be an equilateral triangle. The third-first electrode 1841c, the third-second electrode 1842c, and the third-third electrode 1843c may be disposed to be spaced apart from each other, thereby preventing a problem such as an electrical short circuit.

In a specific embodiment, the body part 1820 may be formed in a shape in which a space is provided therein. For example, the body part 1820 may be formed in a columnar shape, and may be formed in the shape of a column having a circular cross-section.

At this time, the first electrode unit 1840a, the second electrode unit 1840b, and the third electrode unit 1840c may be disposed to form a triangle based on the pipe part. For example, based on FIG. 29, the pipe part may be disposed at the center of the body part, and the first electrode unit 1840a, the second electrode unit 1840b, and the third electrode unit 1840c may be disposed to form a triangle surrounding the pipe part. In an optional embodiment, the triangle formed by connecting the first electrode unit 1840a, the second electrode unit 1840b, and the third electrode unit 1840c may be an equilateral triangle. The first electrode unit 1840a, the second electrode unit 1840b, and the third electrode unit 1840c may be disposed to be spaced apart from each other, thereby preventing a problem such as an electrical short circuit.

Thus, heat generated from the first electrode unit 1840a, the second electrode unit 1840b, and the third electrode unit 1840c may be uniformly transferred to the entire region of the electrolyzed water IW rather than being transferred only to a local region of the electrolyzed water IW.

Since the first electrode unit 1840a, the second electrode unit 1840b, and the third electrode unit 1840ct, a heating device 1800 according to the present embodiment can easily transform a voltage as necessary. In addition, safety can be improved by ensuring that power can be shut off rapidly and easily when an electrical accident occurs.

In an optional embodiment, the first-first electrode 1841a, the first-second electrode 1842a, and the first-third electrode 1843a may include a first-first terminal 1841Ta, a first-second terminal 1842Ta, and a first-third terminal 1843Ta, respectively, and a power source may be connected thereto respectively through the first-first terminal 1841Ta, the first-second terminal 1842Ta, and the first-third terminal 1843Ta. In addition, the second-first electrode 1841b, the second-second electrode 1842b, and the second-third electrode 1843b may include a second-first terminal 1841Tb, a second-second terminal 1842Tb, and a second-third terminal 1843Tb, respectively, and a power source may be connected thereto respectively through the second-first terminal 1841Tb, the second-second terminal 1842Tb, and the second-third terminal 1843Tb. In addition, the third-first electrode 1841c, the third-second electrode 1842c, and the third-third electrode 1843c may include a third-first terminal 1841Tc, a third-second terminal 1842Tc, and a third-third terminal 1843Tc, respectively, and a power source may be connected thereto respectively through the third-first terminal 1841Tc, the third-second terminal 1842Tc, and the third-third terminal 1843Tc.

In addition, specific descriptions of the pipe part 1810, the body part 1820, the fluid WT, the electrolyzed water IW, the electrode part 1840, each terminal, and the like will be omitted as the contents described in the above-described embodiments may be selectively applied or may be modified and applied as necessary.

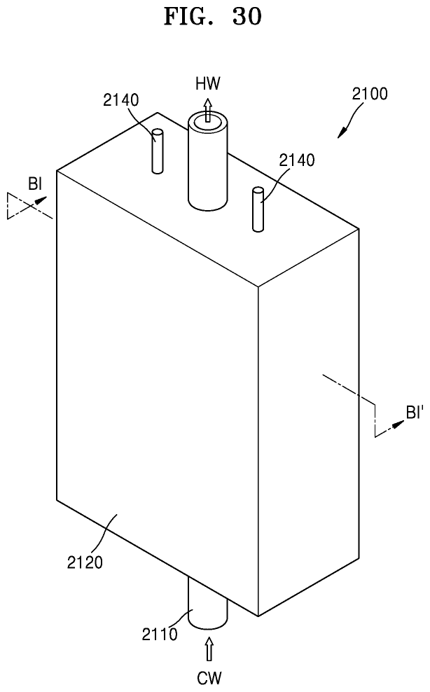

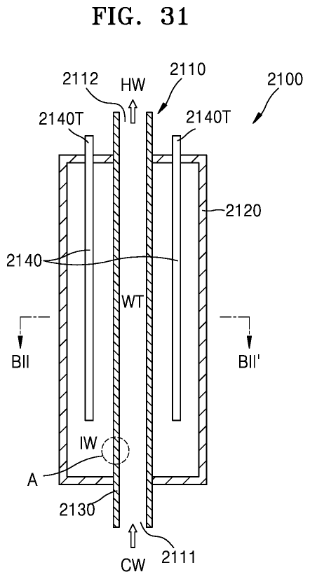

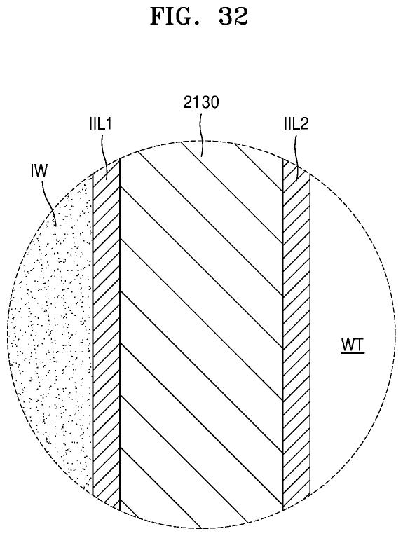

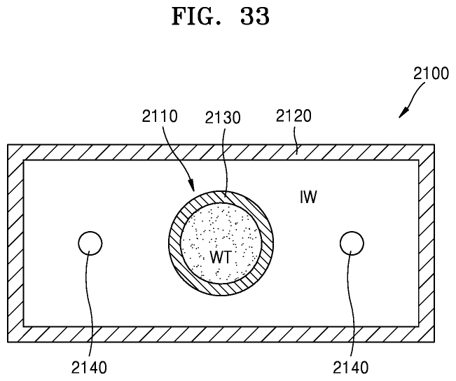

FIG. 30 is a view schematically illustrating a heating device 2100 according to another embodiment of the present disclosure, FIG. 31 is a cross-sectional view taken along line BI-BI′ of FIG. 30, FIG. 32 is an exemplary enlarged view of portion A of FIG. 31, and FIG. 33 is a cross-sectional view taken along line BII-BII′ of FIG. 31.

Referring to FIGS. 30 to 33, the heating device 2100 according to the present embodiment may include a pipe part 2110 and a body part 2120.

A fluid WT may be disposed inside the pipe part 2110. The fluid WT may include various types, for example, a liquid or a gas.

In an optional embodiment, the fluid WT may include water. For example, the heating device 2100 may be driven in a manner that uses hot water.

The pipe part 2110 may be formed in the shape of a pipe including an outer wall and an inner wall and having a space therein in which the fluid WT may be disposed. For example, the pipe part 2110 may be formed in the shape of a pipe having a circular cross-section. In another example, the pipe part 2110 may be formed in the shape of a pipe having a polygonal cross-section. For example, the pipe part 2110 may be formed in the shape of a pipe having a rectangular cross-section. In another example, the pipe part 2110 may be formed in the shape of a pipe having a curved cross-section similar to an ellipse.

The body part 2120 may be a device disposed to surround at least one region of the pipe part 2110 and configured to heat the fluid WT disposed inside the pipe part 2110.

The body part 2120 may have various shapes, and for example, may be formed in the shape of a hollow box having a space provided therein.

In an optional embodiment, the body part 2120 may be formed in a columnar shape, for example, may be formed in the shape of a square column. In another example, the body part 2120 may be formed in the shape of a cylinder. In another example, the body part 2120 may be formed in the shape of a column including a curved surface whose bottom surface is similar to an ellipse.

The body part 2120 may be formed of various materials. For example, the body part 2120 may be formed of a durable and lightweight insulating material. In an optional embodiment, the body part 2120 may be formed of a synthetic resin material including various types of resins. In another optional embodiment, the body part 2120 may also include an inorganic material such as ceramic.

In another optional embodiment, the body part 2120 may be formed of a metal material. In another example, the body part 2120 may also include a Teflon resin that is a fluorine resin.

In an optional embodiment, among surfaces of the body part 2120, an inner side surface adjacent to an electrolyzed water IW may include an insulating layer. For example, the inner side surface of the body part 2120 may include an inorganic layer, and may include an inorganic material including ceramic.

Further, as another example, an insulating layer including an organic material may be formed on the inner side surface adjacent to the electrolyzed water IW among the surfaces of the body part 2120.

The pipe part 2110 may be formed to be longer than the body part 2120.

In an embodiment, the at least one region of the pipe part 2110 may be disposed on an inner side of the body part 2120. Accordingly, when the fluid WT is disposed inside the pipe part 2110, at least a portion of the fluid WT may be disposed inside the body part 2120. In this case, a partial region of the pipe part 2110 may be exposed to the outside of the body part 2120, and specifically, both ends of the pipe part 2110 may be exposed to the outside of the body part 2120.

In an optional embodiment, the pipe part 2110 may include an inlet 2111 via which the fluid WT flows in an inward direction of the body part 2120, and an outlet 2112 via which the fluid WT is discharged in an outward direction of the body part 2120. For example, the pipe part 2110 may include the inlet 2111 at one side and the outlet 2112 at another side, and may include a flow path, in which the fluid WT is disposed, between the inlet 2111 and the outlet 2112. That is, one end of the pipe part 2110 exposed to the outside of the body part 2120 may be the inlet 2111, and another end of the pipe part 2110 exposed to the outside of the body part 2120 may be the outlet 2112.

Accordingly, the fluid WT may flow into the pipe part 2110, and for example, the fluid WT may be introduced via the inlet 2111 of the pipe part 2110 and may be discharged to the outside via the outlet 2112 through the flow path.

Specifically, an unheated fluid CW before being heated may be introduced via the inlet 2111 of the pipe part 2110. For example, the unheated fluid CW may include room-temperature water or low-temperature water.

A heated fluid HW may be discharged via the outlet 2112 and, for example, a fluid WT including water having a temperature higher than that of the unheated fluid CW introduced via the inlet 2111 may be discharged.

In a specific example, the unheated fluid CW including room-temperature water, which is introduced via the inlet 2111, may be introduced into the pipe part 2110 and then heated through the body part 2120, and the heated fluid HW including heated water may be discharged to the outside of the pipe part 2110 via the outlet 2112.

Since the body part 2120 is disposed to surround at least a portion of the pipe part 2110, the fluid WT can be in contact with the body part 2120 over a large area while passing through the pipe part 2110 and thus can be efficiently heated.

The electrolyzed water IW may be disposed inside the body part 2120, and an electrode part 2140 for heating the electrolyzed water IW may be included in the body part 2120. The electrode part 2140 may include at least one electrode.

In an embodiment, the fluid WT and the electrolyzed water IW may be disposed to overlap each other, and for example, the electrolyzed water IW may be disposed to surround the side surface of the pipe part 2110. Specifically, the electrolyzed water IW may be disposed to surround a side surface of the pipe part 2110 that is surrounded by the body part 2120. That is, since the electrolyzed water IW is disposed inside the body, and the fluid WT is disposed inside the pipe part 2110, the electrolyzed water IW and the fluid WT may be disposed to overlap each other.

The electrolyzed water IW may be of various types. For example, the electrolyzed water IW may include an electrolyte solution, specifically distilled water, filtered water, bottled water, tap water, or the like in which at least one of various types of electrolyte solutions is appropriately diluted.

As a material included in the electrolyzed water IW, there are various types including rust inhibitors or the like that contain edible soda, chlorite, silicate, an inorganic material of polyphosphate, amines, oxyacids, or the like as main components.

Thus, as will be described later, the electrolyzed water IW can be easily heated by the electrode part 2140, and the heated electrolyzed water IW can easily heat the fluid WT overlapping therewith.

The pipe part 2110 may include an inner surface in contact with the fluid WT and an outer surface in contact with the electrolyzed water IW. For example, the inner surface of the pipe part 2110 may define a space in which the fluid WT is disposed, and the outer surface of the pipe part 2110 may define an external shape of the pipe part 2110.

The pipe part 2110 may include a heat dissipation part 2130. For example, the heat dissipation part 2130 may be a region which is disposed between the fluid WT and the electrolyzed water IW and in which heat is exchanged between the fluid WT and the electrolyzed water WT.

As described above, an inner space may be provided in the pipe part 2110, and the inner space of the pipe part 2110 may be determined by the heat dissipation part 2130.

The fluid WT may be disposed inside the pipe part 2110. The fluid WT may be disposed to be distinguished from the electrolyzed water IW disposed outside the pipe part 2110.

For example, the fluid WT may be disposed inside the heat dissipation part 2130 of the pipe part 2110, and the fluid WT and the electrolyzed water IW may be disposed to be distinguished from each other through the heat dissipation part 2130. A detailed description of the heat dissipation part 2130 will be provided later.

The body part 2120 may be formed in such a shape that the entry and exit of the electrolyzed water IW are controlled, and may be formed in such a manner that the electrolyzed water IW does not unexpectedly leak to the outside after filling the inside of the body part 2120. In an embodiment, an inlet (not shown) and an outlet (not shown) for replenishing or discharging the electrolyzed water IW may be formed in the body part 2120.

The body part 2120 may include the electrode part 2140 having one or more electrodes.

At least one region of the electrode part 2140 may be disposed on an inner side of the body part 2120, for example, may be disposed on an outer side of the pipe part 2110.

In addition, the electrode part 2140 may be disposed to overlap the electrolyzed water IW to heat the electrolyzed water IW at an outer region of the heat dissipation part 2130.

In an embodiment, the electrode part 2140 may include a plurality of electrodes.

Each of the plurality of electrodes may be disposed inside the body part 2120 so as to be in contact with the electrolyzed water IW. Although not shown in the drawing, current may be applied to the plurality of electrodes under control of an electrode control part (not shown), and a control part (not shown) may control the current applied to the electrode part 2140.

In an optional embodiment, the electrode part 2140 may include a region embedded inside the body part 2120 and a terminal 2140T exposed to the outside of the body part 2120. Here, the region embedded inside the body part 2120 may be a portion from which heat is generated due to a current applied from the outside, and the terminal 2140T may be a portion connected to an external power source to receive the current.

The electrolyzed water IW may be heated due to the current applied to the electrode part 2140. Heat generated by heating of the electrolyzed water IW is transferred to the fluid WT in the pipe part 2110, and the fluid WT may be heated. That is, the body part 2120 may convert electrical energy into thermal energy to heat the electrolyzed water IW disposed inside the body part 2120, and the thermal energy transferred to the electrolyzed water IW may be transferred to the fluid WT in the pipe part 2110.

The plurality of electrodes may be disposed to be spaced apart from each other with an interval in an inner space of the body part 2120.

For example, the plurality of electrodes may be spaced apart from each other with an interval in an outer space of the heat dissipation part 2130 of the body part 2120, and may each have an elongated shape, specifically a linear shape. In addition, the electrode part 2140 may overlap the fluid WT, which is disposed inside the pipe part 2110, with respect to one direction.

In an embodiment, the electrode may be disposed in parallel to the at least one region of the pipe part 2110. For example, the electrode may be formed to extend in a linear shape to have a length, and a direction in which the electrode extends may be parallel to the at least one region of the pipe part 2110. Thus, heat generated from the electrode part 2140 can be transferred to a wide surface of the pipe part 2110, so that the heat can be efficiently transferred.

The region extending from the electrode part 2140 and embedded into the body part 2120 may be spaced apart from a region of the body part 2120, specifically, a bottom surface of the body part 2120. That is, each end portion of the electrode part 2140 facing an opposite direction from the terminal 2140T may be formed to be spaced apart from the bottom surface of the body part 2120.

Accordingly, the risk of occurrence of electrical leakage or short circuits, which may occur due to the direct contact between the body part 2120 and the electrode part 2540, may be reduced, and a heating process for the electrolyzed water IW may be stably performed.

In addition, the electrode part 2140 may include a conductive part (not shown) connected to the terminal 2140T to allow a current to be applied to the electrode part 2140, and the conductive part (not shown) is a conductor in the form of a wire and may be connected to the electrode control part (not shown).

In this case, the electrode part 2140 may be provided in a two-phase form and may include two electrodes.

In an optional embodiment, the two electrodes may be respectively disposed on both sides with respect to the pipe part 2110. For example, the two electrodes may be disposed in different directions with respect to the pipe part 2110, and in a specific embodiment, the two electrodes may be disposed in opposite directions. Accordingly, the electrolyzed water IW can be uniformly heated by the two electrodes.

The heat dissipation part 2130 may be a device disposed to distinguish between the electrolyzed water IW and the fluid WT. For example, the heat dissipation part 2130 may be disposed between the electrolyzed water IW and the fluid WT, and specifically, may be formed to define an internal space of the pipe part 2110. In addition, the heat dissipation part 2130 may be formed to be spaced apart from the electrode part 2140.

For example, the heat dissipation part 2130 may have an elongated shape having a length in the same direction with a longitudinal direction of the pipe part 2110, and specifically, may form the flow path of the pipe part 2110. Accordingly, the heat dissipation part 2130 may be connected to at least one surface of the body part 2120. That is, the heat dissipation part 2130 may be disposed to connect the inlet 2111 to the outlet 2112 between the inlet 2111 and the outlet 2112 of the pipe part 2110.

Accordingly, the unheated fluid CW introduced via the inlet 2111 may remain in contact with the heat dissipation part 2130 for a relatively long period of time while remaining inside the heat dissipation part 2130 or moving along the internal space. That is, the unheated fluid CW can receive heat from the heated electrolyzed water IW for a long period of time, thereby improving heating efficiency.

As described above, the heat dissipation part 2130 may be in contact with the electrolyzed water IW and the fluid WT, and for example, an outer surface of the heat dissipation part 2130 may be in contact with the electrolyzed water IW, and an inner surface of the heat dissipation part 2130 may be in contact with the fluid WT.

The heat dissipation part 2130 may be formed of a material having high thermal conductivity, and may be formed to include, for example, a metal material. Heat of the electrolyzed water IW may be easily transferred to the fluid WT through the heat dissipation part 2130.

The heat dissipation part 2130 may be formed to surround one region, in which the fluid WT is disposed, and thus surround an outer side of the region in which the fluid WT is disposed.

Further, the electrolyzed water IW may be disposed to surround the heat dissipation part 2130 on an outer side of the heat dissipation part 2130.

In an embodiment, the heat dissipation part 2130 may include an insulating layer.

Referring to FIG. 32, in an optional embodiment, the heat dissipation part 2130 may include a first insulating layer IIL1 on a side surface facing the electrolyzed water IW and a second insulating layer IIL2 on a side surface facing the fluid WT.

In addition, in another optional embodiment, the heat dissipation part 2130 may include only the first insulating layer ELI on the side surface facing the electrolyzed water IW, or may include only the second insulating layer 2IIL on the side surface facing the fluid WT.

In an embodiment, the first insulating layer IIL1 or the second insulating layer IIL2 may include an inorganic layer, such as a ceramic material or the like.

In another example, the first insulating layer ELI or the second insulating layer IIL2 may include an organic layer such as a resin layer, and may also include an insulating Teflon resin layer as a specific example.

The first insulating layer IIL1 may reduce the current flowing to the heat dissipation part 2130 through the electrolyzed water IW, and may reduce or prevent the flow of the leaked current from remaining in the pipe part 2110 or the fluid WT. Furthermore, when leakage current components remain in the heat dissipation part 2130, the first insulating layer IIL1 may reduce or prevent the leakage current components from flowing to the fluid WT, thereby reducing the occurrence of an electrical accident that may occur during the flow of the fluid WT.

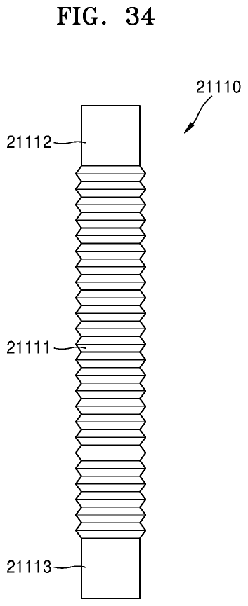

FIG. 34 schematically illustrates an embodiment (21110) of the pipe part of FIG. 30.

Referring to FIG. 34, a pipe part 21110 may include an inflow region 21113 on one side, a discharge region 21112 on another side, and a flow path region 21111 positioned between the inflow region 21113 and the discharge region 21112.

The inflow region 21113 may be a region via which the unheated fluid CW is introduced, and the discharge region 21112 may be a region via which the heated fluid HW is discharged. For example, the fluid WT may be introduced via the inflow region 21113, heated by the body part 2120 while passing through the flow path region 21111, and then discharged to the outside via the discharge region 21112.

In an embodiment, the body part 2120 may include two grooves through which the pipe part 21110 passes. For example, the inflow region 21113 of the pipe part 21110 may be inserted into one groove included in the body part 2120, and the discharge region 21112 of the pipe part 21110 may be inserted into the other groove.

In an optional embodiment, an outer circumferential surface of the flow path region 21111 may include a plurality of ridges and valleys. For example, the outer circumferential surface of the flow path region 21111 may be formed in a shape similar to an outer shape of a bellows. In another example, the outer circumferential surface of the flow path region 21111 may include a plurality of protrusions formed to protrude outward.

Thus, in a state in which the flow path region 21111 is disposed inside the body part 2120, an area in contact with the electrolyzed water IW may increase. Accordingly, the fluid WT passing through the flow path region 21111 can receive heat from the electrolyzed water IW more efficiently.

In an embodiment, an outer circumferential surface of the inflow region 21113 may be formed in the shape of a gently curved surface. For example, the outer circumferential surface of the inflow region 21113 may not include a protruding or recessed region. Thus, coupling characteristics when the inflow region 21113 is coupled to the groove included in the body part 2120 may be improved. For example, the inflow region 21113 may not include an empty gap caused by a portion of the inflow region 21113 protruding or recessing when coupled to the groove included in the body part 2120. Thus, the electrolyzed water IW disposed inside the body part 2120 may be prevented from leaking to the outside, or foreign substances or gas from the outside may be prevented from flowing into the body part 2120.

In an embodiment, an outer circumferential surface of the discharge region 21112 may be formed in the shape of a gently curved surface. For example, the outer circumferential surface of the discharge region 21112 may not include a protruding or recessed region. Thus, coupling characteristics when the discharge region 21112 is coupled to the groove included in the body part 2120 may be improved. For example, the discharge region 21112 may not include an empty gap caused by a portion of the discharge region 21112 protruding or recessing when coupled to the groove included in the body part 2120. Thus, the electrolyzed water IW disposed inside the body part 2120 may be prevented from leaking to the outside, or foreign substances or gas from the outside may be prevented from flowing into the body part 2120.

In an optional embodiment, although not shown in the drawings, a discharge outer region including a protruding or recessed region on an outer circumferential surface thereof may be further formed at one end of the discharge region 21112, for example, at an end portion of the discharge region 21112 opposite to the flow path region 21111. Thus, when the discharge outer region is connected to another device, an area in contact with the other device may increase, and thus heat exchange efficiency may be improved. For example, when connected to a separate heating device, heat can be efficiently transferred to the separate heating device.

In another optional embodiment, although not shown in the drawings, a discharge outer region including a protruding or recessed region on an outer circumferential surface thereof may be further formed at one end of the inflow region 21113, for example, at an end portion of the inflow region 21113 opposite to the flow path region 21111. Thus, when the inflow outer region is connected to another device, an area in contact with the other device may increase, and thus heat exchange efficiency may be improved. For example, when connected to a separate heating device, heat can be efficiently received from the separate heating device.

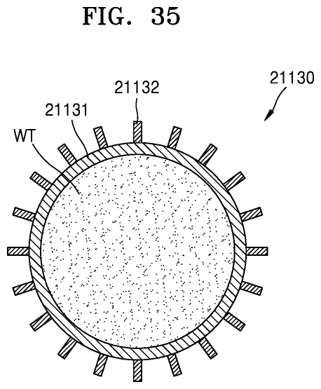

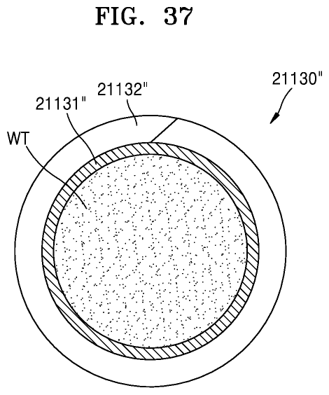

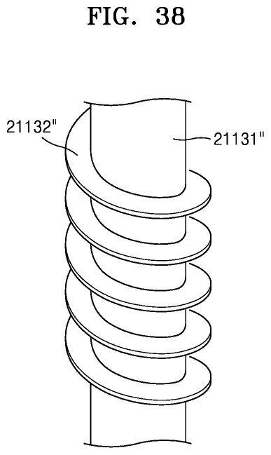

FIGS. 35 to 38 are views schematically illustrating various modified examples of the pipe part, and FIG. 38 is a view illustrating a portion of a perspective view of FIG. 37.

Specific descriptions of the body part, the fluid WT, the electrolyzed water IW, the electrode part, and the like will be omitted as the contents described in the above-described embodiments may be selectively applied or may be modified and applied as necessary.

Referring to FIG. 35, in a modified example, a heat dissipation part 21130 of a pipe part 21130 may include a base 21131 and a protrusion 21132.

The base 21131 may be a component that forms the entire outer shape of the heat dissipation part 21130.

The base 21131 may be formed in a shape surrounding the fluid WT, and may be formed in a shape similar to, for example, a cylinder.

A space may be provided on an inner side of the base 21131, and the electrode part 2140 may be disposed on an outer side of the base 21131.

The protrusion 21132 may be a component for easily transferring heat from the electrolyzed water IW to the heat dissipation part 21130. For example, the protrusion 21132 may be a component of increasing a contact area with the electrolyzed water IW to allow heat to be easily transferred from the electrolyzed water IW to the heat dissipation part 21130, thereby improving heat transfer efficiency.

The protrusion 21132 may be connected to the base 21131 and formed to protrude outward from the base 21131.

In an embodiment, a plurality of protrusions 21132 may be provided, for example, a plurality of protrusions 21132 may be provided along an outer circumference of the base 21131.

In an optional embodiment, each of the plurality of protrusions 21132 may have a shape extending in one direction, and for example, each of the protrusions 21132 may extend in a normal direction from an outer surface of the base 21131. In addition, the protrusions 21132 may be disposed to be spaced apart from each other, and accordingly, a spaced region may be formed between the protrusions 21132 and the electrolyzed water IW may be filled therein.

In an optional embodiment, each of the plurality of protrusions 21132 may have an elongated shape in a longitudinal direction of the heat dissipation part 21130, and may have a length in a direction parallel to the longitudinal direction of the heat dissipation part 21130, for example, to a longitudinal direction of the base 21131.

Further, in another example, each of the plurality of protrusions 21132 may have a length in a direction having an acute angle or an obtuse angle without being parallel to the longitudinal direction of the base 21131.

Further, in another example, each of the plurality of protrusions 21132 may be formed to be curved with respect to the longitudinal direction of the base 21131.

With such a configuration, a contact area between the protrusions 21132 and the electrolyzed water IW may be increased, and heat transfer efficiency may be improved.

The heat dissipation part 21130 may be formed of a material having high thermal conductivity, and may be formed to include, for example, a metal material. Heat of the electrolyzed water 1IT may be easily transferred to the fluid WT through the heat dissipation part 21130.

Further, in an optional embodiment, the heat dissipation part 21130 may include an insulating layer (not shown) on one side facing the fluid WT, and in another example, the heat dissipation part 21130 may include an insulating layer (not shown) on one side facing the electrolyzed water IW. This may reduce or prevent current from flowing through the heat dissipation part 21130 from the electrolyzed water WT.

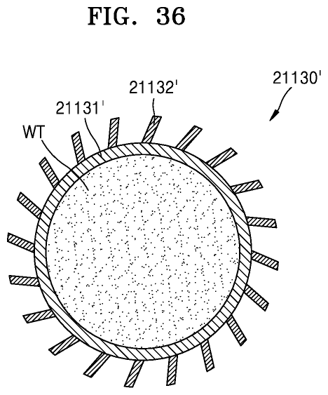

Referring to FIG. 36, in a modified example, a heat dissipation part 21130′ of a pipe part 21130′ may include a base 21131′ and a protrusion 21132′.

The base 21131′ may be a component that forms the entire outer shape of the heat dissipation part 21130′.

The base 21131′ may be formed in a shape surrounding the fluid WT, and may be formed in a shape similar to, for example, a cylinder.

A space may be provided on an inner side of the base 21131′, and the electrode part 2140 may be disposed on an outer side of the base 21131′.

The protrusion 21132′ may be a component for easily transferring heat from the electrolyzed water IW to the heat dissipation part 21130′. For example, the protrusion 21132′ may be a component of increasing a contact area with the electrolyzed water IW to allow heat to be easily transferred from the electrolyzed water IW to the heat dissipation part 21130′, thereby improving heat transfer efficiency.

The protrusion 21132′ may be connected to the base 21131′ and formed to protrude outward from the base 21131′.

In an embodiment, a plurality of protrusions 21132′ may be provided, for example, a plurality of protrusions 21132′ may be provided along an outer circumference of the base 21131′.

In an optional embodiment, each of the plurality of protrusions 21132′ may be formed to protrude in an inclined direction with respect to an outer circumferential surface of the base 21131′. For example, each of the plurality of protrusions 21132′ may be formed to protrude to have an acute angle or an obtuse angle with respect to the outer circumferential surface of the base 21131′.

In addition, in a specific embodiment, each of the plurality of protrusions 21132′ may have a shape inclined in the same direction when each of the plurality of protrusions 21132′ has the shape inclined with respect to the outer circumferential surface of the base 21131′ In an example, as shown in FIG. 36, each of the plurality of protrusions 21132′ may have a shape inclined in a clockwise direction with respect to the outer circumferential surface of the base 21131′.

Accordingly, the electrolyzed water IW can flow along an inclined direction of the protrusion 21132′, so that, in the inner space of the body part 2120, the electrolyzed water IW can be easily moved, thereby improving the uniformity of heating.

In an optional embodiment, each of the plurality of protrusions 21132′ may have an elongated shape in a longitudinal direction of the heat dissipation part 21130′, and may have a length in a direction parallel to the longitudinal direction of the heat dissipation part 21130′, for example, to a longitudinal direction of the base 21131′.

Further, in another example, each of the plurality of protrusions 21132′ may have a length in a direction having an acute angle or an obtuse angle without being parallel to the longitudinal direction of the base 21131′.

Further, in another example, each of the plurality of protrusions 21132′ may be formed to be curved with respect to the longitudinal direction of the base 21131′.

With such a configuration, a contact area between the protrusions 21132′ and the electrolyzed water IW may be increased, and heat transfer efficiency may be improved.

The heat dissipation part 21130′ may be formed of a material having high thermal conductivity, and may be formed to include, for example, a metal material. Heat of the fluid WT may be easily transferred to the electrolyzed water IW through the heat dissipation part 21130′.

Further, in an optional embodiment, the heat dissipation part 21130′ may include an insulating layer (not shown) on one side facing the fluid WT, and in another example, the heat dissipation part 21130′ may include an insulating layer (not shown) on one side facing the electrolyzed water IW. This may reduce or prevent current from flowing through the heat dissipation part 21130′ from the electrolyzed water IW.

Referring to FIGS. 37 and 38, in a modified example, a heat dissipation part 21130″ of a pipe part 21130″ may include a base 21131″ and a protrusion 11132″.

The base 21131″ may be a component that forms the entire outer shape of the heat dissipation part 21130″.

The base 21131″ may be formed in a shape surrounding the fluid WT, and may be formed in a shape similar to, for example, a cylinder.

A space may be provided on an inner side of the base 21131″, and the electrode part 2140 may be disposed on an outer side of the base 21131″.

The protrusion 21132″ may be a component for easily transferring heat from the electrolyzed water IW to the heat dissipation part 21130″. For example, the protrusion 21132″ may be a component of increasing a contact area with the electrolyzed water IW to allow heat to be easily transferred from the electrolyzed water IW to the heat dissipation part 21130″, thereby improving heat transfer efficiency.

The protrusion 11132″ may be formed to protrude outward along an outer surface of the base 21131″, and in a specific embodiment, the protrusion 11132″ may be formed in the shape of a screw thread. For example, the protrusion 11132″ may be formed to be inclined while forming a wing shape along an outer circumference of the base 21131″.

In an optional embodiment, the protrusion 11132″ may include at least one connected portion extending from an upper portion to a lower portion of an outer surface of the base 21131″. However, not all regions necessarily have to be connected, and at least one discontinuous portion may also be included.

Accordingly, the electrolyzed water IW can flow along the screw thread of the protrusion 11132″, so that, in the inner space of the body part 2120, the electrolyzed water IW can be easily moved, thereby improving the uniformity of heating. That is, at least a portion of the electrolyzed water IW can continuously come into contact with the heat dissipation part 21130″ while moving along the screw thread-shaped protrusion 11132″, thereby improving heating efficiency and improving the uniformity of heating.

Further, with such a configuration, a contact area between the protrusions 21132″ and the electrolyzed water IW may be increased, and heat transfer efficiency may be improved.

The heat dissipation part 21130″ may be formed of a material having high thermal conductivity, and may be formed to include, for example, a metal material. Heat of the fluid WT may be easily transferred to the electrolyzed water IW through the heat dissipation part 21130″.

Further, in an optional embodiment, the heat dissipation part 21130″ may include an insulating layer (not shown) on one side facing the fluid WT, and in another example, the heat dissipation part 21130″ may include an insulating layer (not shown) on one side facing the electrolyzed water IW. This may reduce or prevent current from flowing through the heat dissipation part 21130″ from the fluid WT.

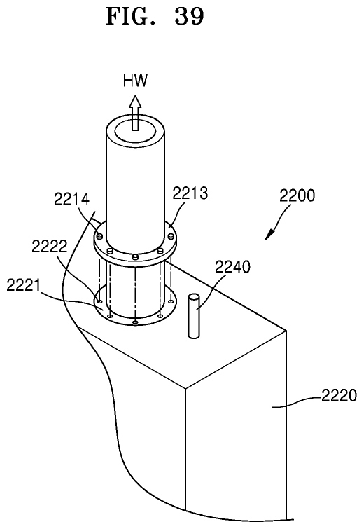

FIG. 39 is a view for describing an embodiment in which a pipe part 2210 and a body part 2220 are coupled to each other. In the drawing, it is illustrated that only an outlet 2212 of the pipe part 2210 is coupled to the body part 2220, but, it should be appreciated that the technical configuration of the present embodiment may also be used for an inlet 2211 of the pipe part 2210 to be coupled to the body part 2220.

Referring to FIG. 39, one side of the pipe part 2210 may be disposed to pass through the body part 2220, and the pipe part 2210 may be fixedly coupled to the body part 2220.

In an embodiment, the pipe part 2210 may include a coupling part 2213 for coupling to the body part 2220. The coupling part 2213 may be formed along an outer circumferential surface of the pipe part 2210. The coupling part 2213 is coupled to at least a portion of the body part 2220, and thus, the pipe part 2210 and the body part 2220 may eventually be firmly fixed to each other.

In an optional embodiment, the coupling part 2213 may include a coupling member 2214, and the body part 2220 may include a pipe coupling part 2221 for coupling to the coupling part 2213. In this case, the pipe coupling part 2221 may include a coupling hole 2222 to which the coupling member 2214 is coupled. That is, the coupling member 2214 may be a member for coupling a screw, a bolt, a nail, and the like, and the coupling hole 2222 may be a component for firmly coupling the pipe part 2210 to the body part 2220 by inserting the coupling member 2214 thereinto.

In another optional embodiment, the pipe part 2210 and the body part 2220 may be coupled to each other through welding, bonding, or the like without using a separate member for coupling.

In another optional embodiment, the pipe part 2210 and the body part 2220 may be coupled to each other through a separate member for coupling, and then further coupled to each other through means such as welding or bonding.

Accordingly, the pipe part 2210 may be easily and firmly coupled to the body part 2220. That is, it is possible to prevent the pipe part 2210 from being separated or decoupled from the body part 2220.

In addition, specific descriptions of the pipe part 2210, the body part 2220, an electrode part 2240, a fluid WT, an electrolyzed water IW, and the like will be omitted as the contents described in the above-described embodiments may be selectively applied or may be modified and applied as necessary.

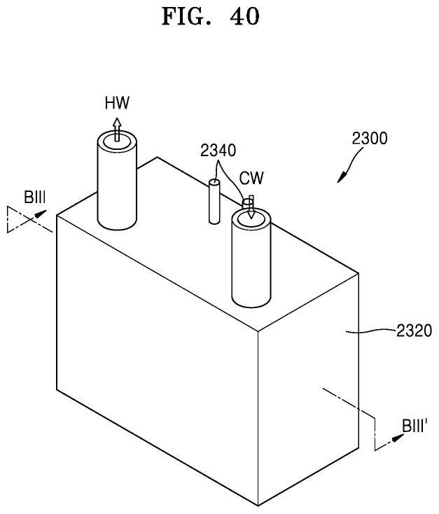

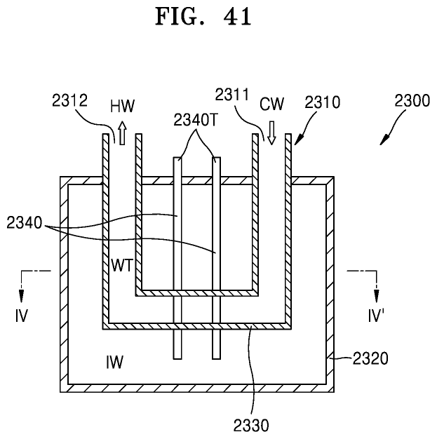

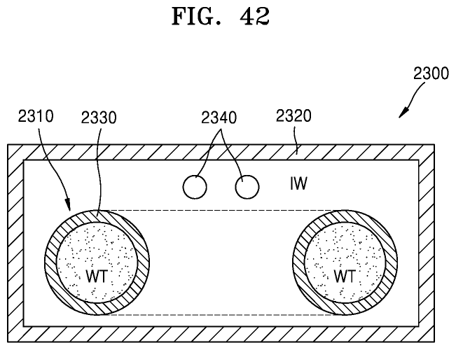

FIG. 40 is a view schematically illustrating a heating device according to another embodiment of the present disclosure, FIG. 41 is a cross-sectional view taken along line BIII-BIII′ of FIG. 40, and FIG. 42 is a cross-sectional view taken along line BIV-BIV′ of FIG. 41.

Referring to FIGS. 40 to 42, a heating device 2300 according to the present embodiment may include a pipe part 2310 and a body part 2320.

A fluid WT may be disposed inside the pipe part 2310. The fluid WT may include various types, for example, a liquid or a gas.

The pipe part 2310 may be formed in the shape of a pipe including an outer wall and an inner wall and having a space therein in which the fluid WT may be disposed. For example, the pipe part 2310 may be formed in the shape of a pipe having a circular cross-section. In another example, the pipe part 2310 may be formed in the shape of a pipe having a polygonal cross-section. For example, the pipe part 2310 may be formed in the shape of a pipe having a rectangular cross-section. In another example, the pipe part 2310 may be formed in the shape of a pipe having a curved cross-section similar to an ellipse.

The body part 2320 may be a device disposed to surround at least one region of the pipe part 2310 and configured to heat the fluid WT disposed inside the pipe part 2310.

The body part 2320 may have various shapes, and for example, may be formed in the shape of a hollow box having a space provided therein.

In an optional embodiment, the body part 2320 may be formed in a columnar shape, for example, may be formed in the shape of a square column. In another example, the body part 2320 may be formed in the shape of a cylinder. In another example, the body part 2320 may be formed in the shape of a column including a curved surface whose bottom surface is similar to an ellipse.

The pipe part 2310 may be formed to be longer than the body part 2320.

In an embodiment, the at least one region of the pipe part 2310 may be disposed on an inner side of the body part 2320. Accordingly, when the fluid WT is disposed inside the pipe part 2310, at least a portion of the fluid WT may be disposed inside the body part 2320. In this case, a partial region of the pipe part 2310 may be exposed to the outside of the body part 2320, and specifically, both ends of the pipe part 2310 may be exposed to the outside of the body part 2320.

In an optional embodiment, the pipe part 2310 may include an inlet 2311 via which the fluid WT flows in an inward direction of the body part 2320, and an outlet 2312 via which the fluid WT is discharged in an outward direction of the body part 2320. For example, the pipe part 2310 may include the inlet 2311 at one side and the outlet 2312 at another side, and may include a flow path, in which the fluid WT is disposed, between the inlet 2311 and the outlet 2312. That is, one end of the pipe part 2310 exposed to the outside of the body part 2320 may be the inlet 2311, and another end of the pipe part 2310 exposed to the outside of the body part 2320 may be the outlet 2312.

Accordingly, the fluid WT may flow into the pipe part 2310, and for example, the fluid WT may be introduced via the inlet 2311 of the pipe part 2310 and may be discharged to the outside via the outlet 2312 through the flow path.

Specifically, an unheated fluid CW before being heated may be introduced via the inlet 2311 of the pipe part 2310. For example, the unheated fluid CW may include room-temperature water or low-temperature water.

A heated fluid HW may be discharged via the outlet 2312 and, for example, a fluid WT including water having a temperature higher than that of the unheated fluid CW introduced via the inlet 2311 may be discharged.

In a specific example, the unheated fluid CW including room-temperature water, which is introduced via the inlet 2311, may be introduced into the pipe part 2310 and then heated through the body part 2320, and the heated fluid HW including heated water may be discharged to the outside of the pipe part 2310 via the outlet 2312.

Since the body part 2320 is disposed to surround at least a portion of the pipe part 2310, the fluid WT can be in contact with the body part 2320 over a large area while passing through the pipe part 2310 and thus can be efficiently heated.

The electrolyzed water IW may be disposed inside the body part 2320, and an electrode part 2340 for heating the electrolyzed water IW may be included in the body part 2320. The electrode part 2340 may include at least one electrode.

In an embodiment, the fluid WT and the electrolyzed water IW may be disposed to overlap each other, and for example, the electrolyzed water IW may be disposed to surround the side surface of the pipe part 2310. That is, since the electrolyzed water IW is disposed inside the body, and the fluid WT is disposed inside the pipe part 2310, the electrolyzed water IW and the fluid WT may be disposed to overlap each other.

The pipe part 2310 may include a heat dissipation part 2330. For example, the heat dissipation part 2330 may be a region which is disposed between the fluid WT and the electrolyzed water IW and in which heat is exchanged between the fluid WT and the electrolyzed water WT.

The heat dissipation part 2330 may be disposed to distinguish between the electrolyzed water IW and the fluid WT. For example, the heat dissipation part 2330 may be disposed between the electrolyzed water IW and the fluid WT, and specifically, may be formed to define an internal space of the pipe part 2310. In addition, the heat dissipation part 2330 may be formed to be spaced apart from the electrode part 2340.

For example, the heat dissipation part 2330 may have an elongated shape having a length in the same direction with a longitudinal direction of the pipe part 2310, and specifically, may form the flow path of the pipe part 2310. Accordingly, the heat dissipation part 2330 may be connected to at least one surface of the body part 2320. That is, the heat dissipation part 2330 may be disposed to connect the inlet 2311 to the outlet 2312 between the inlet 2311 and the outlet 2312 of the pipe part 2310.

The fluid WT may be disposed inside the pipe part 2310. The fluid WT may be disposed to be distinguished from the electrolyzed water IW disposed outside the pipe part 2310.

For example, the fluid WT may be disposed inside the heat dissipation part 2330 of the pipe part 2310, and the fluid WT and the electrolyzed water IW may be disposed to be distinguished from each other through the heat dissipation part 2330.

In an embodiment, at least one region of the pipe part 2310 may be formed to be curved inside the body part 2320.

When a specific embodiment is described with reference to FIGS. 41 and 42 again, the pipe part 2310 may include a curved region such that the pipe part 2310 is formed in an approximately “U” shape inside the body part 2320. Thus, the flow path through which the fluid WT flows inside the body part 2320 is also curved.

For example, based on FIG. 41, the fluid WT may flow in a downward direction after being introduced via the inlet 2311, flow in a lateral direction at a curved region, and then flow in an upward direction toward the outlet 2312. Accordingly, the time for the fluid WT to remain inside the pipe part 2310 increases, and thus the time for the fluid WT to receive heat from the body part 2320 increases, allowing the fluid WT to be heated more efficiently.

Meanwhile, the pipe part 2310 is illustrated as being bent vertically, but the present disclosure is not limited thereto, and it should be appreciated that the pipe part 2310 may be bent in a curved shape.

The body part 2320 may include the electrode part 2340 having one or more electrodes.

At least one region of the electrode part 2340 may be disposed on an inner side of the body part 2320, for example, may be disposed on an outer side of the pipe part 2310.

In addition, the electrode part 2340 may be disposed to overlap the electrolyzed water IW to heat the electrolyzed water IW at an outer region of the heat dissipation part 2330.

In an embodiment, the electrode part 2340 may include a plurality of electrodes.

Each of the plurality of electrodes may be disposed inside the body part 2320 so as to be in contact with the electrolyzed water IW.

In an optional embodiment, the electrode part 2340 may include a region embedded inside the body part 2320 and a terminal 2340T exposed to the outside of the body part 2320. Here, the region embedded inside the body part 2320 may be a portion from which heat is generated due to a current applied from the outside, and a terminal 2340T may be a portion connected to an external power source to receive the current.

The electrolyzed water IW may be heated due to the current applied to the electrode part 2340. Heat generated by heating of the electrolyzed water IW is transferred to the fluid WT in the pipe part 2310, and the fluid WT may be heated.

The plurality of electrodes may be disposed to be spaced apart from each other with an interval in an inner space of the body part 2320.

For example, the plurality of electrodes may be spaced apart from each other with an interval in an outer space of the heat dissipation part 2330 of the body part 2320, and may each have an elongated shape, specifically a linear shape. In addition, the electrode part 2340 may overlap the fluid WT, which is disposed inside the pipe part 2310, with respect to one direction. In addition, the electrode part 2340 may be disposed not to be in direct contact with the pipe part 2310 or not to pass through the pipe part 2310.

For example, based on FIG. 42, the pipe part 2310 may be disposed on a lower side, and the electrode part 2340 may be disposed above the pipe part 2310 such that the electrode part 2340 is not in direct contact with the pipe part 2310 or does not pass through the pipe part 2310.

In an embodiment, the electrode may be disposed in parallel to the at least one region of the pipe part 2310. For example, the electrode may be formed to extend in a linear shape to have a length, and a direction in which the electrode extends may be parallel to the at least one region of the pipe part 2310. That is, based on FIG. 41, the electrode may be formed to be parallel to a longitudinal direction of the pipe part 2310. Thus, heat generated from the electrode part 2340 can be rapidly transferred to a wide surface of the pipe part 2310, so that the heat can be efficiently transferred.

The region extending from the electrode part 2340 and embedded into the body part 2320 may be spaced apart from a region of the body part 2320, specifically, a bottom surface of the body part 2320. That is, each end portion of the electrode part 2340 facing an opposite direction from the terminal 2340T may be formed to be spaced apart from the bottom surface of the body part 2320.

Accordingly, the risk of occurrence of electrical leakage or short circuits, which may occur due to the direct contact between the body part 2320 and the electrode part 2340, may be reduced, and a heating process for the electrolyzed water IW may be stably performed.

In addition, the electrode part 2340 may include a conductive part (not shown) connected to the terminal 2340T to allow a current to be applied to the electrode part 2340, and the conductive part (not shown) is a conductor in the form of a wire and may be connected to the electrode control part (not shown).

In an optional embodiment, the electrode part 2340 may be provided in a two-phase form, and may include two electrodes, but the present disclosure is not limited thereto.

In addition, specific descriptions of the pipe part 2310, the body part 2320, the fluid WT, the electrolyzed water IW, the electrode part 2340, and the like will be omitted as the contents described in the above-described embodiments may be selectively applied or may be modified and applied as necessary.

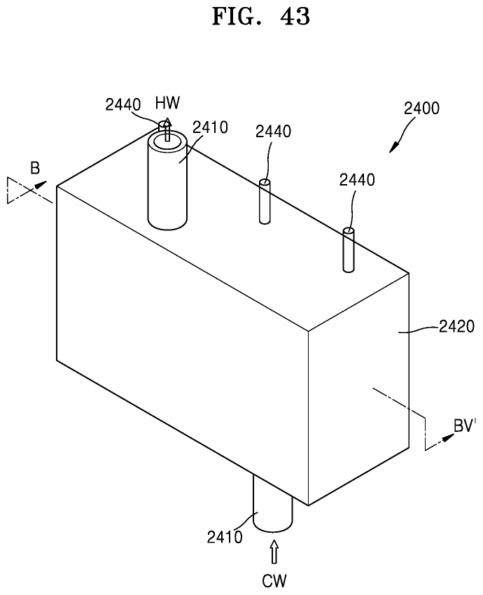

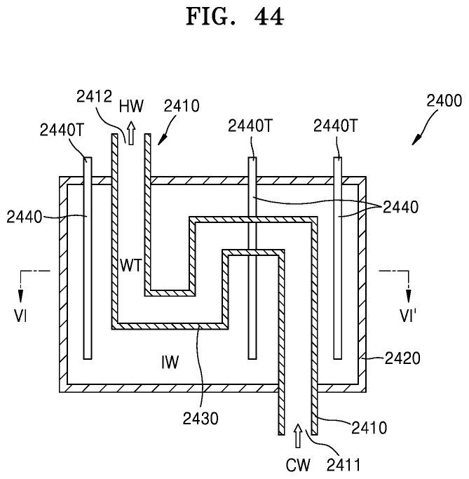

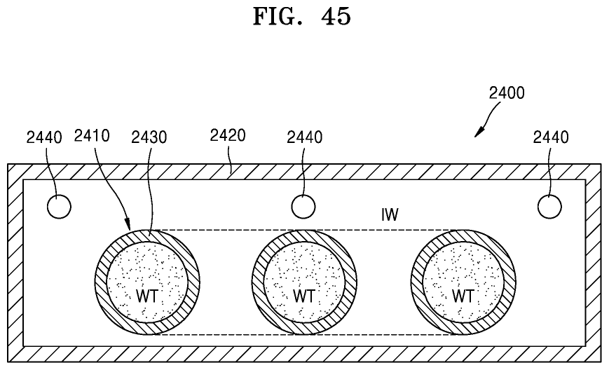

FIG. 43 is a view schematically illustrating a heating device according to another embodiment of the present disclosure, FIG. 44 is a cross-sectional view taken along line BV-BV′ of FIG. 43, and FIG. 45 is a cross-sectional view taken along line BVI-BVI′ of FIG. 44.

Referring to FIGS. 43 to 45, a heating device 2400 according to the present embodiment may include a pipe part 2410 and a body part 2420.

A fluid WT may be disposed inside the pipe part 2410. The fluid WT may include various types, for example, a liquid or a gas.

The pipe part 2410 may be formed in the shape of a pipe including an outer wall and an inner wall and having a space therein in which the fluid WT may be disposed. For example, the pipe part 2410 may be formed in the shape of a pipe having a circular cross-section. In another example, the pipe part 2410 may be formed in the shape of a pipe having a polygonal cross-section. For example, the pipe part 2410 may be formed in the shape of a pipe having a rectangular cross-section. In another example, the pipe part 2410 may be formed in the shape of a pipe having a curved cross-section similar to an ellipse.

The body part 2420 may be a device disposed to surround at least one region of the pipe part 2410 and configured to heat the fluid WT disposed inside the pipe part 2410.

The body part 2420 may have various shapes, and for example, may be formed in the shape of a hollow box having a space provided therein.

In an optional embodiment, the body part 2420 may be formed in a columnar shape, for example, may be formed in the shape of a square column. In another example, the body part 2420 may be formed in the shape of a cylinder. In another example, the body part 2420 may be formed in the shape of a column including a curved surface whose bottom surface is similar to an ellipse.

The pipe part 2410 may be formed to be longer than the body part 2420.

In an embodiment, the at least one region of the pipe part 2410 may be disposed on an inner side of the body part 2420. Accordingly, when the fluid WT is disposed inside the pipe part 2410, at least a portion of the fluid WT may be disposed inside the body part 2420. In this case, a partial region of the pipe part 2410 may be exposed to the outside of the body part 2420, and specifically, both ends of the pipe part 2410 may be exposed to the outside of the body part 2420.

In an optional embodiment, the pipe part 2410 may include an inlet 2411 via which the fluid WT flows in an inward direction of the body part 2420, and an outlet 2412 via which the fluid WT is discharged in an outward direction of the body part 2420. For example, the pipe part 2410 may include the inlet 2411 at one side and the outlet 2412 at another side, and may include a flow path, in which the fluid WT is disposed, between the inlet 2411 and the outlet 2412. That is, one end of the pipe part 2410 exposed to the outside of the body part 2420 may be the inlet 2411, and another end of the pipe part 2410 exposed to the outside of the body part 2420 may be the outlet 2412.

Accordingly, the fluid WT may flow into the pipe part 2410, and for example, the fluid WT may be introduced via the inlet 2411 of the pipe part 2410 and may be discharged to the outside via the outlet 2412 through the flow path.

Specifically, an unheated fluid CW before being heated may be introduced via the inlet 2411 of the pipe part 2410. For example, the unheated fluid CW may include room-temperature water or low-temperature water.

A heated fluid HW may be discharged via the outlet 2412 and, for example, a fluid WT including water having a temperature higher than that of the unheated fluid CW introduced via the inlet 2411 may be discharged.

In a specific example, the unheated fluid CW including room-temperature water, which is introduced via the inlet 2411, may be introduced into the pipe part 2410 and then heated through the body part 2420, and the heated fluid HW including heated water may be discharged to the outside of the pipe part 2410 via the outlet 2412.

Since the body part 2420 is disposed to surround at least a portion of the pipe part 2410, the fluid WT can be in contact with the body part 2420 over a large area while passing through the pipe part 2410 and thus can be efficiently heated.

The electrolyzed water IW may be disposed inside the body part 2420, and an electrode part 2440 for heating the electrolyzed water IW may be included in the body part 2420. The electrode part 2440 may include at least one electrode.

In an embodiment, the fluid WT and the electrolyzed water IW may be disposed to overlap each other, and for example, the electrolyzed water IW may be disposed to surround the side surface of the pipe part 2410. That is, since the electrolyzed water IW is disposed inside the body, and the fluid WT is disposed inside the pipe part 2410, the electrolyzed water IW and the fluid WT may be disposed to overlap each other.

The pipe part 2410 may include a heat dissipation part 2430. For example, the heat dissipation part 2430 may be a region which is disposed between the fluid WT and the electrolyzed water IW and in which heat is exchanged between the fluid WT and the electrolyzed water WT.

The heat dissipation part 2430 may be disposed to distinguish between the electrolyzed water IW and the fluid WT. For example, the heat dissipation part 2430 may be disposed between the electrolyzed water IW and the fluid WT, and specifically, may be formed to define an internal space of the pipe part 2410. In addition, the heat dissipation part 2430 may be formed to be spaced apart from the electrode part 2440.

For example, the heat dissipation part 2430 may have an elongated shape having a length in the same direction with a longitudinal direction of the pipe part 2410, and specifically, may form the flow path of the pipe part 2410. Accordingly, the heat dissipation part 2430 may be connected to at least one surface of the body part 2420. That is, the heat dissipation part 2430 may be disposed to connect the inlet 2411 to the outlet 2412 between the inlet 2411 and the outlet 2412 of the pipe part 2410.

The fluid WT may be disposed inside the pipe part 2410. The fluid WT may be disposed to be distinguished from the electrolyzed water IW disposed outside the pipe part 2410.

For example, the fluid WT may be disposed inside the heat dissipation part 2430 of the pipe part 2410, and the fluid WT and the electrolyzed water IW may be disposed to be distinguished from each other through the heat dissipation part 2430.

In an embodiment, at least one region of the pipe part 2410 may be formed to be curved inside the body part 2420, for example, two regions thereof may be formed to be curved.

When a specific embodiment is described with reference to FIGS. 44 and 45 again, the pipe part 2410 may include a curved region such that the pipe part 2410 is formed in an approximately lying “S” shape inside the body part 2420. Thus, the flow path through which the fluid WT flows inside the body part 2420 is also curved.

For example, based on FIG. 44, the fluid WT may flow in an upward direction after being introduced via the inlet 2411, flow in a lateral direction at a curved region, flow in a downward direction at a curved region, flow in the lateral direction again at a curved region, and then, flow in the upward direction again at a curved region toward the outlet 2412. Accordingly, the time for the fluid WT to remain inside the pipe part 2410 relatively further increases, and thus the time for the fluid WT to receive heat from the body part 2420 increases, allowing the fluid WT to be heated more efficiently.

Meanwhile, the pipe part 2410 is illustrated as being bent vertically, but the present disclosure is not limited thereto, and it should be appreciated that the pipe part 2410 may be bent in a curved shape.

The body part 2420 may include the electrode part 2440 having one or more electrodes.

At least one region of the electrode part 2440 may be disposed on an inner side of the body part 2420, for example, may be disposed on an outer side of the pipe part 2410.

In addition, the electrode part 2440 may be disposed to overlap the electrolyzed water IW to heat the electrolyzed water IW at an outer region of the heat dissipation part 2430.

In an embodiment, the electrode part 2440 may include a plurality of electrodes.

Each of the plurality of electrodes may be disposed inside the body part 2420 so as to be in contact with the electrolyzed water IW.

In an optional embodiment, the electrode part 2440 may include a region embedded inside the body part 2420 and a terminal 2440T exposed to the outside of the body part 2420. Here, the region embedded inside the body part 2420 may be a portion from which heat is generated due to a current applied from the outside, and a terminal 2440T may be a portion connected to an external power source to receive the current.

The electrolyzed water IW may be heated due to the current applied to the electrode part 2440. Heat generated by heating of the electrolyzed water IW is transferred to the fluid WT in the pipe part 2410, and the fluid WT may be heated.

The plurality of electrodes may be disposed to be spaced apart from each other with an interval in an inner space of the body part 2420.

For example, the plurality of electrodes may be spaced apart from each other with an interval in an outer space of the heat dissipation part 2430 of the body part 2420, and may each have an elongated shape, specifically a linear shape. In addition, the electrode part 2440 may overlap the fluid WT, which is disposed inside the pipe part 2410, with respect to one direction. In addition, the electrode part 2440 may be disposed not to be in direct contact with the pipe part 2410 or not to pass through the pipe part 2410.

For example, based on FIG. 45, the pipe part 2410 may be disposed on a lower side, and the electrode part 2440 may be disposed above the pipe part 2410 such that the electrode part 2440 is not in direct contact with the pipe part 2410 or does not pass through the pipe part 2410.

In an embodiment, the electrode may be disposed in parallel to the at least one region of the pipe part 2410. For example, the electrode may be formed to extend in a linear shape to have a length, and a direction in which the electrode extends may be parallel to the at least one region of the pipe part 2410. That is, based on FIG. 44, the electrode may be formed to be parallel to a longitudinal direction of the pipe part 2410. Thus, heat generated from the electrode part 2440 can be rapidly transferred to a wide surface of the pipe part 2410, so that the heat can be efficiently transferred.

The region extending from the electrode part 2440 and embedded into the body part 2420 may be spaced apart from a region of the body part 2420, specifically, a bottom surface of the body part 2420. That is, each end portion of the electrode part 2440 facing an opposite direction from the terminal 2440T may be formed to be spaced apart from the bottom surface of the body part 2420.

Accordingly, the risk of occurrence of electrical leakage or short circuits, which may occur due to the direct contact between the body part 2420 and the electrode part 2440, may be reduced, and a heating process for the electrolyzed water IW may be stably performed.

In addition, the electrode part 2440 may include a conductive part (not shown) connected to the terminal 2440T to allow a current to be applied to the electrode part 2440, and the conductive part (not shown) is a conductor in the form of a wire and may be connected to the electrode control part (not shown).

In an optional embodiment, the electrode part 2440 may be provided in a three-phase form, and may include three electrodes, but the present disclosure is not limited thereto.

In addition, specific descriptions of the pipe part 2410, the body part 2420, the fluid WT, the electrolyzed water IW, the electrode part 2440, and the like will be omitted as the contents described in the above-described embodiments may be selectively applied or may be modified and applied as necessary.

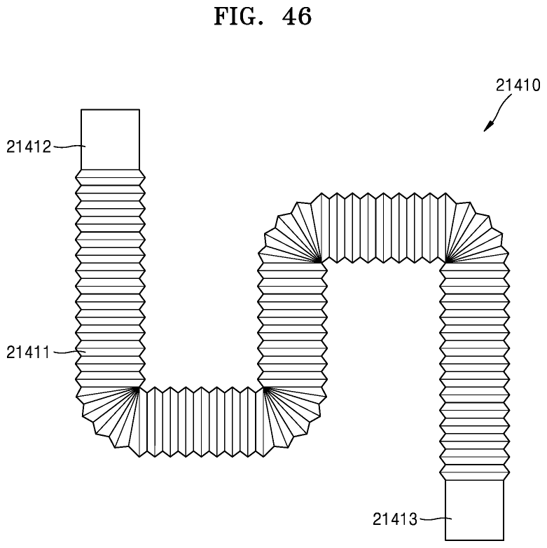

FIG. 46 is a view schematically illustrating an embodiment (21410) of the pipe part of FIG. 44.

Referring to FIG. 46, as in the pipe part 21110 described with reference to FIG. 34, a pipe part 24410 according to the present embodiment may include an inflow region 21413 at one side thereof and a discharge region 21412 at another side thereof, and may include a flow path region 21411 positioned between the inflow region 21413 and the discharge region 21412.

The inflow region 21413 may be a region via which the unheated fluid CW is introduced, and the discharge region 21412 may be a region via which the heated fluid HW is discharged. For example, the fluid WT may be introduced via the inflow region 21413, heated by the body part 2420 while passing through the flow path region 21411, and then discharged to the outside via the discharge region 21412.

An outer circumferential surface of the flow path region 21411 may include a plurality of ridges and valleys. For example, the outer circumferential surface of the flow path region 21411 may be formed in a shape similar to an outer shape of a bellows. In another example, the outer circumferential surface of the flow path region 21411 may include a plurality of protrusions formed to protrude outward.

In an optional embodiment, at least one region of the flow path region 21411 may be formed to be curved. For example, at least one region of the flow path region 21411 may be formed to be curved inside the body part 2420. Thus, since the fluid WT flows along the curved flow path region 21411, the time for the fluid WT to remain inside the body part 2420 increases. In addition, according thereto, in a state in which the flow path region 21411 is disposed inside the body part 2420, an area in contact with the electrolyzed water IW may increase. Accordingly, the fluid WT passing through the flow path region 21411 can receive heat from the electrolyzed water IW more efficiently.

In an embodiment, an outer circumferential surface of the inflow region 21413 may be formed in the shape of a gently curved surface. For example, the outer circumferential surface of the inflow region 21413 may not include a protruding or recessed region. Thus, coupling characteristics when the inflow region 21413 is coupled to the groove included in the body part 2420 may be improved. For example, the inflow region 21413 may not include an empty gap caused by a portion of the inflow region 21413 protruding or recessing when coupled to the groove included in the body part 2420. Thus, the electrolyzed water IW disposed inside the body part 2420 may be prevented from leaking to the outside, or foreign substances or gas from the outside may be prevented from flowing into the body part 2420.

In an embodiment, an outer circumferential surface of the discharge region 21412 may be formed in the shape of a gently curved surface. For example, the outer circumferential surface of the discharge region 21412 may not include a protruding or recessed region. Thus, coupling characteristics when the discharge region 21412 is coupled to the groove included in the body part 2420 may be improved. For example, the discharge region 21412 may not include an empty gap caused by a portion of the discharge region 21412 protruding or recessing when coupled to the groove included in the body part 2420. Thus, the electrolyzed water IW disposed inside the body part 2420 may be prevented from leaking to the outside, or foreign substances or gas from the outside may be prevented from flowing into the body part 2420.

In an optional embodiment, although not shown in the drawings, a discharge outer region including a protruding or recessed region on an outer circumferential surface thereof may be further formed at one end of the discharge region 21412, for example, at an end portion of the discharge region 21412 opposite to the flow path region 21411. Thus, when the discharge outer region is connected to another device, an area in contact with the other device may increase, and thus heat exchange efficiency may be improved. For example, when connected to a separate heating device, heat can be efficiently transferred to the separate heating device.

In another optional embodiment, although not shown in the drawings, a discharge outer region including a protruding or recessed region on an outer circumferential surface thereof may be further formed at one end of the inflow region 21413, for example, at an end portion of the inflow region 21413 opposite to the flow path region 21411. Thus, when the inflow outer region is connected to another device, an area in contact with the other device may increase, and thus heat exchange efficiency may be improved. For example, when connected to a separate heating device, heat can be efficiently received from the separate heating device.

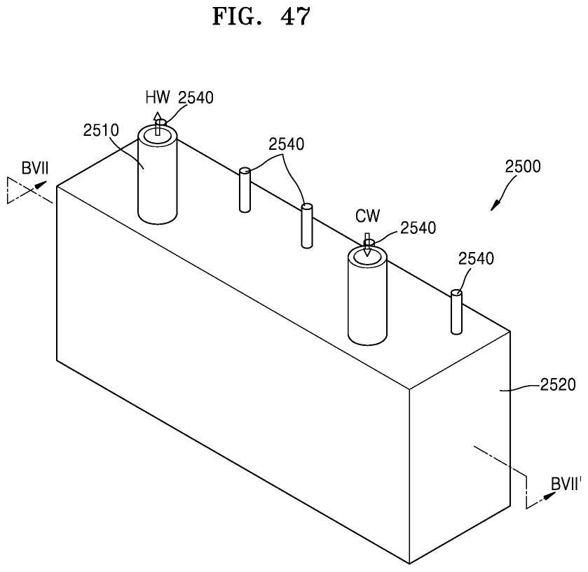

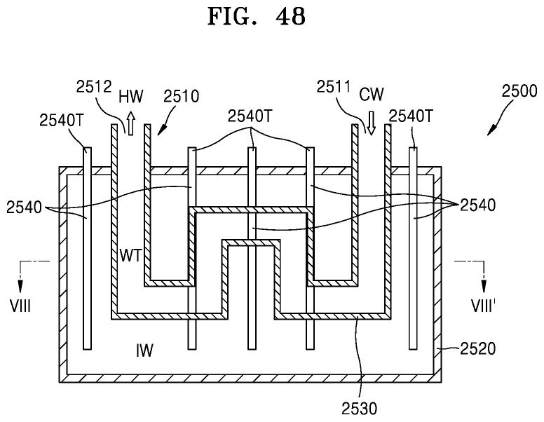

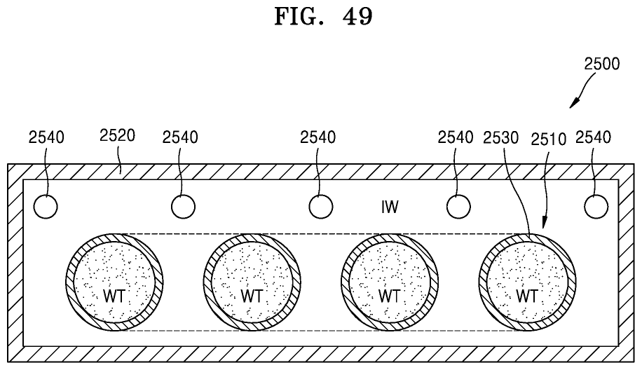

FIG. 47 is a view schematically illustrating a heating device according to another embodiment of the present disclosure, FIG. 48 is a cross-sectional view taken along line BVII-BVII′ of FIG. 47, and FIG. 49 is a cross-sectional view taken along line BVIII-BVIII′ of FIG. 44.

Referring to FIGS. 47 to 49, a heating device 2500 according to the present embodiment may include a pipe part 2510 and a body part 2520.

A fluid WT may be disposed inside the pipe part 2510. The fluid WT may include various types, for example, a liquid or a gas.

The pipe part 2510 may be formed in the shape of a pipe including an outer wall and an inner wall and having a space therein in which the fluid WT may be disposed. For example, the pipe part 2510 may be formed in the shape of a pipe having a circular cross-section. In another example, the pipe part 2510 may be formed in the shape of a pipe having a polygonal cross-section. For example, the pipe part 2510 may be formed in the shape of a pipe having a rectangular cross-section. In another example, the pipe part 2510 may be formed in the shape of a pipe having a curved cross-section similar to an ellipse.

The body part 2520 may be a device disposed to surround at least one region of the pipe part 2510 and configured to heat the fluid WT disposed inside the pipe part 2510.

The body part 2520 may have various shapes, and for example, may be formed in the shape of a hollow box having a space provided therein.

In an optional embodiment, the body part 2520 may be formed in a columnar shape, for example, may be formed in the shape of a square column. In another example, the body part 2520 may be formed in the shape of a cylinder. In another example, the body part 2520 may be formed in the shape of a column including a curved surface whose bottom surface is similar to an ellipse.

The pipe part 2510 may be formed to be longer than the body part 2520.

In an embodiment, the at least one region of the pipe part 2510 may be disposed on an inner side of the body part 2520. Accordingly, when the fluid WT is disposed inside the pipe part 2510, at least a portion of the fluid WT may be disposed inside the body part 2520. In this case, a partial region of the pipe part 2510 may be exposed to the outside of the body part 2520, and specifically, both ends of the pipe part 2510 may be exposed to the outside of the body part 2520.

In an optional embodiment, the pipe part 2510 may include an inlet 2511 via which the fluid WT flows in an inward direction of the body part 2520, and an outlet 2512 via which the fluid WT is discharged in an outward direction of the body part 2520. For example, the pipe part 2510 may include the inlet 2511 at one side and the outlet 2512 at another side, and may include a flow path, in which the fluid WT is disposed, between the inlet 2511 and the outlet 2512. That is, one end of the pipe part 2510 exposed to the outside of the body part 2520 may be the inlet 2511, and another end of the pipe part 2510 exposed to the outside of the body part 2520 may be the outlet 2512.

Accordingly, the fluid WT may flow into the pipe part 2510, and for example, the fluid WT may be introduced via the inlet 2511 of the pipe part 2510 and may be discharged to the outside via the outlet 2512 through the flow path.

Specifically, an unheated fluid CW before being heated may be introduced via the inlet 2511 of the pipe part 2510. For example, the unheated fluid CW may include room-temperature water or low-temperature water.

A heated fluid HW may be discharged via the outlet 2512 and, for example, a fluid WT including water having a temperature higher than that of the unheated fluid CW introduced via the inlet 2511 may be discharged.

In a specific example, the unheated fluid CW including room-temperature water, which is introduced via the inlet 2511, may be introduced into the pipe part 2510 and then heated through the body part 2520, and the heated fluid HW including heated water may be discharged to the outside of the pipe part 2510 via the outlet 2512.

Since the body part 2520 is disposed to surround at least a portion of the pipe part 2510, the fluid WT can be in contact with the body part 2520 over a large area while passing through the pipe part 2510 and thus can be efficiently heated.

The electrolyzed water IW may be disposed inside the body part 2520, and an electrode part 2540 for heating the electrolyzed water IW may be included in the body part 2520. The electrode part 2540 may include at least one electrode.

In an embodiment, the fluid WT and the electrolyzed water IW may be disposed to overlap each other, and for example, the electrolyzed water IW may be disposed to surround the side surface of the pipe part 2510. That is, since the electrolyzed water IW is disposed inside the body, and the fluid WT is disposed inside the pipe part 2510, the electrolyzed water IW and the fluid WT may be disposed to overlap each other.

The pipe part 2510 may include a heat dissipation part 2530. For example, the heat dissipation part 2530 may be a region which is disposed between the fluid WT and the electrolyzed water IW and in which heat is exchanged between the fluid WT and the electrolyzed water WT.

The heat dissipation part 2530 may be disposed to distinguish between the electrolyzed water IW and the fluid WT. For example, the heat dissipation part 2530 may be disposed between the electrolyzed water IW and the fluid WT, and specifically, may be formed to define an internal space of the pipe part 2510. In addition, the heat dissipation part 2530 may be formed to be spaced apart from the electrode part 2540.

For example, the heat dissipation part 2530 may have an elongated shape having a length in the same direction with a longitudinal direction of the pipe part 2510, and specifically, may form the flow path of the pipe part 2510. Accordingly, the heat dissipation part 2530 may be connected to at least one surface of the body part 2520. That is, the heat dissipation part 2530 may be disposed to connect the inlet 2511 to the outlet 2512 between the inlet 2511 and the outlet 2512 of the pipe part 2510.

The fluid WT may be disposed inside the pipe part 2510. The fluid WT may be disposed to be distinguished from the electrolyzed water IW disposed outside the pipe part 2510.

For example, the fluid WT may be disposed inside the heat dissipation part 2530 of the pipe part 2510, and the fluid WT and the electrolyzed water IW may be disposed to be distinguished from each other through the heat dissipation part 2530.

In an embodiment, at least one region of the pipe part 2510 may be formed to be curved inside the body part 2520, for example, two regions thereof may be formed to be curved.

When a specific embodiment is described with reference to FIGS. 48 and 49 again, the pipe part 2510 may include a curved region such that the pipe part 2510 is formed in an approximately “W” shape inside the body part 2520. Thus, the flow path through which the fluid WT flows inside the body part 2520 is also curved.

For example, based on FIG. 48, the fluid WT may flow in a downward direction after being introduced via the inlet 2511, flow in an upward direction through curved regions, flow in the downward direction again through curved regions, and then, flow in the upward direction again toward the outlet 2512 after through curved regions. Accordingly, the time for the fluid WT to remain inside the pipe part 2510 relatively further increases, and thus the time for the fluid WT to receive heat from the body part 2520 increases, allowing the fluid WT to be heated more efficiently.

Meanwhile, the pipe part 2510 is illustrated as being bent vertically, but the present disclosure is not limited thereto, and it should be appreciated that the pipe part 2510 may be bent in a curved shape.

The body part 2520 may include the electrode part 2540 having one or more electrodes.

At least one region of the electrode part 2540 may be disposed on an inner side of the body part 2520, for example, may be disposed on an outer side of the pipe part 2510.

In addition, the electrode part 2540 may be disposed to overlap the electrolyzed water IW to heat the electrolyzed water IW at an outer region of the heat dissipation part 2530.

In an embodiment, the electrode part 2540 may include a plurality of electrodes.

Each of the plurality of electrodes may be disposed inside the body part 2520 so as to be in contact with the electrolyzed water IW.

In an optional embodiment, the electrode part 2540 may include a region embedded inside the body part 2520 and a terminal 2540T exposed to the outside of the body part 2520. Here, the region embedded inside the body part 2520 may be a portion from which heat is generated due to a current applied from the outside, and a terminal 2540T may be a portion connected to an external power source to receive the current.

The electrolyzed water IW may be heated due to the current applied to the electrode part 2540. Heat generated by heating of the electrolyzed water IW is transferred to the fluid WT in the pipe part 2510, and the fluid WT may be heated.

The plurality of electrodes may be disposed to be spaced apart from each other with an interval in an inner space of the body part 2520.

For example, the plurality of electrodes may be spaced apart from each other with an interval in an outer space of the heat dissipation part 2530 of the body part 2520, and may each have an elongated shape, specifically a linear shape. In addition, the electrode part 2540 may overlap the fluid WT, which is disposed inside the pipe part 2510, with respect to one direction. In addition, the electrode part 2540 may be disposed not to be in direct contact with the pipe part 2510 or not to pass through the pipe part 2510.

For example, based on FIG. 49, the pipe part 2510 may be disposed on a lower side, and the electrode part 2540 may be disposed above the pipe part 2510 such that the electrode part 2540 is not in direct contact with the pipe part 2510 or does not pass through the pipe part 2510.

In an embodiment, the electrode may be disposed in parallel to the at least one region of the pipe part 2510. For example, the electrode may be formed to extend in a linear shape to have a length, and a direction in which the electrode extends may be parallel to the at least one region of the pipe part 2510. That is, based on FIG. 48, the electrode may be formed to be parallel to a longitudinal direction of the pipe part 2510. Thus, heat generated from the electrode part 2540 can be rapidly transferred to a wide surface of the pipe part 2510, so that the heat can be efficiently transferred.

In an optional embodiment, based on FIG. 48, the electrodes may be disposed to be distributed over a wide range in a horizontal direction. For example, the electrodes may be respectively disposed at positions adjacent to regions disposed in a vertical direction among regions of the pipe part 2510. Thus, the electrode part 2540 can transfer heat to various positions of the pipe part 2510.

The region extending from the electrode part 2540 and embedded into the body part 2520 may be spaced apart from a region of the body part 2520, specifically, a bottom surface of the body part 2520. That is, each end portion of the electrode part 2540 facing an opposite direction from the terminal 2540T may be formed to be spaced apart from the bottom surface of the body part 2520.

Accordingly, the risk of occurrence of electrical leakage or short circuits, which may occur due to the direct contact between the body part 2520 and the electrode part 2540, may be reduced, and a heating process for the electrolyzed water IW may be stably performed.

In addition, the electrode part 2540 may include a conductive part (not shown) connected to the terminal 2540T to allow a current to be applied to the electrode part 2540, and the conductive part (not shown) is a conductor in the form of a wire and may be connected to the electrode control part (not shown).

In an optional embodiment, the electrode part 2540 may have a plurality of electrode units each having a two-phase form and including two electrodes. Alternatively, the electrode part 2540 may be provided in a three-phase form and may include three electrode units. Alternatively, the electrode part 2540 may include electrode units having both a two-phase form and a three-phase form. However, the present disclosure is not limited thereto, and various arrangements of electrodes may be used as long as they have a configuration in which current can be applied to generate heat.

In addition, specific descriptions of the pipe part 2510, the body part 2520, the fluid WT, the electrolyzed water IW, the electrode part 2540, and the like will be omitted as the contents described in the above-described embodiments may be selectively applied or may be modified and applied as necessary.

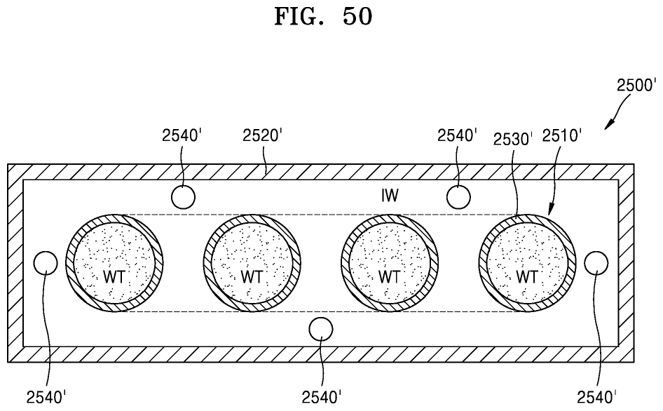

FIG. 50 is a view schematically illustrating a modified example (2500′) of FIGS. 47 to 49.

Hereinafter, for convenience of description, differences from the embodiment (2500) described with reference to FIGS. 47 to 49 will be mainly described.

As in the embodiment (2500) described above, a heating device 2500′ according to the present embodiment may include a pipe part 2510′, a body part 2520′, a heat dissipation part 2530′, and an electrode part 2540′.

In this case, the electrode part 2540′ may include a plurality of electrodes, and the electrodes may be disposed not to be in direct contact with the pipe part 2510′ or not to pass through the pipe part 2510′.

In an optional embodiment, based on FIG. 50, the plurality of electrodes may be disposed to intersect above and below the pipe part 2510′. That is, the plurality of electrodes may each be disposed so as not to be in direct contact with the pipe part 2510′, and may be disposed alternately on the outside of the pipe part 2510′.

Accordingly, heat generated from each electrode can be transmitted to the entire side surface of the pipe part 2510′, so that the heat can be rapidly and efficiently transferred. That is, the heat generated by the electrodes may be transferred over a large region of the pipe part 2510′, rather than being transferred locally in just one region of the pipe part 2510′.

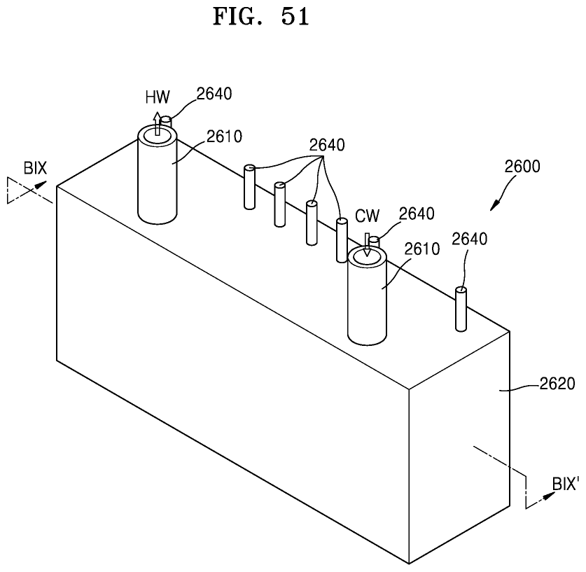

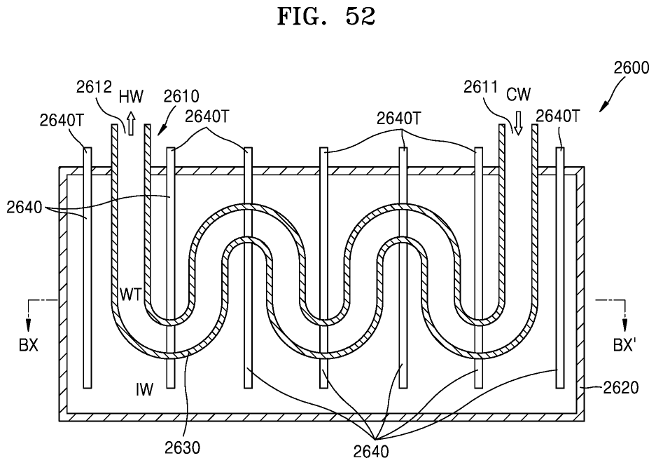

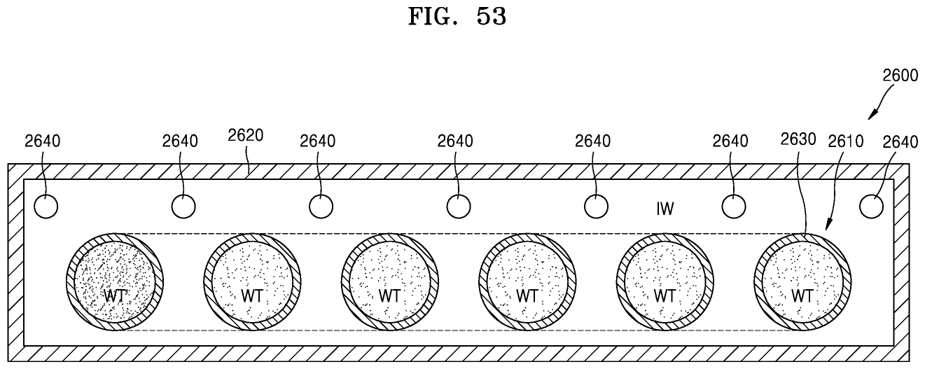

FIG. 51 is a view schematically illustrating a heating device according to another embodiment of the present disclosure, FIG. 52 is a cross-sectional view taken along line BIX-BIX′ of FIG. 51, and FIG. 53 is a cross-sectional view taken along line BX-BX′ of FIG. 52.

Referring to FIGS. 51 to 53, a heating device 2600 according to the present embodiment may include a pipe part 2610 and a body part 2620.

A fluid WT may be disposed inside the pipe part 2610. The fluid WT may include various types, for example, a liquid or a gas.

The pipe part 2610 may be formed in the shape of a pipe including an outer wall and an inner wall and having a space therein in which the fluid WT may be disposed. For example, the pipe part 2610 may be formed in the shape of a pipe having a circular cross-section. In another example, the pipe part 2610 may be formed in the shape of a pipe having a polygonal cross-section. For example, the pipe part 2610 may be formed in the shape of a pipe having a rectangular cross-section. In another example, the pipe part 2610 may be formed in the shape of a pipe having a curved cross-section similar to an ellipse.

The body part 2620 may be a device disposed to surround at least one region of the pipe part 2610 and configured to heat the fluid WT disposed inside the pipe part 2610.

The body part 2620 may have various shapes, and for example, may be formed in the shape of a hollow box having a space provided therein.

In an optional embodiment, the body part 2620 may be formed in a columnar shape, for example, may be formed in the shape of a square column. In another example, the body part 2620 may be formed in the shape of a cylinder. In another example, the body part 2620 may be formed in the shape of a column including a curved surface whose bottom surface is similar to an ellipse.

The pipe part 2610 may be formed to be longer than the body part 2620.

In an embodiment, the at least one region of the pipe part 2610 may be disposed on an inner side of the body part 2620. Accordingly, when the fluid WT is disposed inside the pipe part 2610, at least a portion of the fluid WT may be disposed inside the body part 2620. In this case, a partial region of the pipe part 2610 may be exposed to the outside of the body part 2620, and specifically, both ends of the pipe part 2610 may be exposed to the outside of the body part 2620.

In an optional embodiment, the pipe part 2610 may include an inlet 2611 via which the fluid WT flows in an inward direction of the body part 2620, and an outlet 2612 via which the fluid WT is discharged in an outward direction of the body part 2620. For example, the pipe part 2610 may include the inlet 2611 at one side and the outlet 2612 at another side, and may include a flow path, in which the fluid WT is disposed, between the inlet 2611 and the outlet 2612. That is, one end of the pipe part 2610 exposed to the outside of the body part 2620 may be the inlet 2611, and another end of the pipe part 2610 exposed to the outside of the body part 2620 may be the outlet 2612.

Accordingly, the fluid WT may flow into the pipe part 2610, and for example, the fluid WT may be introduced via the inlet 2611 of the pipe part 2610 and may be discharged to the outside via the outlet 2612 through the flow path.

Specifically, an unheated fluid CW before being heated may be introduced via the inlet 2611 of the pipe part 2610. For example, the unheated fluid CW may include room-temperature water or low-temperature water.

A heated fluid HW may be discharged via the outlet 2612 and, for example, a fluid WT including water having a temperature higher than that of the unheated fluid CW introduced via the inlet 2611 may be discharged.

In a specific example, the unheated fluid CW including room-temperature water, which is introduced via the inlet 2611, may be introduced into the pipe part 2610 and then heated through the body part 2620, and the heated fluid HW including heated water may be discharged to the outside of the pipe part 2610 via the outlet 2612.

Since the body part 2620 is disposed to surround at least a portion of the pipe part 2610, the fluid WT can be in contact with the body part 2620 over a large area while passing through the pipe part 2610 and thus can be efficiently heated.

The electrolyzed water IW may be disposed inside the body part 2620, and an electrode part 2640 for heating the electrolyzed water IW may be included in the body part 2620. The electrode part 2640 may include at least one electrode.

In an embodiment, the fluid WT and the electrolyzed water IW may be disposed to overlap each other, and for example, the electrolyzed water IW may be disposed to surround the side surface of the pipe part 2610. That is, since the electrolyzed water IW is disposed inside the body, and the fluid WT is disposed inside the pipe part 2610, the electrolyzed water IW and the fluid WT may be disposed to overlap each other.

The pipe part 2610 may include a heat dissipation part 2630. For example, the heat dissipation part 2630 may be a region which is disposed between the fluid WT and the electrolyzed water IW and in which heat is exchanged between the fluid WT and the electrolyzed water WT.

The heat dissipation part 2630 may be disposed to distinguish between the electrolyzed water IW and the fluid WT. For example, the heat dissipation part 2630 may be disposed between the electrolyzed water IW and the fluid WT, and specifically, may be formed to define an internal space of the pipe part 2610. In addition, the heat dissipation part 2630 may be formed to be spaced apart from the electrode part 2640.

For example, the heat dissipation part 2630 may have an elongated shape having a length in the same direction with a longitudinal direction of the pipe part 2610, and specifically, may form the flow path of the pipe part 2610. Accordingly, the heat dissipation part 2630 may be connected to at least one surface of the body part 2620. That is, the heat dissipation part 2630 may be disposed to connect the inlet 2611 to the outlet 2612 between the inlet 2611 and the outlet 2612 of the pipe part 2610.

The fluid WT may be disposed inside the pipe part 2610. The fluid WT may be disposed to be distinguished from the electrolyzed water IW disposed outside the pipe part 2610.

For example, the fluid WT may be disposed inside the heat dissipation part 2630 of the pipe part 2610, and the fluid WT and the electrolyzed water IW may be disposed to be distinguished from each other through the heat dissipation part 2630.

In an embodiment, at least one region of the pipe part 2610 may be formed to be curved inside the body part 2620, for example, two regions thereof may be formed to be curved.

When a specific embodiment is described with reference to FIGS. 52 and 53 again, the pipe part 2610 may include a plurality of vertically curved regions inside the body part 2620. Thus, the flow path through which the fluid WT flows inside the body part 2620 is also curved.

For example, based on FIG. 52, the fluid WT may be introduced via the inlet 2611 so that the flow is reversed a plurality of times, specifically five times, in a vertical direction. Accordingly, the time for the fluid WT to remain inside the pipe part 2610 relatively further increases, and thus the time for the fluid WT to receive heat from the body part 2620 increases, allowing the fluid WT to be heated more efficiently. However, the present disclosure is not limited thereto, and it is also possible for the pipe part 2610 to further include a curved region so that the flow of the fluid WT is reversed more than the above-mentioned number of times, as necessary.

Meanwhile, the pipe part 2610 may not only be bent in a curved shape, but may also be bent vertically.

The body part 2620 may include the electrode part 2640 having one or more electrodes.

At least one region of the electrode part 2640 may be disposed on an inner side of the body part 2620, for example, may be disposed on an outer side of the pipe part 2610.

In addition, the electrode part 2640 may be disposed to overlap the electrolyzed water IW to heat the electrolyzed water IW at an outer region of the heat dissipation part 2630.

In an embodiment, the electrode part 2640 may include a plurality of electrodes.

Each of the plurality of electrodes may be disposed inside the body part 2620 so as to be in contact with the electrolyzed water IW.

In an optional embodiment, the electrode part 2640 may include a region embedded inside the body part 2620 and a terminal 2640T exposed to the outside of the body part 2620. Here, the region embedded inside the body part 2620 may be a portion from which heat is generated due to a current applied from the outside, and a terminal 2640T may be a portion connected to an external power source to receive the current.

The electrolyzed water IW may be heated due to the current applied to the electrode part 2640. Heat generated by heating of the electrolyzed water IW is transferred to the fluid WT in the pipe part 2610, and the fluid WT may be heated.

The plurality of electrodes may be disposed to be spaced apart from each other with an interval in an inner space of the body part 2620.

For example, the plurality of electrodes may be spaced apart from each other with an interval in an outer space of the heat dissipation part 2630 of the body part 2620, and may each have an elongated shape, specifically a linear shape. In addition, the electrode part 2640 may overlap the fluid WT, which is disposed inside the pipe part 2610, with respect to one direction. In addition, the electrode part 2640 may be disposed not to be in direct contact with the pipe part 2610 or not to pass through the pipe part 2610.

For example, based on FIG. 49, the pipe part 2610 may be disposed on a lower side, and the electrode part 2640 may be disposed above the pipe part 2610 such that the electrode part 2640 is not in direct contact with the pipe part 2610 or does not pass through the pipe part 2610.

In an embodiment, the electrode may be disposed in parallel to the at least one region of the pipe part 2610. For example, the electrode may be formed to extend in a linear shape to have a length, and a direction in which the electrode extends may be parallel to the at least one region of the pipe part 2610. That is, based on FIG. 48, the electrode may be formed to be parallel to a longitudinal direction of the pipe part 2610. Thus, heat generated from the electrode part 2640 can be rapidly transferred to a wide surface of the pipe part 2610, so that the heat can be efficiently transferred.

In an optional embodiment, based on FIG. 53, the electrodes may be disposed to be distributed over a wide range in a horizontal direction. For example, the electrodes may be respectively disposed at positions adjacent to regions disposed in a vertical direction among regions of the pipe part 2610. Thus, the electrode part 2640 can transfer heat to various positions of the pipe part 2610.

The region extending from the electrode part 2640 and embedded into the body part 2620 may be spaced apart from a region of the body part 2620, specifically, a bottom surface of the body part 2620. That is, each end portion of the electrode part 2640 facing an opposite direction from the terminal 2640T may be formed to be spaced apart from the bottom surface of the body part 2620.

Accordingly, the risk of occurrence of electrical leakage or short circuits, which may occur due to the direct contact between the body part 2620 and the electrode part 2640, may be reduced, and a heating process for the electrolyzed water IW may be stably performed.

In addition, the electrode part 2640 may include a conductive part (not shown) connected to the terminal 2640T to allow a current to be applied to the electrode part 2640, and the conductive part (not shown) is a conductor in the form of a wire and may be connected to the electrode control part (not shown).

In an optional embodiment, the electrode part 2640 may have a plurality of electrode units each having a two-phase form and including two electrodes. Alternatively, the electrode part 2640 may be provided in a three-phase form and may include three electrode units. Alternatively, the electrode part 2640 may include electrode units having both a two-phase form and a three-phase form. However, the present disclosure is not limited thereto, and various arrangements of electrodes may be used as long as they have a configuration in which current can be applied to generate heat.

In addition, specific descriptions of the pipe part 2610, the body part 2620, the fluid WT, the electrolyzed water IW, the electrode part 2640, and the like will be omitted as the contents described in the above-described embodiments may be selectively applied or may be modified and applied as necessary.

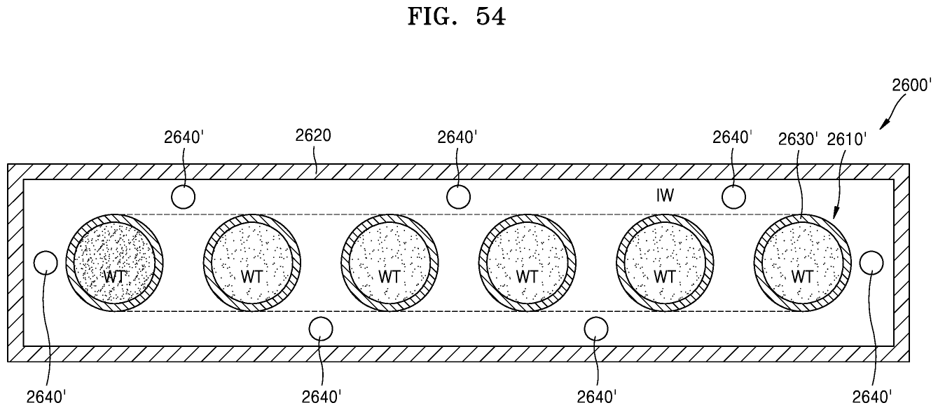

FIG. 54 is a view schematically illustrating a modified example (2600′) of FIGS. 51 to 53.

Hereinafter, for convenience of description, differences from the embodiment (2600) described with reference to FIGS. 51 to 53 will be mainly described.

As in the embodiment (2600) described above, a heating device 2600′ according to the present embodiment may include a pipe part 2610′, a body part 2620′, a heat dissipation part 2630′, and an electrode part 2640′.

In this case, the electrode part 2640′ may include a plurality of electrodes, and the electrodes may be disposed not to be in direct contact with the pipe part 2610′ or not to pass through the pipe part 2610′.

In an optional embodiment, based on FIG. 54, the plurality of electrodes may be disposed to intersect above and below the pipe part 2610′. That is, each of the plurality of electrodes is disposed so as not to be in direct contact with the pipe part 2610′, and may be alternately disposed outside the pipe part 2610′.

Accordingly, heat generated from each electrode can be transmitted to the entire side surface of the pipe part 2610′, thereby rapidly and efficiently transferring heat. That is, the heat generated from the electrode may not be locally transferred to only one region of the pipe part 2610′, but may be transmitted over a wide region of the pipe part 2610′.

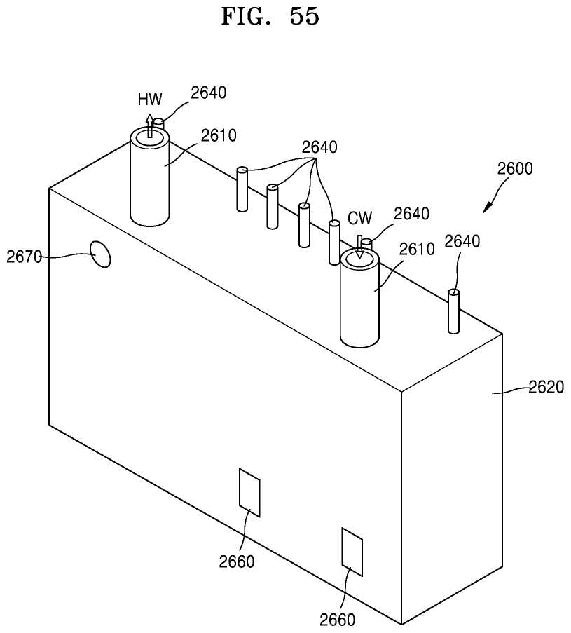

FIG. 55 is a view schematically illustrating an embodiment of the heating device including a sensor.

Referring to FIG. 55, the heating device 2600 according to the present embodiment may further include a temperature sensor 2660.

In an embodiment, the temperature sensor 2660 may be a device for measuring a temperature of the electrolyzed water IW inside the body part 2620 or a temperature of the fluid WT disposed inside the pipe part 2610. For example, the temperature sensor 2660 may measure the temperature of the electrolyzed water IW or the fluid WT to determine whether the temperature is maintained within a predetermined temperature range.

In an optional embodiment, a plurality of temperature sensors 2660 may be provided.

The plurality of temperature sensors 2660 may be disposed at positions spaced apart from each other. For example, the temperature sensors 2660 may be disposed to be spaced apart from each other at a plurality of positions along a movement path of the fluid WT.

In a specific embodiment, one temperature sensor 2660 may be disposed in the body part 2620 to be adjacent to the outlet 2612 of the pipe part 2610, and another one temperature sensor 2660 may be disposed in the body part 2620 to be adjacent to the inlet 2611 of the pipe part 2610′. However, the temperature sensors 2660 are not necessarily disposed at both the position adjacent to the outlet 2612 of the pipe part 2610 and the position adjacent to the inlet 2611 of the pipe part 2610, but may be disposed at either position. In addition, the temperature sensor 2660 may be further disposed in the path through which the fluid WT flows. Thus, the temperature sensors 2660 may be disposed at a plurality of positions and paths, via which the fluid WT is introduced, flows, and is discharged, to measure the temperature of the electrolyzed water IW or the fluid WT at various positions.

Accordingly, it can be more easily determined whether the electrolyzed water IW or the fluid WT is maintained at a predetermined temperature, and the heating device 2600 can be controlled to heat the fluid WT to a required temperature.

In addition, specific descriptions of the pipe part 2610, the body part 2620, the fluid WT, the electrolyzed water IW, the electrode part 2640, and the like will be omitted as the contents described in the above-described embodiments may be selectively applied or may be modified and applied as necessary.

In an embodiment, the heating device 2600 may further include an overheating sensor 2670. For example, the overheating sensor 2670 may be disposed in at least one region of the body part 2620.

The overheating sensor 2670 may be a device for measuring whether the electrolyzed water IW disposed inside the body part 2620 or the fluid WT disposed inside the pipe part 2610 is heated to a predetermined temperature or higher. Thus, accidents due to overheating may be prevented in advance, or it is possible to measure whether the fluid WT is heated to a desired temperature and discharged.

In an optional embodiment, the overheating sensor 2670 may be disposed at a position adjacent to the outlet 2612 of the pipe part 2610. Accordingly, the temperature of the fluid WT finally discharged from the heating device 2600 can be measured to determine whether the fluid WT at a desired temperature is discharged, or to determine whether the electrolyzed water IW is heated to a temperature within a safe range.

In an additional embodiment, the heating device 2600 may further include a cooling part to control the overheating of the electrolyzed water IW when the temperature sensor 2660 measures that the electrolyzed water IW reaches an overheated temperature.

The control part may be provided to control a current applied to the electrode part 2640. A current applied to each of a first electrode 2641 and a second electrode 2642 of the electrode part 2640 may be controlled through the control part, and in an optional embodiment, real-time control may be performed.

At this time, the control part may check the amount of current applied to the electrode part 2640 and control the current by increasing or decreasing the amount of current according to a set value, thereby preventing a sudden change in the temperature of the electrolyzed water IW.

The control part may have various shapes to facilitate changes in current. For example, the control part (not shown) may include various types of switches, and may include a non-contact relay such as an SSR for sensitive and rapid control.

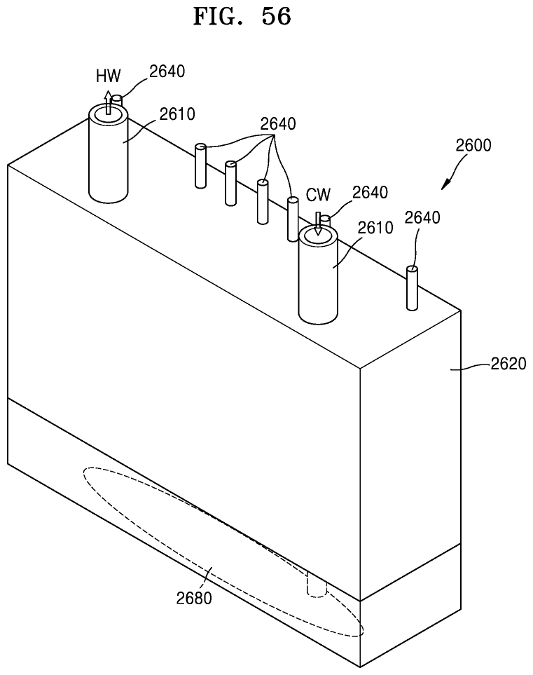

FIG. 56 is a view schematically illustrating an embodiment of the heating device including a buffer part.

In the embodiment of FIG. 56, the description of the above-described embodiments may be selectively applied or modified and applied as necessary, and thus, differences from the above-described embodiments will be mainly described.

Referring to FIG. 56, the heating device 2600 may further include a buffer part 2680.

The buffer part 2680 may be a device for buffering thermal expansion caused by heating.

That is, the fluid WT expands in volume when heated, and thus, when the electrolyzed water IW disposed in the body part 2620 is excessively overheated, the volume of the electrolyzed water IW may become larger than the volume inside the body part 2620, or when a gas is present in the body part 2620, the pressure inside the body part 2620 may be excessively increased as the gas is heated. In this case, the body part 2620 may be damaged or the electrolyzed water IW may leak. Alternatively, the pipe part 2610 may be damaged, causing the mixing of the electrolyzed water IW and the fluid WT.

The buffer part 2680 may be connected to the body part 2620 to buffer an increase in volume due to thermal expansion occurring in the body part 2620.

In an embodiment, the body part 2620 and the buffer part 2680 may be in communication with each other so that the electrolyzed water IW or air can be distributed therebetween. In addition, the buffer part 2680 may be formed of an elastic material, and thus may increase in volume to buffer an increase in pressure inside the buffer part 2680 and, conversely, decrease in volume when the pressure inside the buffer part 2680 decreases.

In an optional embodiment, a space for the buffer part 2680 to be disposed may be provided at one side of the body part 2120. For example, the buffer part 2680 may be repeatedly expanded and contracted in response to temperature changes in the electrolyzed water IW in the space provided in the body part 2120. That is, the body part 2620 may separately include a space in which the electrolyzed water IW is disposed and heating is performed, and a space in which the buffer part 2680 is disposed to buffer volume expansion caused by heating of the electrolyzed water IW. Thus, problems such as expansion of the buffer part 2680 due to direct heating by the electrolyzed water may be avoided, and volume expansion due to heating of the electrolyzed water IW can be buffered more efficiently.

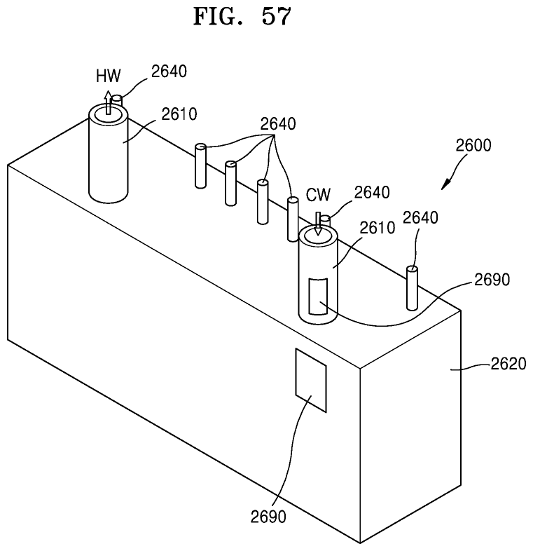

FIG. 57 is a view schematically illustrating an embodiment of the heating device including a control unit 2690.

Referring to FIG. 57, the heating device 2600 may further include a control unit 2690. For example, the control unit 2690 may be one component included in the above-described control part (not shown), and in another example, the control unit 2690 may be an additional component provided separately.

The control unit 2690 may be a device for performing control over at least one component of the heating device 2100. For example, the control unit 2690 may control circuits for providing power. In a specific example, the control unit 2690 may control the flow of current supplied to the electrode part 2640. Accordingly, the heating of the electrolyzed water IW may be precisely performed, and thus, the temperature control of the fluid WT may be stably performed.

In an embodiment, the control unit 2690 may include a thyristor, for example, a power thyristor. Thus, the control unit 2690 may easily and stably control the temperature of the fluid WT or the electrolyzed water IW.

Meanwhile, the control unit 2690 may generate heat during operation, and when the control unit 2690 includes a thyristor, the control unit 2690 may generate more heat due to the nature of the thyristor.

In an embodiment, the heat generated in the control unit 2690 may be exchanged with the fluid WT.

For example, the control unit 2690 may be disposed so as to overlap the fluid WT, and specifically, the control unit 2690 may be disposed in at least one position of the pipe part 2610 so as to overlap the fluid WT. Accordingly, the control unit 2690 may be cooled by the fluid WT, and conversely, the fluid WT may be heated by the control unit 2690, which has the advantage of efficiently utilizing heat.

In a specific embodiment, the control unit 2690 may be disposed at a position via which the fluid WT is introduced. For example, the control unit 2690 may be disposed at a position adjacent to the inlet 2611 of the pipe part 2610, and specifically, the control unit 2690 may be disposed on one surface of the pipe part 2610. Thus, the control unit 2690 may heat the fluid WT flowing into the heating device 2600 in advance so that the fluid WT can be rapidly heated to a desired temperature.

In another embodiment, the heat generated in the control unit 2690 may be exchanged with the electrolyzed water IW. For example, the control unit 2690 may be disposed to overlap the electrolyzed water IW, and specifically, the control unit 2690 may be disposed in at least one position of the body part 2620 so as to overlap the electrolyzed water IW. Thus, the control unit 2690 may be cooled by the electrolyzed water IW, and conversely, the electrolyzed water IW may be heated by the control unit 2690, which has the advantage of efficiently utilizing heat.

In a specific embodiment, the control unit 2690 may be disposed on the body part 2620 at a position adjacent to the inlet 2611. For example, the control unit 2690 may be disposed on one surface of the body part 2620 based on FIG. 57. Thus, the control unit 2690 can heat the electrolyzed water IW disposed at a position adjacent to the fluid WT flowing into the heating device 2600 in advance so that the fluid WT can be rapidly heated to a desired temperature.

In an optional embodiment, the control unit 2690 may be formed in the form of a plate. For example, the control unit 2690 may be formed in the form of a plate with a shape corresponding to the outer surface of the pipe part 2610 or the body part 2620 so as to be disposed along one surface of the pipe part 2610 or the body part 2620.

For example, the control unit 2690 may be formed in the shape of a flat plate, or may be formed to be curved in at least one region. Thus, an area in which the control unit 2690 overlaps the fluid WT or the electrolyzed water IW increases so that heat exchange can be more efficiently performed.

In an optional embodiment, a plurality of control units 2690 may be included.

The plurality of control units 2690 may perform control of at least one component of the heating device 2600.

In an embodiment, the plurality of control units 2690 may be configured identically. Accordingly, by including the plurality of control units 2690, a large amount of heat can be exchanged with the fluid WT or the electrolyzed water IW, thereby allowing the fluid to be heated rapidly and efficiently to a desired temperature.

In an optional embodiment, the control unit 2690 may be disposed on the inlet 2611 of the pipe part 2610 and the body part 2620. For example, the control unit 2690 may be disposed on one surface of the body part 2620 adjacent to the inlet 2611. Thus, by disposing the plurality of control units 2690 adjacent to the region via which the unheated fluid CW is introduced, heat exchange with the fluid WT flowing into the heating device 2600 can be performed more efficiently, and the fluid WT can be heated to a desired temperature.

However, the present disclosure is not limited thereto, and of course, more than the above number of control units 2690 may be provided. In this case, in an optional embodiment, at least one control unit 2690 may be disposed in the body part 2620 at a position on the movement path of the fluid WT or adjacent to the outlet 2612 via which the fluid WT is discharged.

Although the present disclosure has been described with reference to the embodiment shown in the drawings, which is merely exemplary, it will be understood by those skilled in the art that various modifications and equivalent other embodiments are possible therefrom. Accordingly, the true technical protection scope of the present disclosure should be determined by the technical spirit of the appended claims.

The particular implementations shown and described herein are illustrative examples of the embodiments and are not intended to otherwise limit the scope of the embodiments in any way. In addition, no item or element is essential to the practice of the present disclosure unless the element is specifically described as “essential” or “critical”

The use of the terms “a” and “an” and “the” and similar referents in the context of describing the present disclosure (especially in the context of the following claims) are to be construed to cover both the singular and the plural. Further, recitation of ranges of values herein are merely intended to serve as a shorthand method of referring individually to each separate value falling within the range, unless otherwise indicated herein, and each separate value is incorporated into the specification as if it were individually recited herein. Finally, operations of all methods described herein can be performed in any suitable order unless otherwise indicated herein or otherwise clearly contradicted by context. The present disclosure is not limited to the described order of the operations. The use of any and all examples, or exemplary terms (e.g., “such as”) provided herein, is intended merely to better illuminate the present disclosure and does not pose a limitation on the scope of the present disclosure unless otherwise claimed. Also, numerous modifications and adaptations will be readily apparent to one of ordinary skill in the art without departing from the spirit and scope of the present disclosure.

### INDUSTRIAL AVAILABILITY

According to an embodiment of the present disclosure, there is provided a heating device of an ionized water arrangement structure surrounding a heated fluid and a heat exchange region. In addition, embodiments of the present disclosure can be applied to heating devices for industrial use.

1. A heating device comprising:
a pipe part formed to allow a fluid to be disposed therein;
a body part formed to allow an electrolyzed water to be disposed therein to overlap the fluid, and formed to surround at least one region of the pipe part; and
at least one electrode for heating the electrolyzed water inside the body part.

2. The heating device of claim 1, wherein the pipe part is disposed to cross an inside of the body part.

3. The heating device of claim 1, wherein the pipe part includes an inlet via which a fluid is introduced in an inward direction of the body part and an outlet via which the fluid is discharged in an outward direction of the body part.

4. The heating device of claim 1, wherein the pipe part has at least one region that is formed to be curved inside the body part.

5. The heating device of claim 1, wherein the electrode is disposed in parallel to at least one region of the pipe part.
